(19) United States
(12) Patent Application Publication
(10) Pub. No.: US 2006/0216683 A1
(43) Pub. Date: Sep. 28, 2006

(54) Interactive system for building, organising, and sharing one's own databank of questions and answers in a variety of questioning formats, on any subject in one or more languages

(76) Inventor: Gautam Dharamdas Goradia, Maharashtra (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/556,143

(22) PCT Filed:
(86) PCT No.: PCT/IN04/00127

(30) Foreign Application Priority Data
May 14, 2003 (IN) 486/MUM/2003

(51) Int. Cl. G09B 19/00; G09B 3/00; G09B 7/00

(52) U.S. Cl. 434/322; 434/118; 434/362

(57) ABSTRACT

Interactive system for building, organising, and sharing one's own databank of questions and answers in a variety of questioning formats, on any subject in one or more languages, it being accepted that one may want to build such data based on one's personal interest, in one or more languages by well-defined classifications that uses a computer system comprising of: a. One or more Databases to store data user wise; b. A well classified (i) User database; (ii) At least one data input, organizing and management module(s) allowing a user to input, append and/or modify data with or without Voice by well-defined classifications; (iii) Module to invoke a Practice Session; (iv) Module to Schedule data on the user's computer, including hand held devices, at preset time intervals; (v) Module to take Self Evaluation Tests and view replays of the same; (vi) Module to create Tests and Quizzes; (vii) Module allowing the user to Export data from the Database(s); (viii) Module allowing the user to Import data built by another user using the same System; (ix) Module allowing the user to Translate data into one or more languages; (x) Reports Module.

### FIELD OF INVENTION

The present invention relates to an interactive System for building (including saving, appending, retrieving, modifying), organising, and sharing one's own databank of Questions and Answers, including Questions and Answers based on passages (which passages are stored along with the Questions and Answers) for better comprehension of the passage, in a variety of questioning formats like Question/Answer, Multiple Choice, True or False, Fill in the Blanks, Match the Columns, Unscramble the Answer, Form a Question based on the Answer, for increasing, improving, evaluating one's own and others' knowledge, on any subject, in one or more languages, it being accepted that one may want to build (including saving, appending, retrieving, modifying) and organise such data based on one's personal interest and/or for the purpose of academic requirements in any subject, by well-defined classifications like Language, Source of Information, Age Group, Difficulty Level, Subject, Sub subjects etc, use such data to, inter alia, improve one's own and others' knowledge by taking Practice Sessions, use such data to evaluate the user's and others' knowledge, by taking or giving Self Evaluation Tests in interesting and stimulating Test formats, use such data to create Tests and quizzes; share such data and obtain a plurality of Reports.

### BACKGROUND OF THE INVENTION

It is a well-accepted fact that, from ancient times, people possessing knowledge have influenced cultures and civilizations. The transition of time has only reaffirmed the fact that knowledge is imperative for success. It is also accepted, that in today's information driven world, success and growth in any field is determined by the extent of knowledge possessed and the correct application of such knowledge.

It is accepted that formal education is an essential part of one's life, and in order to advance to higher stages of such education, one has to undergo the process of being tested or examined on a continual basis.

It is also accepted that several professions require that people pursuing such professions be trained and evaluated on a continual basis. It is also accepted that the results of such tests and examinations have a considerable impact on one's career.

It is accepted that the teaching community tests and examines students based on a curriculum, which is often subject to change.

It is accepted that tests and examinations are part of any educational process, where teachers create tests and examinations and students face these tests and examinations. Consequently, both teachers and students need to make several preparations for such tests and examinations. Since tests and examinations are part of any educational process, students continuously need to practice what they have learnt, as it is a well-known fact that ‘practice makes one perfect’.

It is also accepted that students are tested and examined, among other ways, by questioning them in a variety of questioning formats, to make the testing process both interesting and challenging.

It is also accepted that teachers have to prepare various tests and examination papers, and need to ensure that such tests and examination papers are stimulating and that questions are not duplicated for the same target audience.

It is also accepted that the current trend of questioning in tests and examinations is more objective in nature, as it is accepted that it is easier for a person to remember smaller pieces of information. Moreover, tests and examinations based on the objective-questioning format are easier to create and evaluate, and are thus perceived as a better method of evaluation, as opposed to the subjective questioning format.

It is a well-accepted fact that several tests and examinations require students to answer questions with reference to the context of a passage. It is also accepted that such evaluation, based on the comprehension of a passage, hones the analytical and cognitive skills of the students and helps teachers to evaluate the students on comprehensive passages.

It is also accepted that after studying a particular topic, answering questions related to the same helps in better understanding of the topic, and as such, a lot of text books contain exercises in various questioning formats at the end of each topic.

It is also accepted that Worksheets, Workbooks, GuideBooks, Flash Cards, and other such supplementary material present curriculum in the form of questions and answers, and are part of helping students evaluate themselves. It goes without saying, therefore, that such self-study by means of questions and answers is a very useful tool to revise and remember what has been studied.

It is also a well-accepted fact that external sources of education including private tutoring and online education, are increasingly popular amongst students, as they are perceived to complement and enhance the education received in schools, colleges and universities.

It is also accepted that people like to be well informed in matters relating to General Knowledge, and as such, would like to be updated with regard to the same, from time to time. It is also well known that people refer to newspapers, periodicals, magazines, websites, flash cards and other sources of information on a continual basis for this purpose. It is also well-known that the information available in such media is often stored by people in personal scrapbooks or diaries, for personal or professional use.

It is a well accepted fact that various fields and spheres of human activity are witnessing rapid changes, thereby making information pertaining to the same redundant very quickly. The knowledge of such changes in information is often crucial in the functioning of such fields, and hence it is essential that there be available a means to efficiently store such changes in information, along with an equally effective means to retrieve the same. Since information is constantly changing, the questions relating to the updated information would also change, and hence it is essential that there be available a means to efficiently change the questions related to the changed information.

It is accepted that traditionally, it has always been publishers who have been the ones to publish information in the form of textbooks, periodicals, magazines and quiz books and that, as individuals, one needs to refer to such publications that are published from time to time, to obtain more information, as well as to remain updated, about the same. Since such publications are not updated regularly, people have to wait for long periods of time for updated editions to be published, to remain updated.

It is accepted that the advent of the Internet has created a large source of data on various fields and subjects. It is also well known that such data is updated and replaced on a continual basis, and people would find it difficult to remember the original data for a long period of time. It is therefore necessary that there be available a means to store and organise such data before it is updated or replaced, along with an equally effective means to retrieve the same.

It is accepted that the activity of quizzing has emerged as a popular form of edutainment and further, it is also accepted that people like to participate in programmes and events based on the same, for intellectual gratification as well as for enjoyment. Therefore, there are several programmes based on quizzing that continue to be produced and broadcast through various media like television, radio, Internet amongst others. In the recent past, several quizzing programmes have been produced that have offered substantial amounts of prize money.

Further, there are several books based on quizzing that continue to be published from time to time which contain static and moderate amount of information in the form of questions and answers.

It is a well-accepted fact that people generally cannot remember large amounts of data, whether

by Classifications or not, without external help, and it would be very helpful if there were to exist

a System that would allow them to build (including saving, appending, retrieving, modifying), organise and share their own databank of questions and answers, including questions and answers based on passages (which passages are stored along with the questions and answers) for better comprehension of the passage, in a variety of questioning formats, for increasing, improving, evaluating their own and others' knowledge, on any subject, in one or more languages.

The prior art systems described in the foregoing descriptions have an inherent limitation, in that, they do not allow the user to build their own databank of questions and answers, and further that none of the above prior art assist in the improvement of one's knowledge by allowing users to practice, share and/or take self evaluation tests and/or test others' knowledge.

Therefore, by dint of determined research and intuitive knowledge, our inventor has developed an interactive System that enables users to build (including saving, appending, retrieving, modifying), organise, and share their own databank of questions and answers, including questions and answers based on passages (which passages are stored along with the questions and answers) for better comprehension of the passage, in a variety of questioning formats, on any subject, in one or more languages of their choice, by well-defined Classifications, translate the same into one or more languages, and which further enables users to improve their and others' knowledge by means of Practice Sessions, Scheduled displays and Self Evaluation Tests; and which further enables them to monitor their progress; and which further enables users to create Tests and Quizzes; and which further enables users to evaluate others on their knowledge and to monitor their progress, and which further enables users to export data to other users of this System, and which further allows users to import data built by other users of this System.

US Patent Application Publication No. US2003224341 relates to an apparatus and a system to teach a user a subject based on his questions. The system allows the user to control his learning process, and helps to fill in gaps of misunderstanding in the subject. In one embodiment, the system, including a database, presents study materials on the subject to the user. After working on the presented materials, the user enters his question into the system, which generates an answer to the question, and presents it to him. Then the system compares the question with one or more questions previously entered by the user to determine his understanding level in the subject.

PCT Application No. PCT/JP02/10618 relates to an education system for educating persons such as those working in medical facilities, without causing spatial or temporal load. The education system is a network system including a terminal having communication means and an education system server, which are communicably connected via a network. The terminal has education performing means having a function to display a question and process an answer to the question and communication control means for transmitting the processed answer result to the education system server. The education system server includes test result storage means for storing the processed answer result received for each of the students and test result edition means for editing and outputting the test result according to a request from the terminal.

Japan Patent Application Publication No. JP2003216014 relates to a device and a method for processing questions and answers enabling efficient and automatic distribution of questions sent from students so that the questions are equally distributed to each teacher. Each time a student uploads a question, teacher ID of a teacher who is to be at work on the day when the question is received, is retrieved out of a schedule managing means, and the cumulative number of processing is retrieved out of a processing number managing means based on the retrieved teacher ID. The teacher ID retrieved each time a question is uploaded and the cumulative number of processing are stored in a stack, and the teacher ID with the least accumulated number of processing is retrieved out of teacher IDs and the accumulated processing numbers are stored in the stack to decide the teacher to take care of answering. Thus, questions sent from students can be automatically distributed with efficiency so that the questions are equally distributed to each teacher.

Canadian Patent No. CA2357508 relates to a computerized method and system for learning an information, wherein the information is subdivided into a plurality of portions, and a plurality of sets of questions, each related to a respective one of said portions; a plurality of reviews of the portions of the information are performed by a learner in accordance with a computer program; during each review at least one of said portions called from the storage is displayed as an electronic page on a display, and a content of the electronic page is reviewed; the questions related to the displayed electronic page are presented successively one after the other; the learner inputs indications whether the learner knows an answer to a corresponding question or the learner don't not know the answer at least adequately; in response to the learner's input of the indication that the learner knows the answer to a corresponding question, by the program the question is promoted to a later review; in response to the isomers inputting the indication that the learner does not know the answer to a corresponding question adequately, by the program the question is promoted to an earlier review; and the reviews are performed with time intervals which increase from one review to another.

US Patent Application Publication No. US2003101153 relates to a method of assembling a knowledge database containing question and answer pairs, the method comprising the steps of: extracting questions from a multiplicity of electronic communications; enabling the sender of the communication to examine and select or deselect the extracted question(s); classifying each question based upon the content of the question and identifying keywords in each question; entering the questions into the database together with their respective classifications and keywords; and entering into the database answers corresponding to the entered questions; wherein an answer to a question may be found by classifying the question and identifying keywords therein, identifying questions contained in the database which have the same or a similar classification and which contain some or all of the same keywords, and identifying the corresponding answer.

U.S. Pat. No. 5,890,911 relates to a method and system for computerised learning, response, and evaluation. The computerised system comprises a central processing unit and related memory and storage capacity to operate a learning, response, and evaluation system stored in a computer program. The learning, response, and evaluation system comprises an authoring portion and a presentation portion. Through the use of intuitive interface elements, the authoring portion allows an author to quickly and easily construct a lesson from a pool of relevant data. Due to the design and capabilities provided, the authoring portion reduces the time it takes for an author to learn how to construct a lesson and reduces the time it takes to construct the lesson. Data can be organized into pages, which are presented to the user, and pages that are hidden from the user. The presentation portion allows a user to view and learn the information contained in a lesson. Learning is enhanced because a user can request testing at virtually any point in the lesson. Unlike prior systems, questions presented to the user are generated by the learning, response, and evaluation system rather than being developed by the author.

U.S. Pat. No. 6,029,156 relates to a system that provides a goal based learning system utilizing a rule based expert training system to provide a cognitive educational experience. The system provides the user with a simulated environment that presents a business opportunity to understand and solve optimally. Mistakes are noted and remedial educational material presented dynamically to build the necessary skills that a user requires for success in the business endeavor. The system utilizes an artificial intelligence engine driving individualized and dynamic feedback with synchronized video and graphics used to simulate real-world environment and interactions. Multiple “correct” answers are integrated into the learning system to allow individualized learning experiences in which navigation through the system is at a pace controlled by the learner. A robust business model provides support for realistic activities and allows a user to experience real world consequences for their actions and decisions and entails realtime decision-making and synthesis of the educational material. The system characterizes a user to tailor the presentation.

U.S. Pat. No. 6,164,974 relates to an evaluation based learning system (EBLS) which is used by authors, teachers, students and education administrators for the development of courses, the teaching of courses, the studying of courses and the administration of information and data relevant to the courses. The EBLS provides an efficient authoring, teaching and learning environment wherein a database of questions and answers are linked to a textbook to facilitate the learning and evaluation process of students studying a textbook.

U.S. Pat. No. 6,685,482 relates to an educational software using a computer and having a data storage system including a software module database management system and a user database management system. There is a quiz module database, maintained by the software module database management system, containing at least one quiz module, and a structured learning material editor module database, maintained by the software module database management system and containing at least one structured learning material editor modules. The software also has a structured learning material database, maintained by the user database management system, for storing at least one structured learning material data set created by a user. A user interface is provided for selecting system control functions, editing structured learning materials, presenting quizzes, receiving user answers to quizzes, and displaying quiz analysis results. A control system retrieves software modules from the software module database management system and activates them.

### BRIEF SUMMARY OF THE INVENTION

An object of the present invention is to allow users to build (including saving, appending, retrieving, modifying), organise, and share one's own databank of Questions and Answers in a variety of questioning formats like Question/Answer, Multiple Choice, True/False, Fill in the Blanks, Match the Columns, Unscramble the Answer, Form a Question based on the Answer, on any subject, in one or more languages, for increasing, improving, evaluating one's own and others' knowledge, it being accepted that one may want to build (including saving, appending, retrieving, modifying) such data in one or more languages based on one's personal interest, and further store it by various Classifications like Source of Information, Age Group, Difficulty Level, Subject, Sub subjects etc., such classification of data not being restricted to any already provided data.

Yet another object of the present invention is to allow the user to build (including saving, appending, retrieving, modifying), organise, and share one's own databank of Questions and Answers based on passages (which passages are stored along with the Questions and Answers) for better comprehension of the passage, in a variety of questioning formats like Question/Answer, Multiple Choice, True or False, Fill in the Blanks; Match the Columns, Unscramble the Answer, Form a Question based on the Answer, etc., on any subject, in one or more languages, for increasing, improving, evaluating one's own and others' knowledge, it being accepted that one may want to build (including saving, appending, retrieving, modifying) such data in one or more languages based on one's personal interest, and further store it by various Classifications like Source of Information, Age Group, Difficulty Level, Subject, Sub subjects etc., such classification of data not being restricted to any already provided data.

Yet another object of the present invention is to allow users to build Questions and Answers rapidly with minimum Classifications.

Yet another object of the present invention is to allow the user to FIND data rapidly and efficiently by none or one or more FIND conditions, wherein the FIND conditions to find the Records, from the Database(s) are defined by none or one or more Classifications like the Date, Record ID, Language, Source of Information, Age Group, Difficulty Level, Subject, Sub Subjects, by the number of times a Record has been used in a Practice Session/Scheduled Session/Self Evaluation Test/Test/Quiz/Insta Test/Quiz, by the performance of the user with respect to a Record faced by the user in a Self Evaluation Test, Practice Session Title, Test/Quiz Title, Test/Quiz Venue, Category and Sub categories as well as by keywords, wild card characters, File Attachments, Attachment Remarks, Association Remarks, Import Remarks, and/or Bookmark Remarks including, but not limited to, whether or not the Record is marked as “Set for Practice” or “Mastered”, “Private” or “Public” as well as “Favourite”. The user can exercise the option of using the above conditions to bring forth or avoid Records by the specified conditions.

Yet another object of the present invention is to allow the user to add Bookmark Remarks, Attachments, Associations (including Media files and URLs and more Remarks), and further. Attachment and Association Remarks, to the Questions and Answers and passages, including Questions and Answers based on the passages.

Yet another object of the present invention is to allow users to mark selected Records as “Set for Practice” or “Mastered”, and assign the same to specific users or user groups.

Yet another object of the present invention is to allow users to mark selected Records as “Private” or “Public”, and assign the same to specific users or user groups.

Yet another object of the present invention is to allow users to mark selected Records as “Favourite”, and assign the same to specific users or user groups.

Yet another object of the present invention is to allow users to Navigate efficiently between the Records.

Yet another object of the present invention is to allow users to Modify data individually and Globally, and further selectively.

Yet another object of the present invention is to allow users to Share data created by the users using the Export/Import/Print utilities, such Exporting/Importing/Printing of data capable of being done selectively.

Yet another object of the present invention is to provide users with the utility of Deleting the data, the scope of deleting data being singular or Global, sending the deleted data to the Recycle Bin of the System, and further permanently deleting the same, singularly or plurally, and/or restoring the same, singularly or plurally.

Yet another object of the present invention is to allow users to invoke Practice Session(s) using the stored Questions and Answers and passages along with the Questions and Answers based on the passages, by finding the same by none or one or more FIND conditions.

Yet another object of the present invention is to allow users to take Self Evaluation Tests by finding the stored Questions and Answers and passages along with the Questions and Answers based on the passages to be used for such Tests based on none or one or more FIND conditions, in various interesting, interactive and stimulating questioning formats, view a replay of the Self Evaluation Test as well as that of the user actions performed during the Self Evaluation Test as well as print a report of the same, and to provide them with evaluation reports.

Yet another object of the present invention is to allow users to create Tests or Quizzes rapidly in various interesting Test formats, for the purpose of written Tests or Quizzes, by finding the stored Questions and passages, along with the Questions based on the passages, to be used for such Tests or Quizzes based on none or one or more FIND conditions.

Yet another object of the present invention is to allow users to create Tests and/or Quizzes, manually or automatically in various interesting Test formats, by various Classifications, including rounds, by finding the stored Questions and passages, along with the Questions based on the passages, to be used for such Tests and/or Quizzes, based on none or one or more FIND conditions, assign marks to each Question, and with the further utility of being able to create such Tests and/or Quizzes using a backtracking utility to ensure that the selected Questions are not being duplicated, and further providing the utility of exporting the Questions and Answers used in such Tests and/or Quizzes or of providing the utility of exporting the Test and/or Quiz itself and further to use the Questions and Answers used in the Tests or Quizzes as screen savers.

Yet another object of the present invention is to allow the user to Schedule the Questions and Answers and Passages, along with the Questions and Answers based on the passages, as well as Schedule Practice Sessions or Self Evaluation Tests, by finding the same based on none or one or more FIND conditions, to be brought up on the user's computer system at preset time intervals.

Yet another object of the present invention is to provide various Reports selectively and having the further utility of customizing the same.

Yet another object of the present invention is to provide the necessary Tools to the user for better customization and maintenance of the System in various ways.

Yet another object of the present invention is to allow one or more module(s)/utility(s) to operate within a browser and/or other viewing and/or processing programs, and which can operate on one or more computers, including hand held devices.

Yet another object of the present invention is to provide a utility for creating, editing, deleting, printing, navigating, finding Masters like User, Language,

Source of Information, Age Group, Difficulty Level, Subject and Sub subjects, Passage Title, Test/Quiz Name, Test/Quiz Venue, Categories and Sub Categories, etc. with sufficient security so as not to allow the deletion of any Master of a Record that may be in use.

Yet another object of the present invention is to provide users with a Translation utility, allowing the user to consider any Record as a parent language Record and Translate the same into one or more languages of the user's choice, the translation activity happening from a-Translation Module which is invoked in the Question Bank—Rapid Entry Module, Question Bank —Main Module, and Comprehension Bank Module, and further that all,of the features and/or utility(s)/functionality(s) available in case of the parent language Record are available in case of its translation.

Yet another object of the present invention is to allow the user to print any Record of the user's choice as well as to obtain a plurality of Reports, including but not limited to the printing of Flash Cards, Snap Cards, and Worksheets.

Yet another object of the present invention is to allow the user to input and/or modify data in the Database(s) by Voice input, with or without a conjunction of input made by keyboard support, and/or to use any other utility(s)/functionality(s) of the System, as may be supported by the System for such use, by Voice Command, and further to allow the user to receive

Voice Output of the data so entered/modified by the user in the above Database(s).

Yet another object of the present invention is to use the Questions and Answers in the Database(s) as screen savers.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which, in an illustrative and non-restrictive way, the following are represented:

FIG. 1 is the diagram of the System block of the present invention.

FIG. 2 is the diagram of the Multiple User System of the present invention

FIG. 3 is the diagram of the outline of the System Process of the present invention

FIG. 4 is the diagram of the System Function of the Question Bank—Rapid Entry Module of the present invention

FIG. 5 is the diagram of the System Operation of the Question Bank—Rapid Entry Module of the present invention

FIG. 6 is the diagram of the System State Transition of the Question Bank—Rapid Entry Module of the present invention

FIG 7 is the diagram of the System Function of the Question Bank—Main Module of the present invention

FIG. 8 is the diagram of the System Operation of Question Bank—Main Module of the present invention

FIG. 9 is the diagram of the System State Transition of Question Bank—Main Module of the present invention

FIG. 10 is the diagram of the System Function of the Comprehension Bank Module of the present invention

FIG. 11 is the diagram of the System Operation of the Comprehension Bank Module of the present invention

FIG. 12 is the diagram of the System State Transition of the Comprehension Bank Module of the present invention

FIG. 13 is the diagram of the System Function of the Global Changes Module of the present invention

FIG. 14 is the diagram of the System Operation of the Global Changes Module of the present invention

FIG. 15 is the diagram of the System State Transition of the Global Changes module of the present invention

FIG. 16 is the diagram of the System Function of the Practice Session Module of the present invention

FIG. 17 is the diagram of the System Operation of the Practice Session Module of the present invention

FIG. 18 is the diagram of the System State Transition of the Practice Session Module of the present invention

FIG. 19 is the diagram of the System Function of the Self Evaluation Test Module of the present invention

FIG. 20 is the diagram of the System Operation of the Self Evaluation Test Module of the present invention

FIG. 21 is the diagram of the System State Transition of the Self Evaluation Test Module of the present invention

FIG. 22 is the diagram of the System Function of the Print a Test Module of the present invention

FIG. 23 is the diagram of the System Operation of the Print a Test Module of the present invention

FIG. 24 is the diagram of the System State Transition of the Print a Test Module of the present invention

FIG. 25 is the diagram of the System Function of the Individual Test Report Module of the present invention

FIG. 26 is the diagram of the System Operation of the Individual Test Report Module of the present invention

FIG. 27 is the diagram of the System State Transition of the Individual Test Report Module of the present invention

FIG. 28 is the diagram of the System Function of the Overall Evaluation Report Module of the present invention

FIG. 29 is the diagram of the System Operation of the Overall Evaluation Report Module of the present invention

FIG. 30 is the diagram of the System State Transition of the Overall Evaluation Report Module of the present invention

FIG. 31 is the diagram of the System Function of the Reports Module of the present invention

FIG. 32 is the diagram of the System Operation of the Reports Module of the present invention

FIG. 33 is the diagram of the System State Transition of the Reports Module of the present invention

FIG. 34 is the diagram of the System Function of the Insta Test/Quiz Module of the present invention

FIG. 35 is the diagram of the System Operation of the Insta Test/Quiz Module of the present invention

FIG. 36 is the diagram of the System State Transition of the Insta Test/Quiz Module of the present invention

FIG. 37 is the diagram of the System Function of the Create a Test/Quiz Module of the present invention

FIG. 38 is the diagram of the System Operation of the Create a Test/Quiz Module of the present invention

FIG. 39 is the diagram of the System State Transition of the Create a Test/Quiz Module of the present invention

FIG. 40 is the diagram of the System Function of the Export Module of the present invention

FIG. 41 is the diagram of the System Operation of the Export Module of the present invention

FIG. 42 is the diagram of the System State Transition of the Export Module of the present invention

FIG. 43 is the diagram of the System Function of the Import Module of the present invention

FIG. 44 is the diagram of the System Operation of the Import Module of the present invention

FIG. 45 is the diagram of the System State Transition of the Import Module of the present invention

FIG. 46 is the diagram of the System Function of the Scheduler Module of the present invention

FIG. 47 is the diagram of the System Operation of the Scheduler Module of the present invention

FIG. 48 is the diagram of the System State Transition of the Scheduler Module of the present invention

FIG. 49 is the diagram of the System Function of the Screen Saver Module of the present invention

FIG. 50 is the diagram of the System Operation of the Screen Saver Module of the present invention

FIG. 51 is the diagram of the System State Transition of the Screen Saver Module of the present invention

FIG. 52 is the diagram of the System Function of the Recycle Bin Module of the present invention

FIG. 53 is the diagram of the System Operation of the Recycle Bin Module of the present invention

FIG. 54 is the diagram of the System State Transition of the Recycle Bin Module of the present invention

FIG. 55 is the diagram of the System Function of the Tools/Help Menu Options Module of the present invention

FIG. 56 is the diagram of the System Operation of the Tools/Help Menu Options Module of the present invention

FIG. 57 is the diagram of the System State Transition of the Tools/Help Menu Options Module of the present invention

FIG. 58 is the diagram of the System Function of the Translation Module of the present invention

FIG. 59 is the diagram of the System Operation of the Translation Module of the present invention

FIG. 60 is the diagram of the System State Transition of the Translation Module of the present invention

FIG. 61 is the diagram of the System Function of the Master Module of the present invention

FIG. 62 is the diagram of the System Operation of the Master Module of the present invention

FIG. 63 is the diagram of the System State Transition of the Master Module of the present invention

### DETAILED DESCRIPTION OF THE PRESENT INVENTION

A detailed description of the preferred embodiments and best modes for practicing the present invention are described herein.

Interactive System for building, organising, and sharing one's own databank of Questions and Answers, including Questions and Answers based on passages (which passages are stored along with the Questions and Answers) for better comprehension of the passage, in a variety of questioning formats on any subject, in one or more languages, wherein

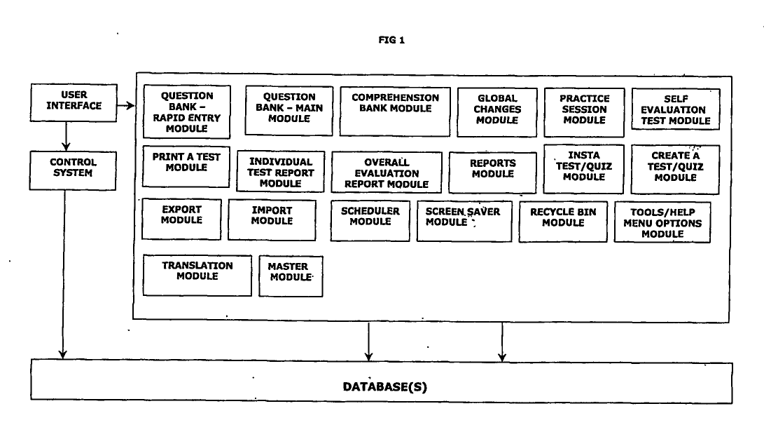

FIG. 1 is the diagram of the different functional blocks and their interaction, of the present invention. The User Interface(s) renders the user's actions, and with the help of the Control System transmits the appropriate user requests to the Database(s). The Control System acts as the bridge between the User Interface(s) and the Database(s).

The Database(s) are the reservoirs of an extensible collection of well-classified data of the Questions and Answers and Passages along with the Questions and Answers based on such passages, including translated data. Information with respect to Practice Session(s), Scheduled Session(s), Self Evaluation Test(s), Insta Test(s)/Quiz(s), including the performance of the user, and the creation of Test(s)/Quiz(s) is stored in the Database(s). User information, including the history of past user interaction with the System is stored in the Database(s). Configurations made by the user for Customization of the System are stored in the Database(s).

If the user requests for the Question Bank—Rapid Entry Module through the User Interface then the Control System asks the Database Management System to find the corresponding data from the Database(s), resulting in the display of the data, if available. The user then interacts further with the Question Bank—Rapid Entry Module through the User Interface with respect to the utilities available in this Module.

If the user requests for the Question Bank—Main Module through the User Interface then the Control System asks the Database Management System to find the corresponding data from the Database(s), resulting in the display of the data, if available. The user then interacts further with the Question Bank—Main Module through the User Interface with respect to the utilities available in this Module.

If the user requests for the Comprehension Bank Module through the User Interface then the Control System asks the Database Management System to find the corresponding data from the Database(s), resulting in the display of the data, if available. The user then interacts further with the Comprehension Bank Module through the User Interface with respect to the utilities available in this Module.

If the user requests for the Global Changes Module through the User Interface, then the Control System asks the Database Management System to find the corresponding data from the Database(s), resulting in the display of the data, if available. The user then interacts further with the Global Changes Module through the User Interface with respect to the utilities available in this Module.

If the user requests for the Practice Session Module through the User Interface then the Control System asks the Database Management System to find the corresponding data from the Database(s), resulting in the display of the data, if available. The user then interacts further with the Practice Session Module through the User Interface with respect to the utilities available in this Module.

If the user requests for the Self Evaluation Test Module through the User Interface, then the Control System asks the Database Management System to find the corresponding data from the

Database(s), resulting in the display of the data, if available. The user then interacts further with the Self Evaluation Test Module through the User Interface with respect to the utilities available in this Module.

If the user requests for the Print a Test Module through the User Interface, then the Control System asks the Database Management System to find the corresponding data from the Database(s) resulting in the display of the data, if available. The user then interacts further with the Print a Test Module through the User Interface with respect to the utilities available in this Module.

If the user requests for the Individual Test Report Module through the User Interface, then the Control System asks the Database Management System to find the corresponding data from the Database(s), resulting in the display of the data, if available. The user then interacts further with the Individual Test Report Module through the User Interface with respect to the utilities available in this Module.

If the user requests for the Overall Evaluation Report Module through the User Interface, then the Control System asks the Database Management System to find the corresponding data from the Database(s), resulting in the display of the data, if available. The user then interacts further with the Overall Evaluation Report Module through the User Interface with respect to the utilities available in this Module.

If the user requests for the Reports Module through the User Interface, then the Control System asks the Database Management System to find the corresponding data from the Database(s), resulting in the display of the data, if available. The user then interacts further with the Reports Module through the User Interface with respect to the utilities available in this Module.

If the user requests for the Insta Test/Quiz Module through the User Interface, then the Control System asks the Database Management System to find the corresponding data from the Database(s), resulting in the display of the data, if available. The user then interacts further with the Insta Test/Quiz Module through the User Interface with respect to the utilities available in this Module.

If the user requests for the Create a Test/Quiz Module through the User Interface, then the Control System asks the Database Management System to find the corresponding data from the Database(s), resulting in the display of the data, if available. The user then interacts further with the Create a Test/Quiz Module through the User Interface with respect to the utilities available in this Module;

If the user requests for the Export Module through the User Interface, then the Control System asks the Database Management System to find the corresponding data from the Database(s), resulting in the display of the data, if available. The user then interacts further with the Export Module through the User Interface with respect to the utilities available in this Module.

If the user requests for the Import Module through the User Interface, then the Control System retrieves the corresponding data from a valid Database file resulting in the display of the data, if available. The user then interacts further with the Import Module through the User Interface with respect to the utilities available in this Module.

If the user requests for the Scheduler Module through the User Interface, then the Control System asks the Database Management System to find the corresponding data from the Database(s), resulting in the display of the data, if available. The user then interacts further with the Scheduler Module through the User Interface with respect to the utilities available in this Module.

If the user requests for the Screen Saver Module through the User Interface, then the Control System asks the Database Management System to find the corresponding data from the Database(s) and retrieves the corresponding data resulting in the display of the data, if available. The user then interacts further with the Screen Saver Module of the System through the User Interface with respect to the utilities available in this Module.

If the user requests for the Recycle Bin Module through the User Interface, then the Control System asks the Database Management System to find the corresponding data from the Database(s) and retrieves the corresponding data resulting in the display of the data, if available. The user then interacts further with the Recycle Bin Module of the System through the User Interface with respect to the utilities available in this Module.

If the user requests for the Tools/Help Menu Options Module through the User Interface, then the Control System retrieves the corresponding Options available from the Database(s). The user then interacts further with the Tools/Help Menu Options Module through the User Interface with respect to the utilities available in this Module.

If the user requests for the Translation Module through the User Interface, then the Control System asks the Database Management System to find the corresponding data from the Database(s), resulting in the display of the data, if available. The user then interacts further with the Translation Module through the User Interface with respect to the utilities available in this Module.

If the user requests for the Master Module through the User. Interface, then the Control System asks the Database Management System to find the corresponding data from the Database(s), resulting in the display of the data, if available. The user then interacts further with the Master Module through the User Interface with respect to the utilities available in this Module. The Database(s) is updated on adding, modifying, and/or deleting a Record(s).

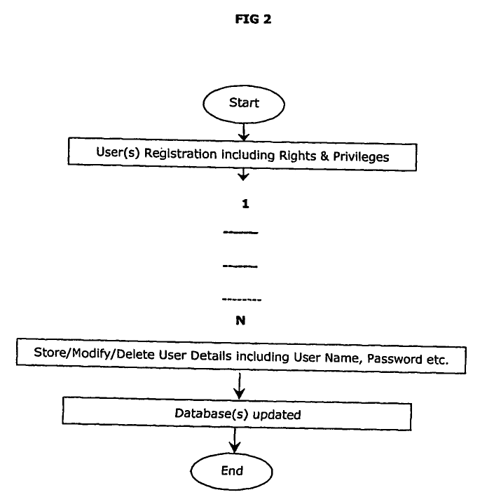

FIG. 2 is the diagram of the Multiple User System of the present invention. It explains that multiple users can use the System at the same time, and also explains that the System can be controlled by rights and privileges. It further allows the user to Store/Modify/Delete the User Details including User Name,.Password etc in the Database(s). Whenever a user wishes to log in to the System, the user has to provide a User Name and password. The user can further modify an existing password. Further, there is also a utility which allows the creation of new users.

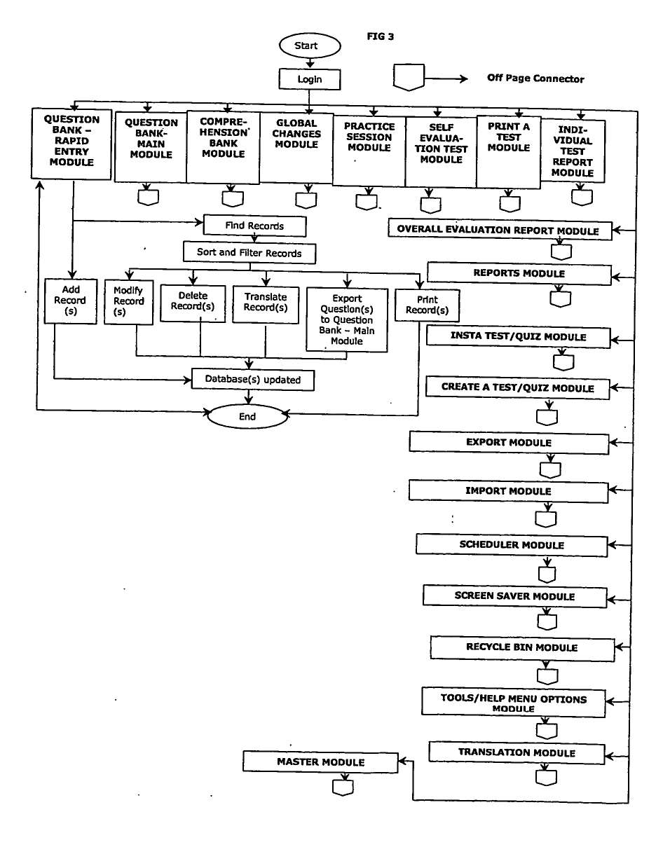

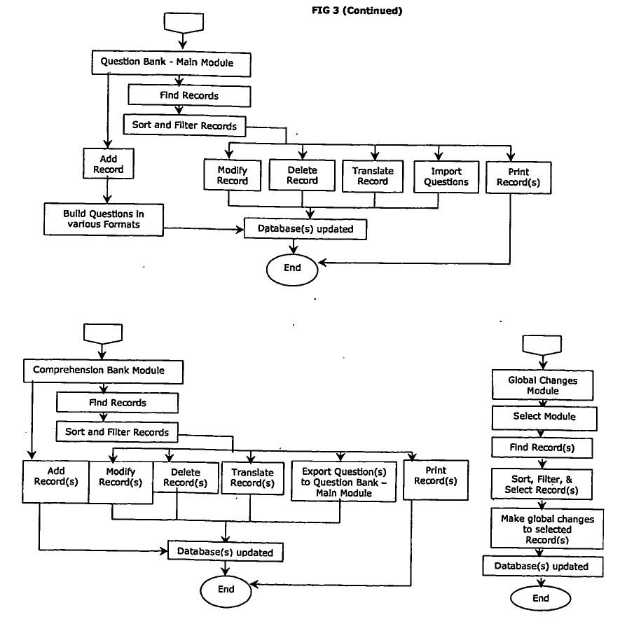

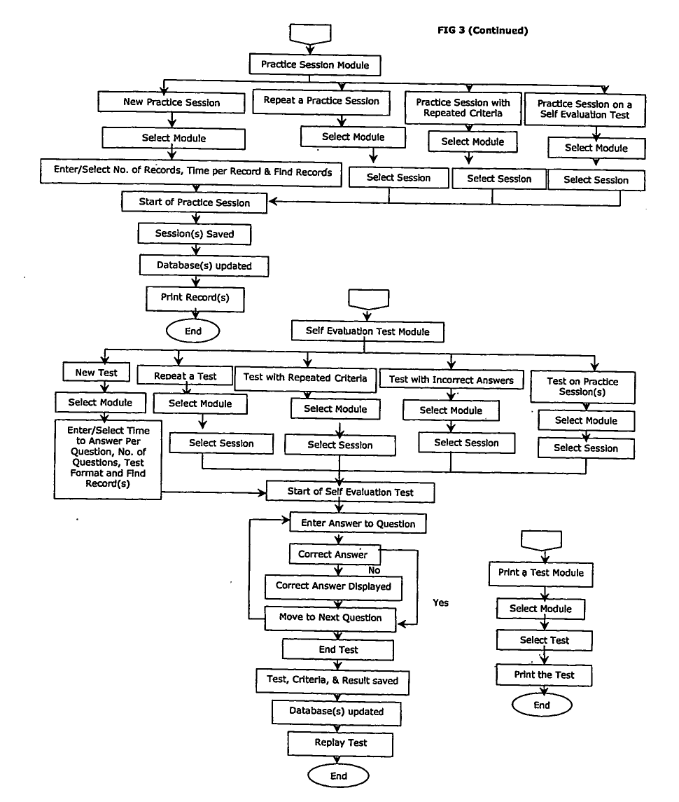

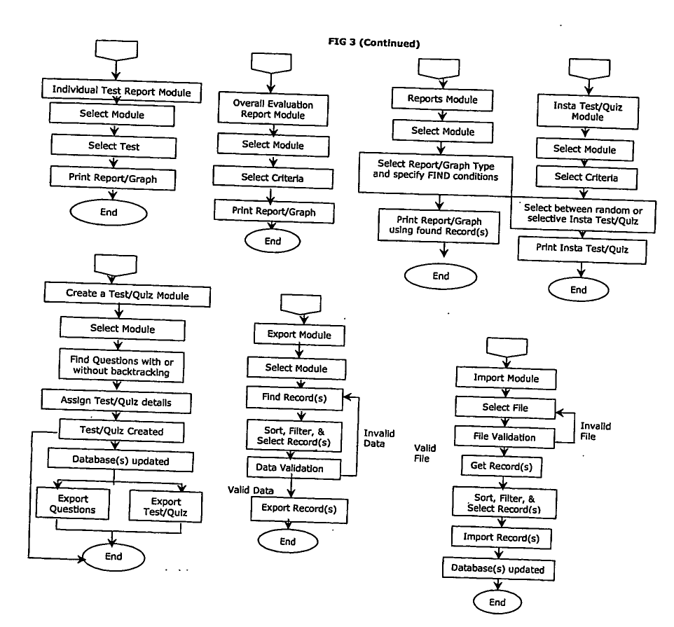

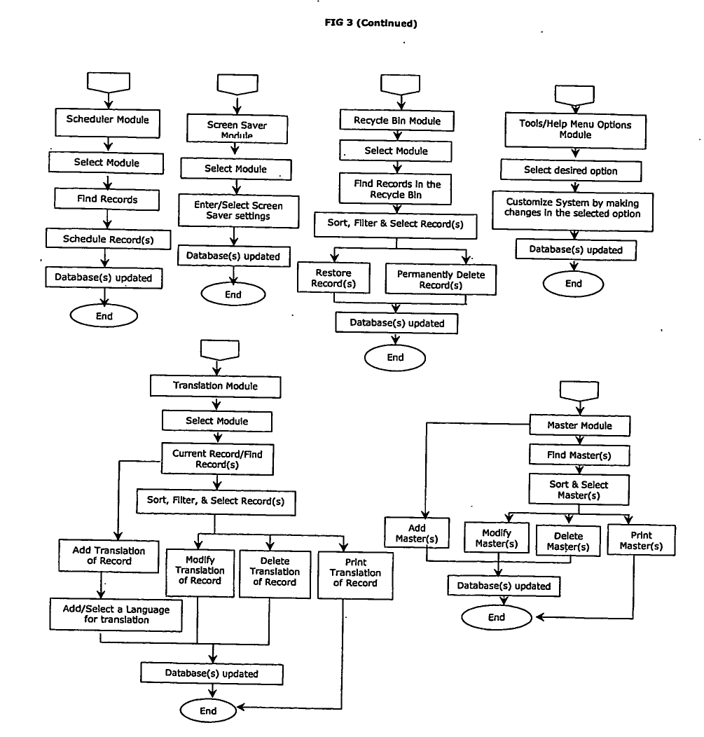

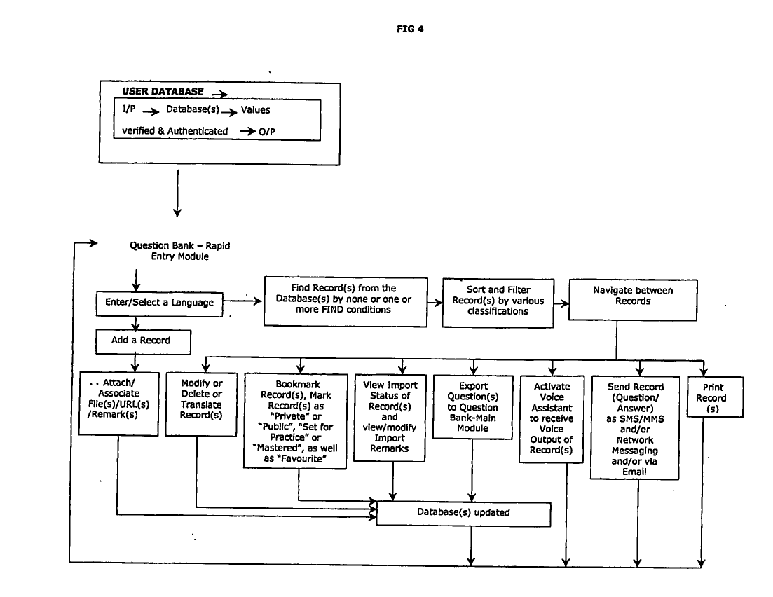

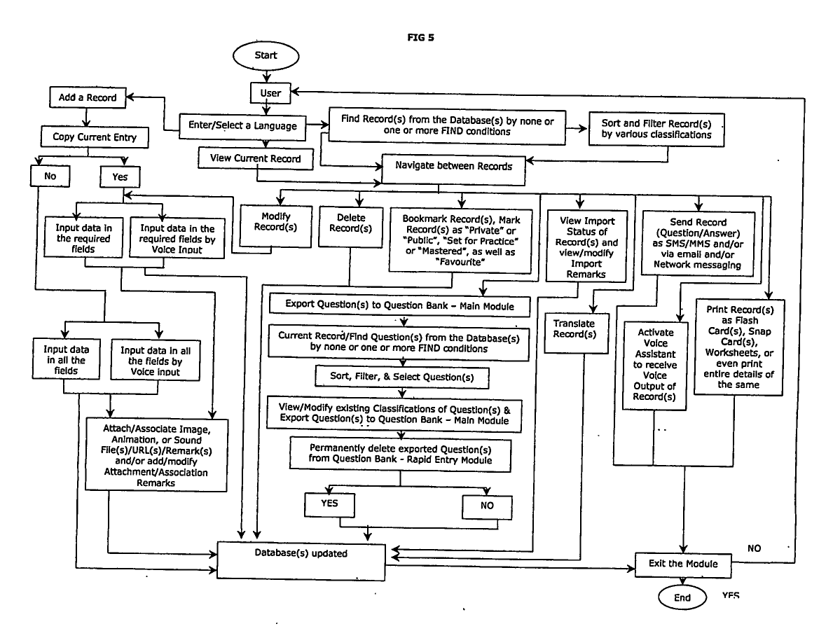

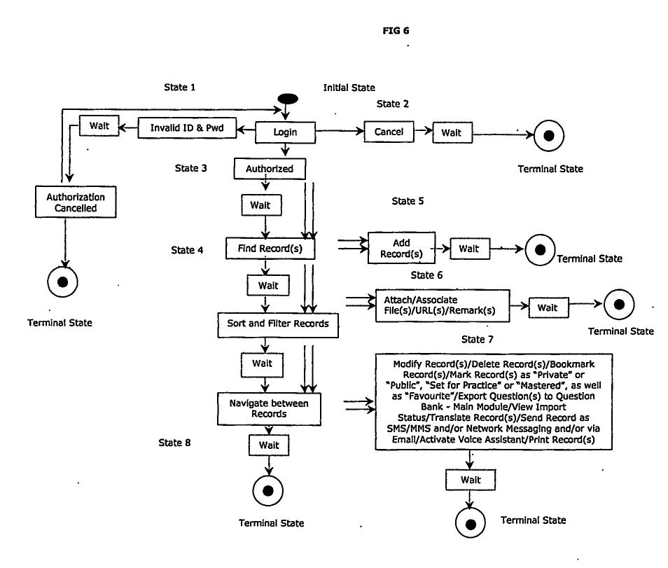

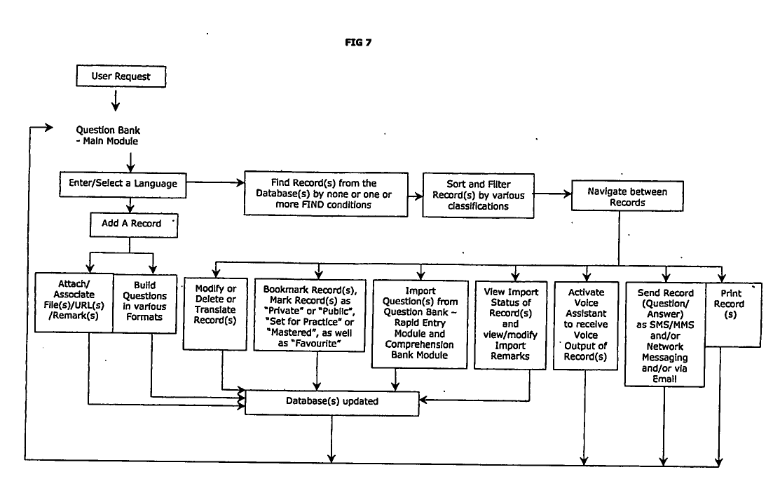

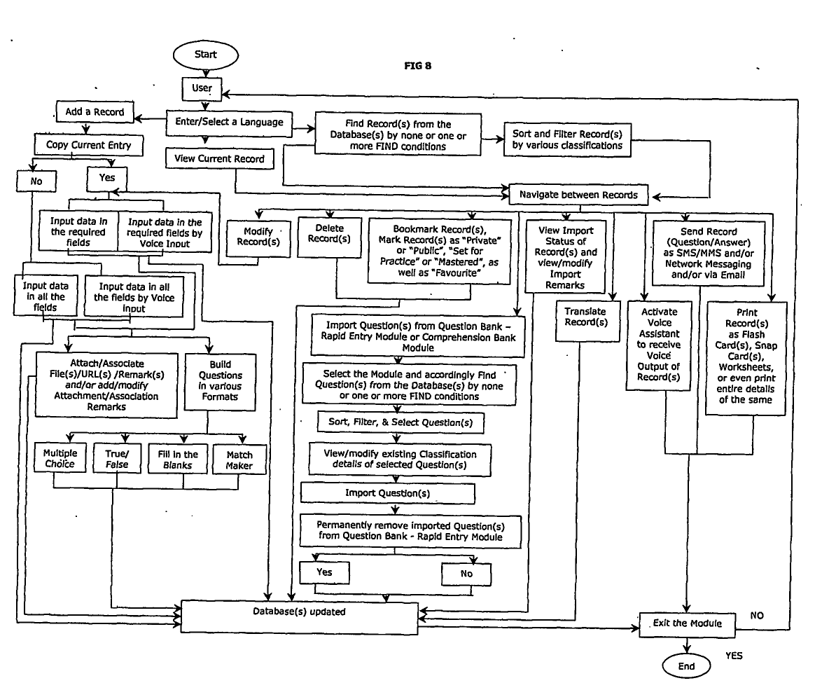

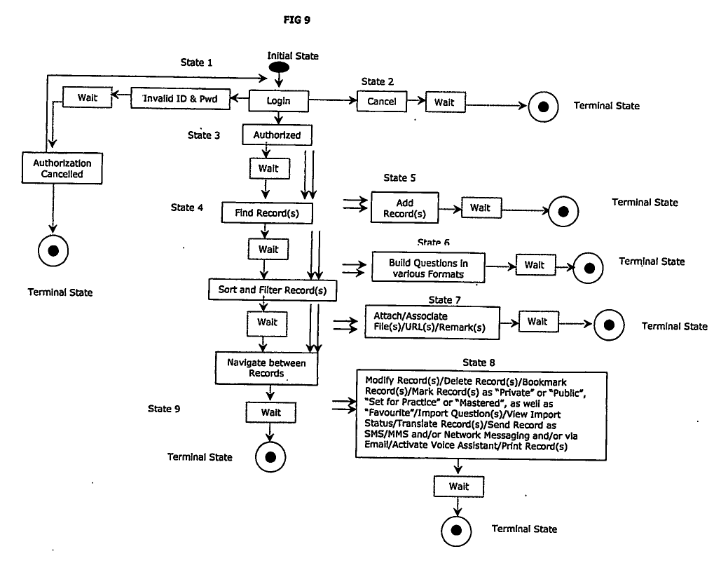

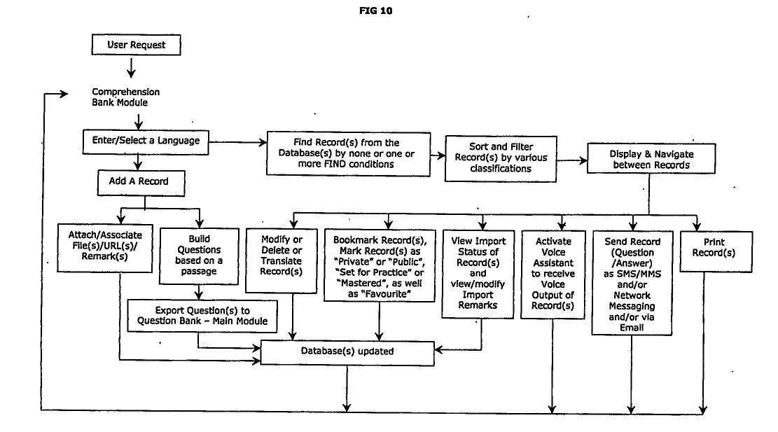

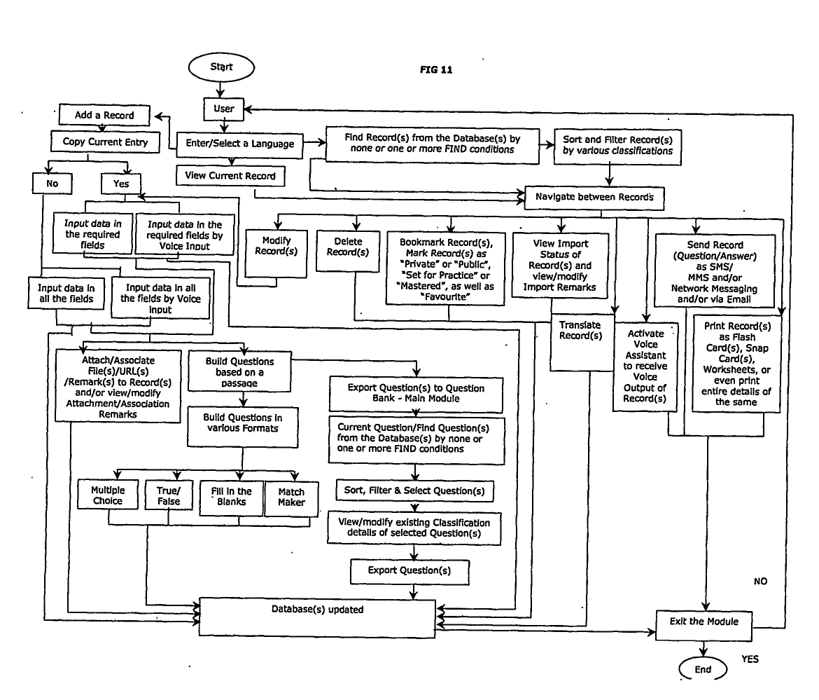

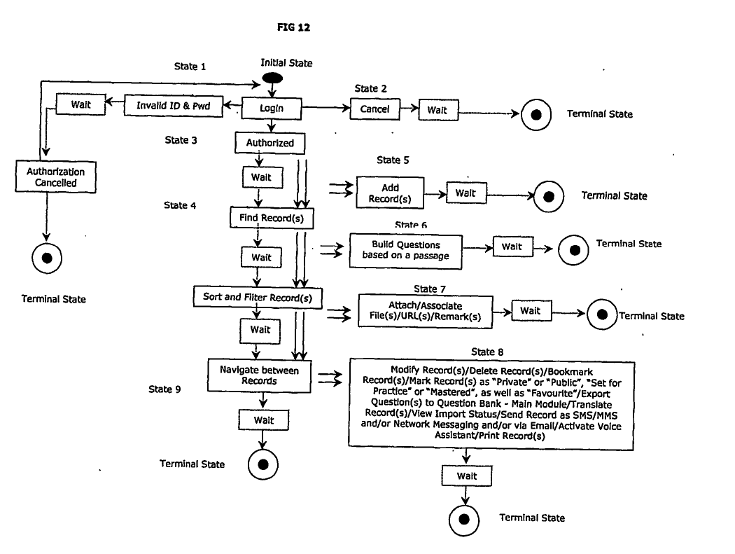

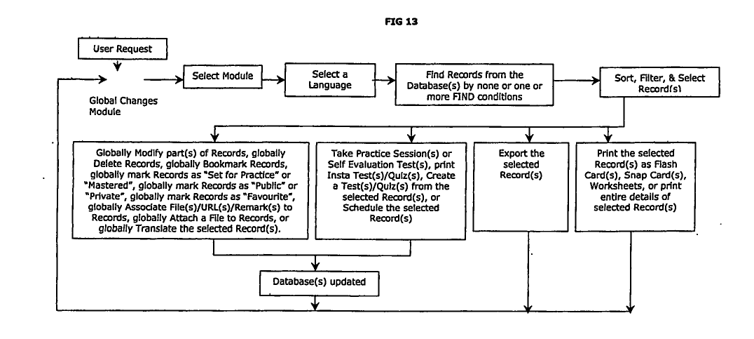

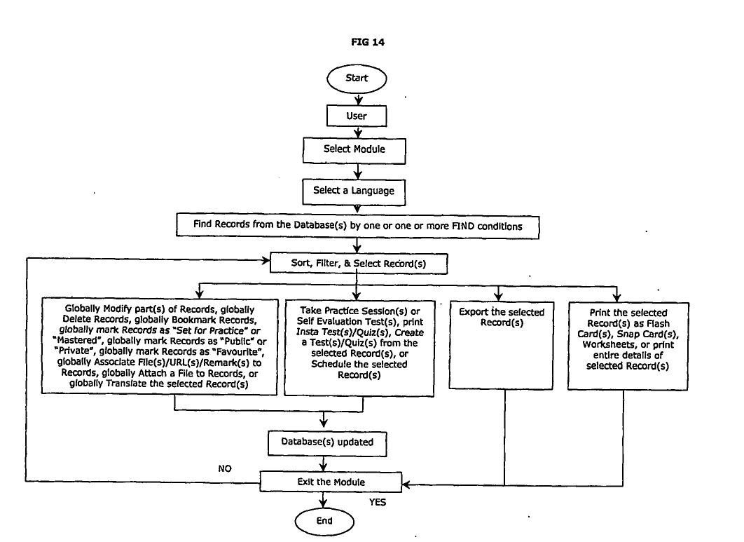

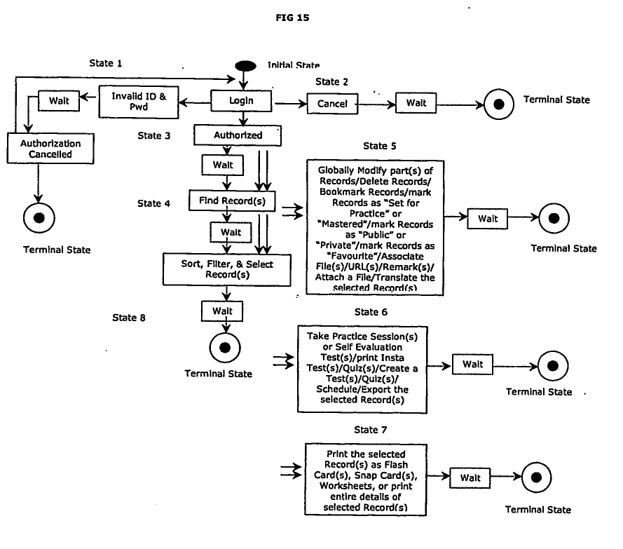

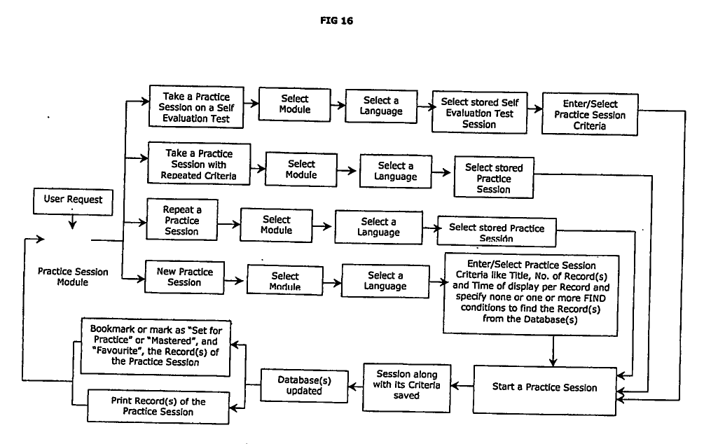

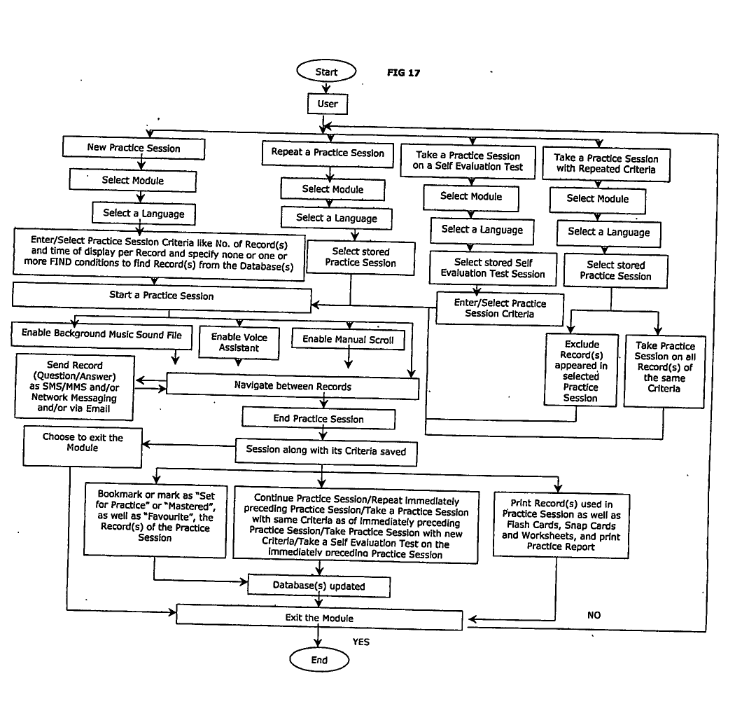

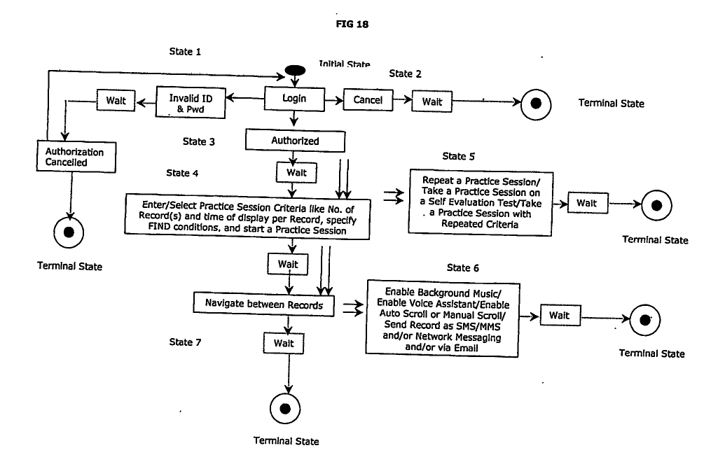

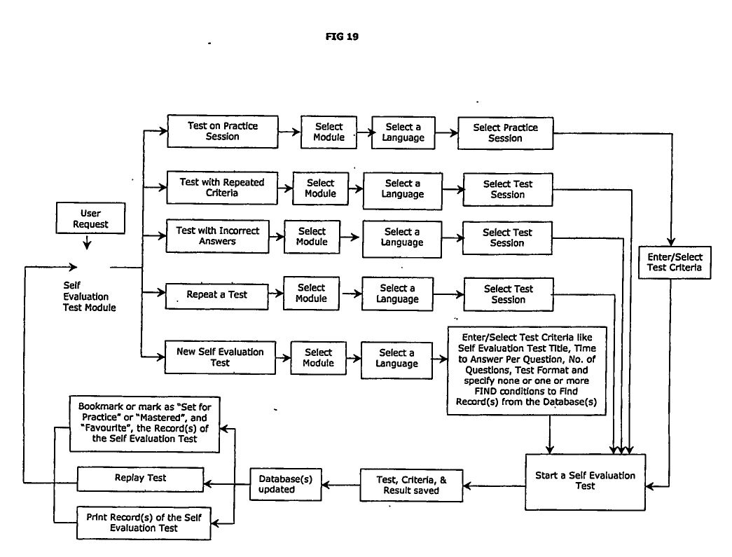

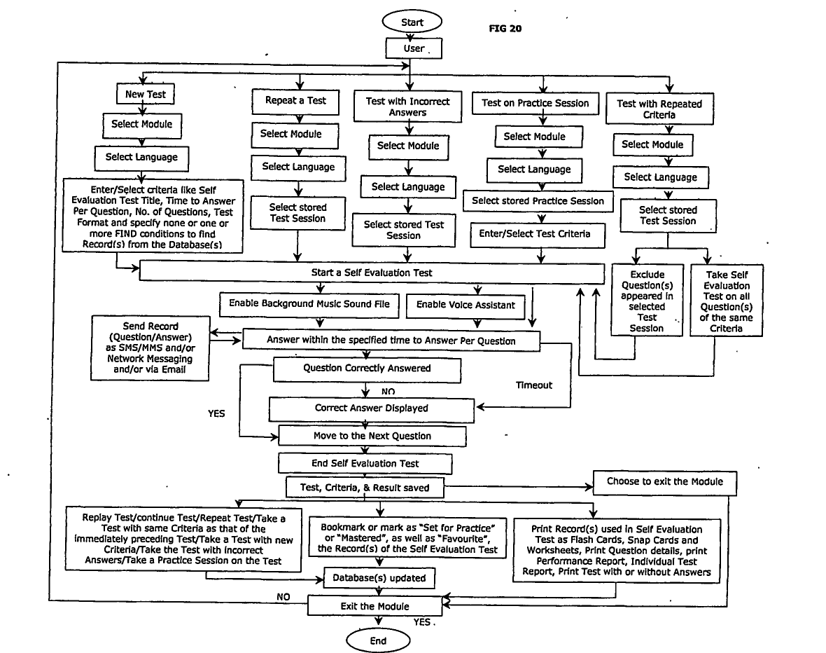

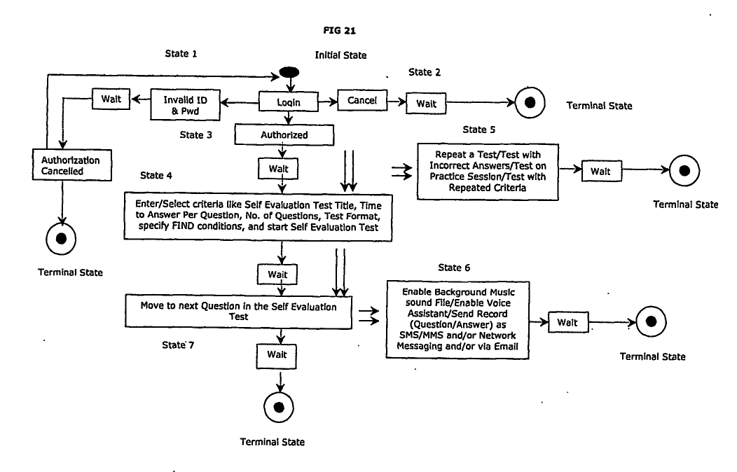

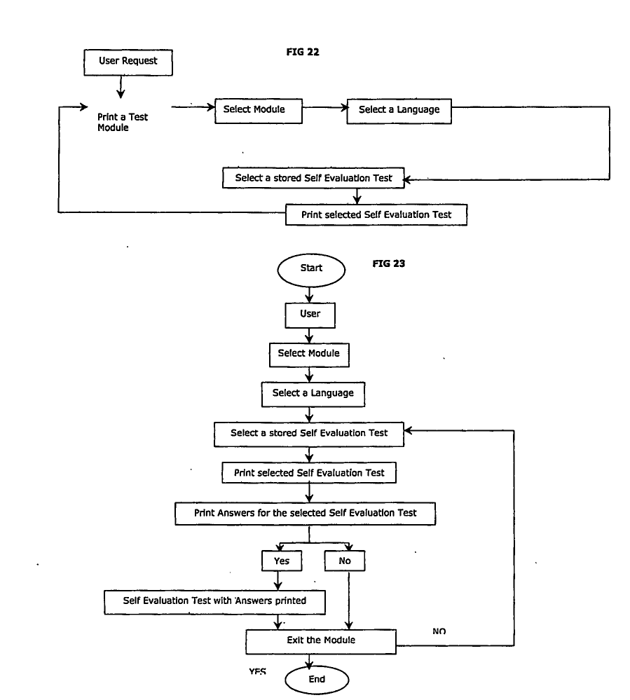

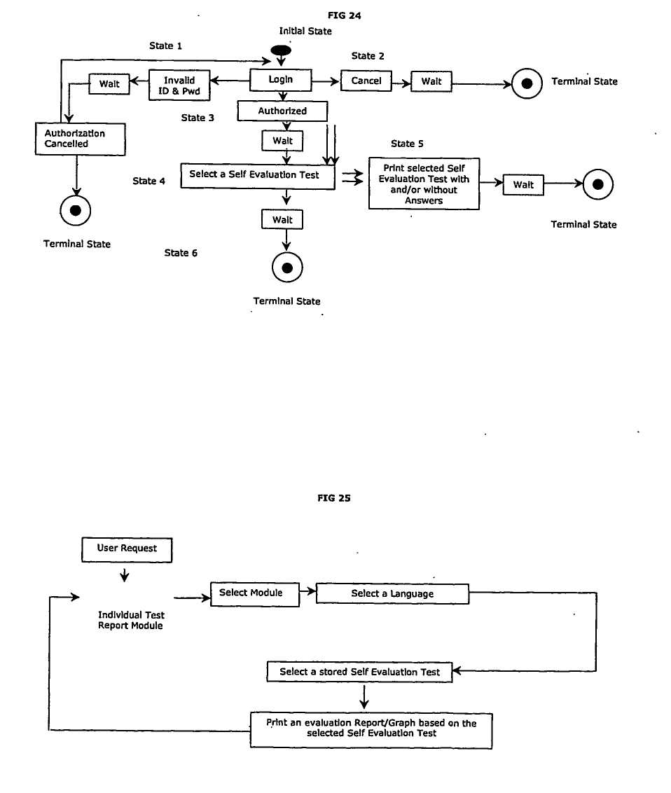

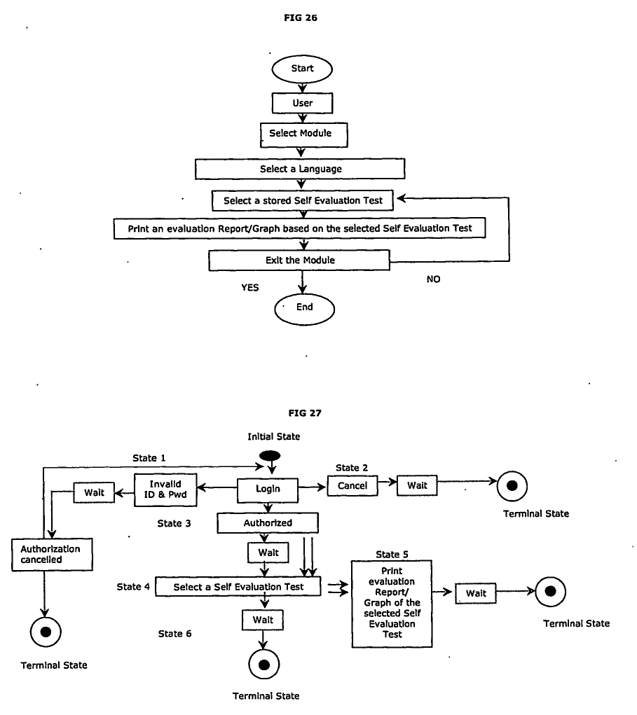

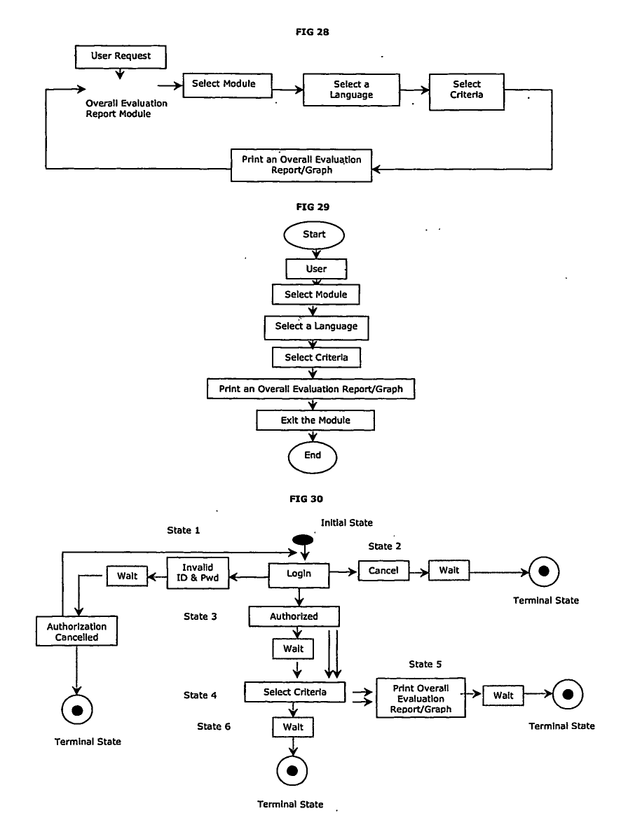

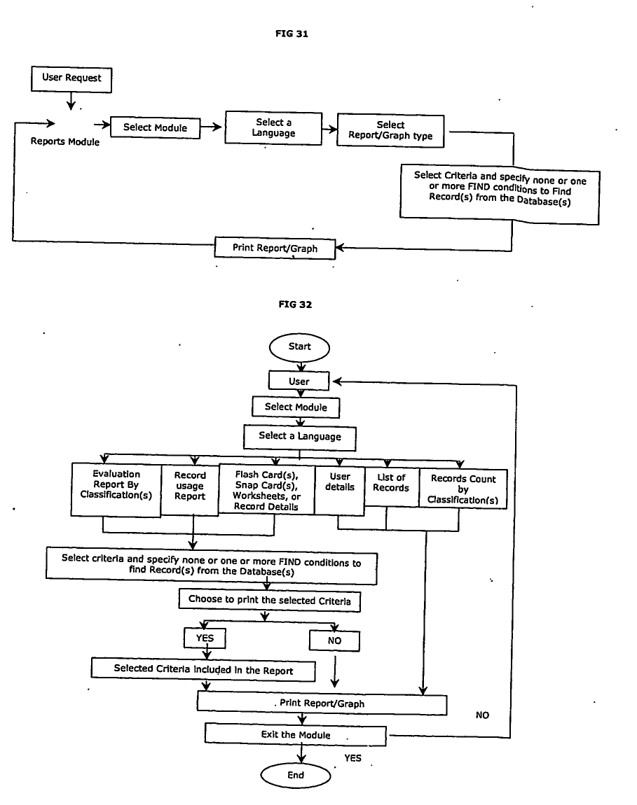

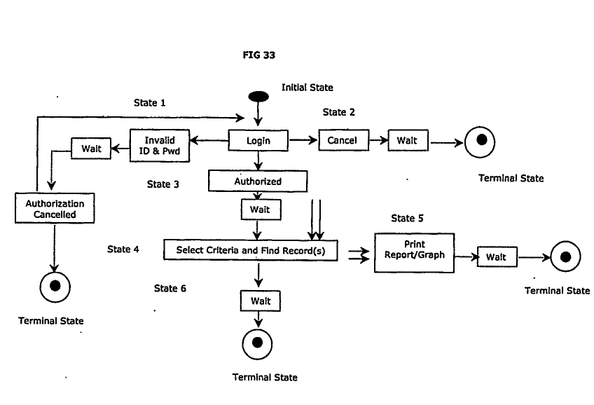

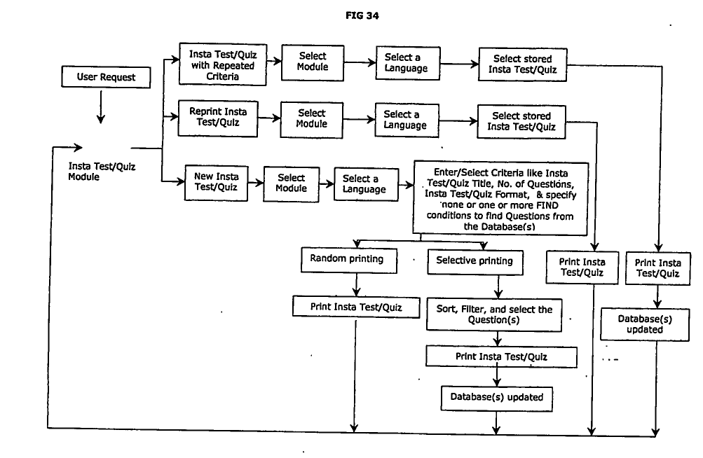

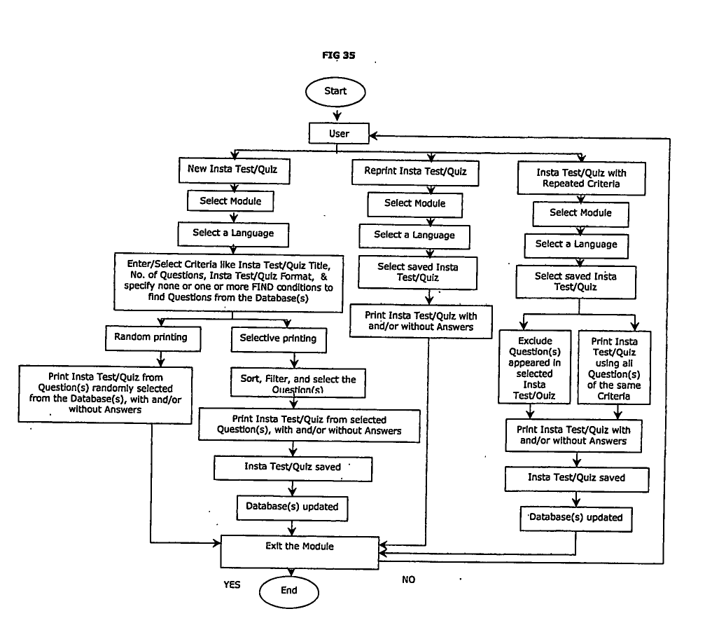

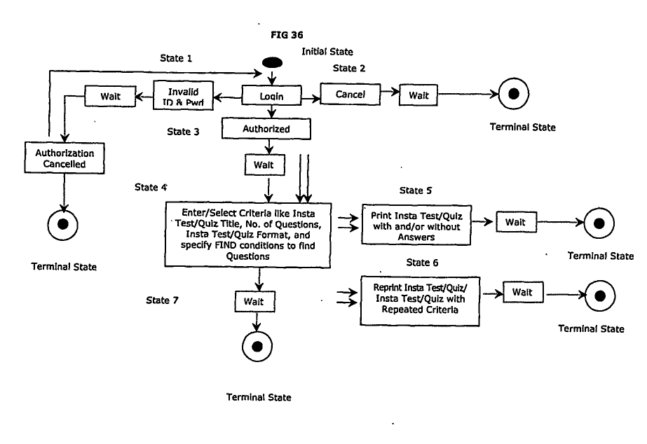

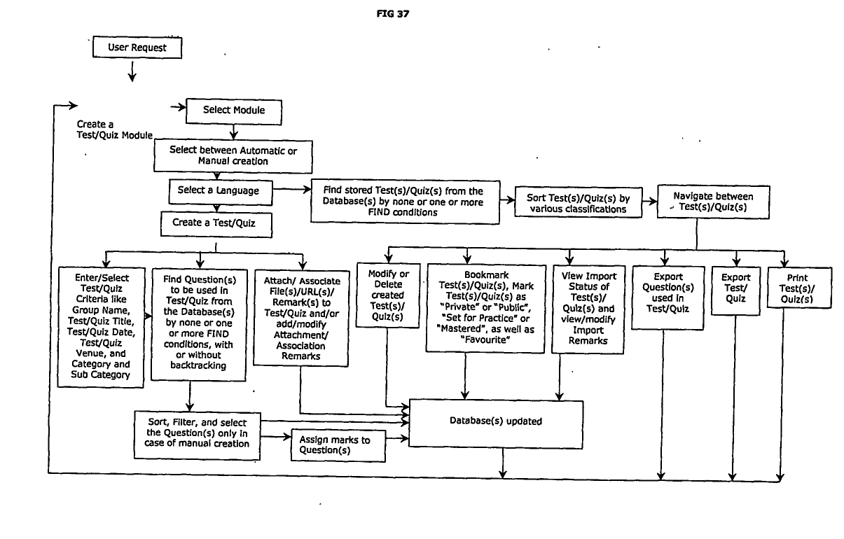

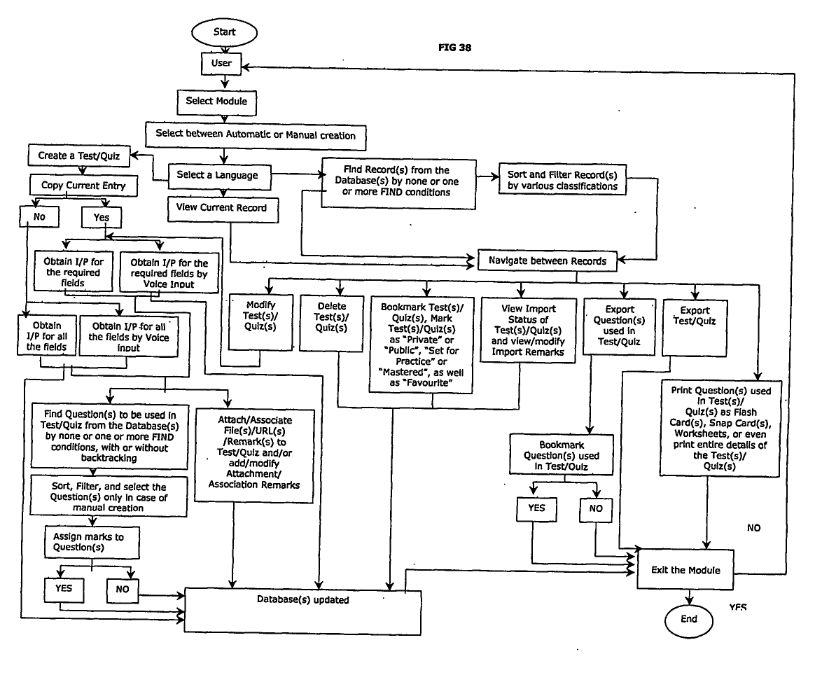

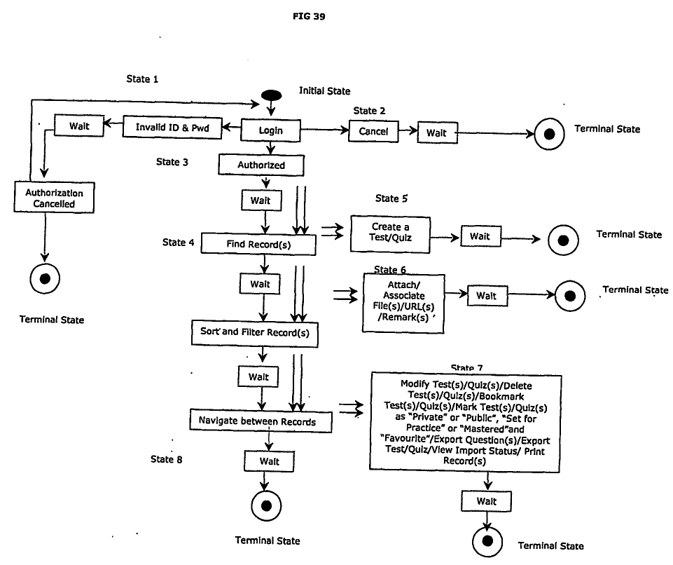

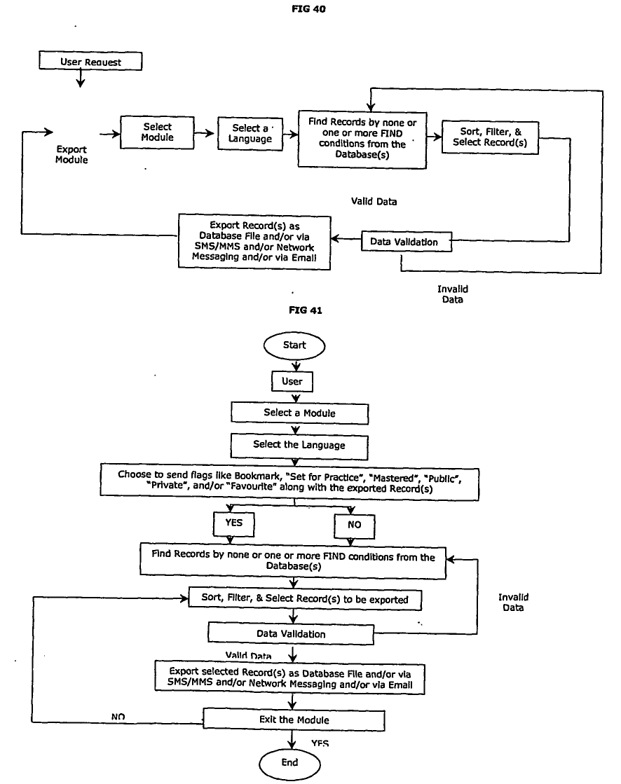

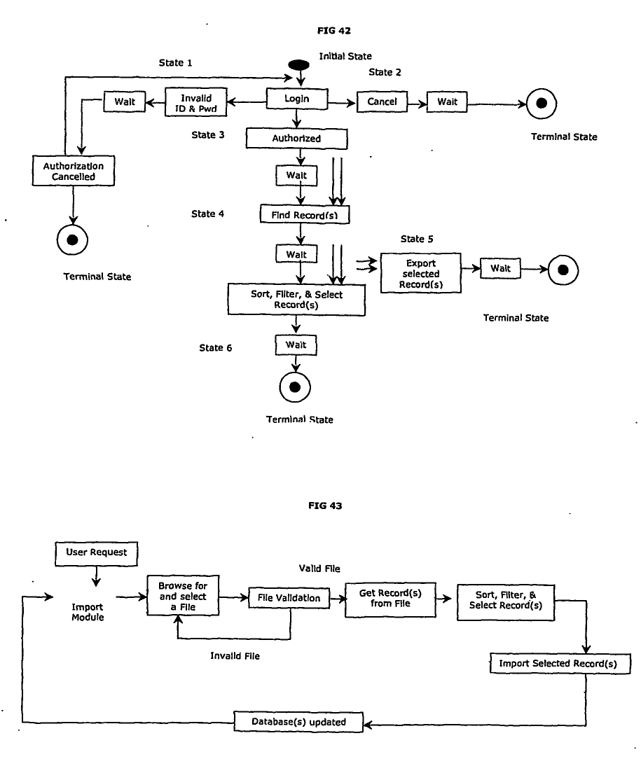

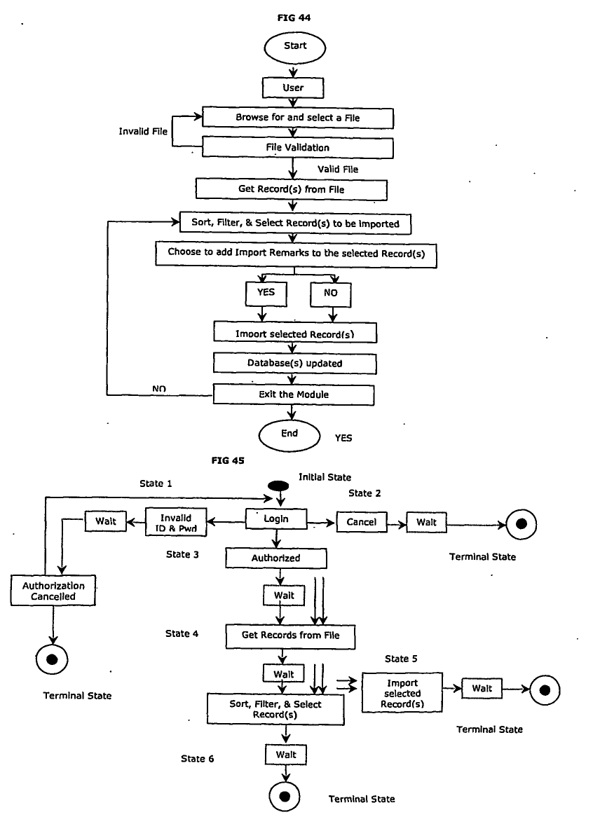

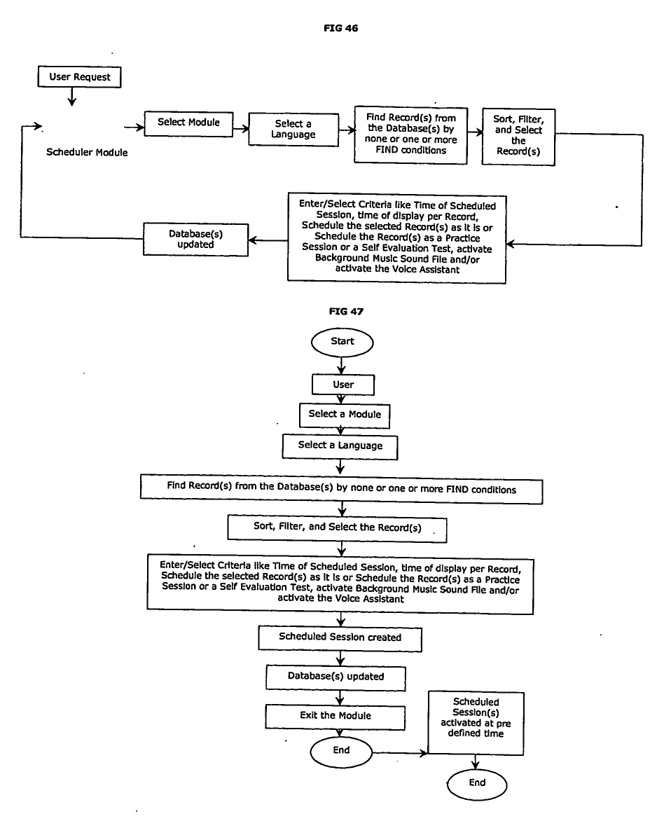

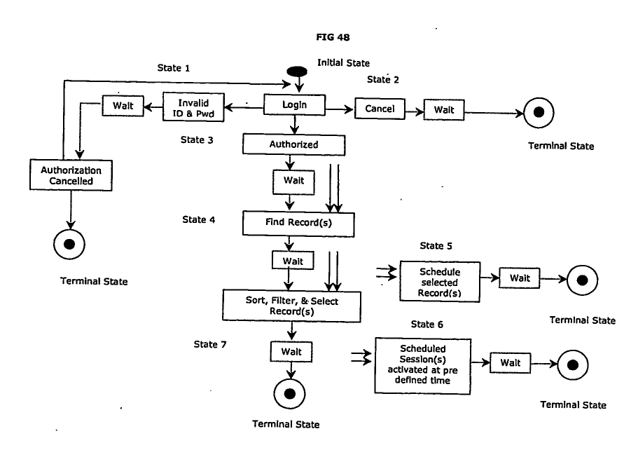

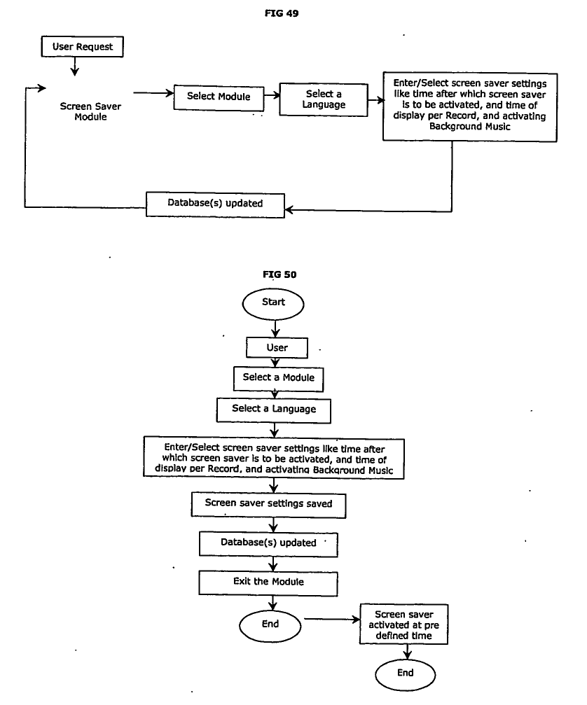

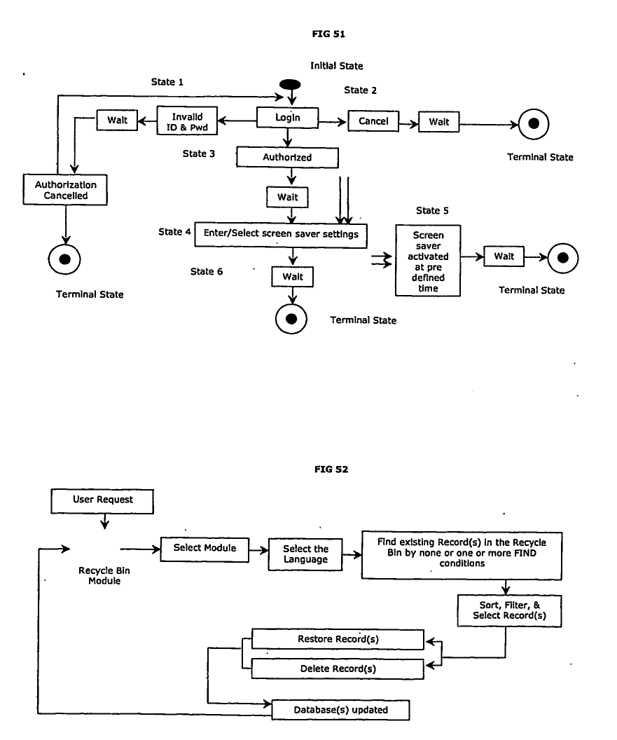

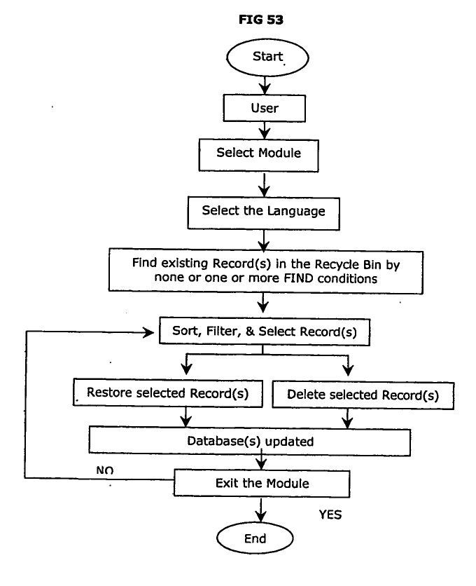

FIG. 3 is the diagram of the outline of the System process of the present invention. It exhibits the Modules of the System and their main functions.

FIGS. 4 to 15 explain the System Function, System Operation, System State Transition of the Question Bank—Rapid Entry Module, System Function, System Operation, System State Transition of the Question Bank—Main Module, System Function, System Operation, System State Transition of the Comprehension Bank Module, System Function, System Operation, System State Transition of the Global Changes Module, respectively, of the present invention. The Question Bank—Rapid Entry: Module allows the user to build Questions and Answers rapidly by fewer Classifications, thereby quickening the building process. The Question Bank—Main Module allows the user to build Questions and Answers by detailed Classifications, in various questioning formats such as Multiple Choice, True/False, Fill in the Blanks, and Match Maker. The Comprehension Bank Module allows the user to build and store ‘passages’ etc. by detailed Classifications, and build Questions and Answers based on such ‘passages’.

The Global Changes Module allows the user to globally Modify part(s) of Records, globally Delete Records, globally Bookmark Records, globally mark Records as “Set for Practice” or “Mastered”, globally mark Records as “Public” or “Private”, globally mark Records as “Favourite”, globally Associate additional information in the form of File(s)/URL(s)/Remark(s) to Records, globally Attach a File such as an Image, Animation, or a Sound file to Records, or globally Translate Records.

FIG. 4 describes the System Function of the Question Bank—Rapid Entry Module. The architecture of this Module comprises the following major functions, which allow a user to build Questions and Answers rapidly by minimum Classifications with the help of the User Interface.

The Module allows a user to:
Enter/Select a Language
Build Questions and Answers rapidly by minimum Classifications
Copy Current Entry
Attach/Associate File(s)/URL(s)/Remark(s) to Record(s)
Find existing Records from the Database(s) by none or one or more FIND conditions
Sort, Filter, and Select Record(s)
Modify Record(s)
Add/Modify Record(s) by Voice Input as well as receive Voice Output of Record(s)
Translate Record(s)
Delete Record(s)
Go To a Record and Navigate between Records
Print Record(s) by various Print conditions including printing of Flash Cards, Snap Cards, and Worksheets
Bookmark Record(s)
Mark Record(s) as “Set for Practice” or “Mastered”, “Public” or “Private” as well as “Favourite”
Send Record(Question/Answer) as SMS/MMS and/or Network Messaging and/or via Email
Export Question(s) and Answer(s) to the Question Bank—Main Module

FIG. 5 describes the System Operation of the Question Bank—Rapid Entry Module, explaining that the Module is based on user actions. The Question Bank—Rapid Entry Module accepts data in one or more languages (such data capable of being accepted from more than one user at the same time), with or without Voice, by minimum Classifications like (1) Date (the same being generated by the Control System and which can be modified by the user if needed) (2) Language (the user selects the available language or adds a new one) (3) Source of Information (to record the Source from where the user obtained the details the user is entering—EXAMPLE—The user may have read something in a particular book or magazine—say “XYZ” and would like to store this as Source of Information), and (4) Subject (to record the subject under which the Record, that the user is entering, is to be stored —EXAMPLE—A Question on the animal “YAK” may be stored under the subject ANIMAL WORLD).

When the user enters this Module, the Control System brings forth a User Interface from where the user can Enter/Select a Language, build Questions and Answers in that Language rapidly by minimum Classifications, Attach/Associate File(s)/URL(s)/Remark(s) to Question(s), Find existing Record(s) from the Database(s) by none or one or more FIND conditions, Sort, Filter, and Select Record(s), Modify Record(s), Delete Record(s), build/Modify Record(s) by Voice Input as well as receive Voice Output of Record(s), Translate Record(s), Go To a Record and Navigate between Records, Bookmark Record(s), Mark Record(s) as “Set for Practice” or “Mastered”, “Public” or “Private” as well as “Favourite”, Print Record(s); by various Print conditions including printing of Flash Cards, Snap Cards, and Worksheets, Send Record (Question/Answer) as SMS/MMS and/or Network Messaging and/or via Email, Export Question(s) and Answer(s) to the Question Bank—Main Module, and view Import Status. The user can also choose not to use any of these functionalities and close the User Interface to come out of the Module. All of these functionalities are described below in detail.

If the user chooses to build Questions and Answers, the user must first enter/select a Language. When the user chooses to build a Question, the Control System brings forth a User Interface which prompts the user to copy the current Question and Answer if any, facing the user, in terms of data input fields comprising of the Header (Classifications), Question, Answer and Remarks, and/or Attachment/Association(s), such “Copy Current Entry” utility being of immense use to the user to simplify the building of Questions and Answers having at least common Classifications. If a user selects to copy the Header (Classifications), then the Classifications under which the current Question facing the user is classified, will be copied.—EXAMPLE—if a user has an existing Record classified as:

Subject: Animal World

And the new Record being added by the user also happens to be falling under the above classification, the “Copy Current Entry” utility would make the new entry easier for the user, in that, the user would not have to reclassify the new entry. If a user selects to copy the Question, Answer and Remarks, the current Question, Answer and Remarks, facing the user will be copied. If a user selects to copy the Attachment/Associations to the current Question facing the user, then the Attachment/Associations will be copied accordingly. If a user chooses not to use this “Copy Current Entry” utility, then the Control System gets notified and blanks out all the relevant data input fields for new data input by the user.

The user can build Questions and Answers by entering the same in relevant data input fields provided for the purpose. It is mandatory for the user to do this, else the Question and Answer will not be saved in the Database(s). The user can further add Remarks about the Question and Answer in a data input field provided for the purpose.

The user can further choose to Attach/Associate additional information like File(s) including Image, Animation or Sound File(s), URL(s), and Remarks to the Question being built by the user—EXAMPLE—The user may want to Attach a File such as an Image, Animation, or a Sound file to the Record(s), or the user may want to Associate more information to the Record(s) by means of associating some information that may be on a file or a Web Site, and hence the user would Associate a file or URL to the Record. The user can open and view such File(s), provided the relevant applications for opening the file(s) are installed on the user's computer system. In case of a URL, the same would be opened by the Control System provided the user is connected to the Internet; The user may also simply Wish to add a REMARK to the Question. Such REMARKS are displayed to the user on demand. In case the user wants to Attach/Associate File(s) with the Record(s), the user must browse for and select the File(s), from a computer system. In case the user wants to Associate URL(s) or Remark(s), the user must enter the same into a data input field provided for the purpose. The user can further enter Remarks about each Attachment/Association in data input fields provided for the purpose. The user can further delete the Association(s) or remove the Attachment that the user might have given at this time. The Control System updates the Database(s) in this case.

After the user builds and chooses to save the Question and Answer in the manner described above, the Control System saves the same, generates a new Record Id for the same, and updates the Database(s). The Control System generates a new Record ID each time a new entry is made by a user or when a Record is imported by the user.

If the user wants to find existing Record(s) in the Database(s), the Control System brings forth a User Interface from where the user enters/selects a FIND criterion, and based on the same, the Control System finds and retrieves the Record(s) from the Database(s). The user can find Record(s) by one or none or more FIND conditions. EXAMPLE—If the user wishes to find Record(s) pertaining to the subject ANIMAL WORLD, the user must select the subject ANIMAL WORLD in the Subject field of the User Interface. Similarly, if the user wishes to find Record(s) pertaining to the Source of Information ‘XYZ’, the user must select the Source of Information ‘XYZ.2 in the Source of Information field in the User Interface. The user can also enter relevant keywords in the keywords field, which would bring forth those Questions and Answers, which contain the exact match or part thereof of the keywords entered by the user. The user can enter more than one keyword and can also choose to include or exclude the whole or part of any keyword—EXAMPLE—The user can enter one or more words separated by a space in the keywords field, and further the user can add a “+” separator or a “−” separator to include or exclude the subsequent word with respect to the immediately preceding word. The Control System searches for the keyword in the Question, Answer, and Remarks fields of the Records and brings forth the Find Results accordingly. The user can also find Records by a Date range, and by the Record ID. The user has the further option to exclude these FIND conditions.—EXAMPLE—If the user enters the Subject as ANIMAL WORLD and chooses to exclude the same, the Control System will avoid showing those Record(s) having the Subject as ANIMAL WORLD in the Find Results. The same (i.e the option to exclude a FIND condition) applies accordingly in case of Source of Information, keywords, Date Range and Record Id. The user can further find Record(s) by whether or not the Record(s) has been Bookmarked. In case where the Record is Bookmarked, the user can find it by entering the appropriate Bookmark Remarks that the user may have assigned to the Record at the time of bookmarking the Record in the Module. The user has the further option of excluding the entered Bookmark Remark.—EXAMPLE—If the user has entered the Bookmark Remarks as “XYZ” and chooses to exclude the same, then the Control System will avoid showing those Record(s) where “XYZ” is there in the Bookmark Remarks, in the Find Results. The user can find by whether or not the Record(s) have been marked as “Public”/“Private” or both, “Set for Practice”/“Mastered” or both, as well as “Favourite”The user has a further option to exclude these flags—EXAMPLE—If the user chooses to exclude Record(s) marked as “Set for Practice”, the Control System will bring forth Find Results showing Record(s) marked as “Mastered” as well as Record(s) which are not marked either as “Set for Practice” or “Mastered”The user can further find Record(s) by a Criteria of whether or not the Record(s) have Associations or File Attachments. If the user selects to find Record(s) that have File Attachments, the user must further select the type of the File Attachment as either an Image, Animation, or a Sound file. The user has a further option to exclude the type of the File Attachment.—EXAMPLE—If the user selects the type of the File Attachment as ‘IMAGE’ and chooses to exclude the same, the Control System will bring forth Find Results showing those Record(s) which do not have Image files as Attachments. Further the user can find by entering the relevant Attachment/Association Remarks if any, related to the Attachment/Association of the Record(s). The user has a further option to exclude the entered Attachment/Association Remark(s).—EXAMPLE—If the user has entered the Attachment/Association Remarks as “XYZ” and chooses to exclude the same, then the Control System will bring forth Find Results showing those Record(s) where “XYZ” is not there in the Attachment/Association Remarks. The user can further find by the Import Remarks, if any, given to the Records that were imported, with a further option to find by excluding the same in the same manner as described in case of Attachment/Association Remarks. The user can also choose to find by more than one master for a particular Criteria by using the Custom option.—EXAMPLE—the user can choose to find Record(s) for the Age Groups ‘JUNIORS’ as well as ‘SENIORS’ at a time. The user can further find Record(s) by Accuracy and Frequency of Occurrence—EXAMPLE—in case of Accuracy, the user finds according to the performance of the user on the Question in a Self Evaluation Test. In case of Frequency of Occurrence, the user finds by whether or not a Question has appeared in a Self Evaluation Test or a Practice Session and if so, the number of times it has appeared, and also the time period in which it has appeared. The user has a further option to find Record(s) by excluding the Accuracy and/or Frequency of Occurrence as may be specified by the user.

If the user chooses none of the FIND Criteria described above, then the Control System brings forth Find Results showing all the Question(s) stored in the Database(s), by all the FIND Criteria. If the user chooses one of the FIND Criteria described above, then the Control System brings forth Find Results showing Question(s) pertaining only to that Criteria. If the user chooses more than one FIND Criteria described above, then the Control System brings forth Find Results showing Question(s) pertaining to the Criteria chosen by the user.

After the user has chosen to find the Questions by none or one or more of the FIND conditions described above, the Control System brings forth a User Interface showing a grid displaying the Record(s) brought forth according to the FIND conditions, and from where the user can Sort, Filter, and Select the Record(s) in the grid. The grid shows the part(s) of the Records like Subject, Record Id, Source of Information as columns. The user can Sort the Records, in ascending or descending order, by Classifications. The user can apply the Sort condition to the Records currently displayed in the Find Result grid facing the user or the entire set of found Records. The user can also do single level sorting, in ascending or descending order, by clicking on any column in the grid.—EXAMPLE—If the user clicks on the Subject column, then all the Records in the grid will get sorted by subject of the Records in ascending or descending order. The user can also do multilevel sorting, in ascending or descending order, wherein the user can select more than one field in a Record.—EXAMPLE—If the user wishes to Sort Records in the grid by Subject and Source of Information, the user must select the fields of Subject and Source of Information in a User Interface provided for the purpose. The user can further choose to Filter the Records in the grid according to various Criteria. —EXAMPLE—If the user wishes to see only Records of the subject ANIMAL WORLD in the grid, then the user can apply the Filter to the Subject column. The user can further choose to apply the Filter to more than one column in the grid, wherein the user must select more than one fields of the Record to apply the Filter.—EXAMPLE—If the user Wishes to view the Records of the Subject ANIMAL WORLD and having Source of Information as “NATIONAL GEOGRAPHIC”, then the user must select to apply Filters to the Subject and Source of Information fields respectively.

For the Date and Record Id fields, the user can apply the Filter by ranges—EXAMPLE—If the user wants to view Record(s) in the grid created between particular dates, the user must select the respective dates in a User Interface provided for the purpose. The same holds in case of the Record Id field. For text based fields like Question and Answer, the user can apply the Filter by entering keywords—EXAMPLE—If the user wants to view all Questions in the grid beginning with the letter ‘A’, the user can enter the keyword as ‘A*’ in a User Interface provided for the purpose.

If the user wants to view all Questions in the grid having the word “ABACA”, the user can enter the keyword as ‘ABACA’ in a User Interface provided for the purpose. The user can further enter more than one keywords. In case of master based fields like Subject and Source of Information, the user has to select the exact master.—EXAMPLE—If the user wants to view all Questions in the grid classified under Subject “ANIMAL WORLD”, the user must select the Subject as “ANIMAL WORLD” in a User Interface provided for the purpose. The Control System applies the Filter to the Records in the grid as per the user's choice The user can further remove the Filter on one or more columns in the grid. The user has a further option of excluding any of the Filter conditions as may be specified by the user “in the same manner as described in case of excluding any of the FIND conditions. Further, the user can select the Record(s) in the grid and further view all the selected Record(s) through a “Selected So Far” utility. The Control System brings forth a User Interface wherein the user can further Sort, Filter, as well as select Record(s) as well as undo this selection. The user can also view the Classification details of the Record(s). The user can further print the selected Record(s) as Flash Card(s), Snap Card(s), Worksheets, or even entire details of the same. The user can further make global changes to the selected Record(s), as described in FIGS. 13 and 14.

The following utilities are available to a user from the User Interface displaying the Find Result grid:
1. Sort and Filter the Records by various Classifications as explained above
2. Select single or multiple Records as well as undo selections of the same as explained above
3. View classification details of selected Records as explained above
4. View selected Records in a further grid through a ‘Selected so far’ utility, with a further possibility of unselecting Records from this grid.
5. Print Flash Cards, Snap Cards, Worksheets, or entire details of selected Records
6. Make global changes as mentioned above
7. Take a Practice session using the selected Records as explained below
8. Take a Self Evaluation Test using the selected Records as explained below
9. Create a Test/Quiz using the selected Records as explained below
10. Print an Insta Test/Quiz using the selected Records as explained above
11. Schedule the selected Record(s) as explained below
12. Export the selected records as explained below

Further, the user can take Practice Session(s) or Self Evaluation Test(s), print Insta Test(s)/Quiz(s), Create a Test(s)/Quiz(s) from the selected Record(s), Schedule or Export the selected Record(s), only in case the selected Record(s) in the Find Result grid belong to the Question Bank—Rapid Entry Module, Question Bank—Main Module, or the Comprehension Bank Module.

If the user chooses to take a Practice Session or a Self Evaluation Test from the selected Record(s), then the Control System brings forth a User Interface from where the user can enter/select Criteria like the Practice Session Title or Self Evaluation Test Title, time of display per Record or time to answer per Question, Test Format, select to activate Background Music during the Practice Session or Self Evaluation Test, and start the Practice Session or Self Evaluation Test. The Control System then starts a Practice Session or a Self Evaluation Test which are described in detail in FIGS. 16, 17 and 19, 20 respectively. At the end of a Practice Session or a Self Evaluation Test, the Control System saves the Practice Session or Self Evaluation Test, generates a new Practice Session Id or Self Evaluation Test Id for the same, and thus updates the Database(s). After the user has taken a Practice Session or a Self Evaluation Test in this manner, the Control System then takes the user back to the User Interface displaying the Find Result grid.

If the user chooses to print an Insta Test/Quiz from the selected Record(s), then the Control System brings forth a User Interface from where the user can enter/select Criteria like Group Name, Insta Test/Quiz Title, Insta Test/Quiz Date, Insta Test/Quiz format, and choose to print the Insta Test/Quiz. The Control System brings forth a print preview of the Insta Test/Quiz, described in detail in FIGS. 34 and 35, from which the user can print the same. After the user closes this print preview, the Control System saves the Insta Test/Quiz, generates a new Insta Test/Quiz Id for the same, and thus updates the Database(s). After the user prints an Insta Test/Quiz in this manner, the Control System then takes the user back to the User Interface displaying the Find Result grid.

If the user chooses to Create a Test/Quiz from the selected Record(s), the Control System brings forth a User Interface from where the user can enter/select Criteria like Group Name, Test/Quiz Title, Test/Quiz Date, Test/Quiz Venue, and Category and Sub Categories of the Test/Quiz, and choose to create the Test/Quiz. The Control System creates the Test/Quiz using the selected Record(s), generates a Test/Quiz Id, and thus updates the Database(s). The creation of a Test/Quiz is described in detail in FIGS. 37 and 38. After the user has created a Test/Quiz in this manner, the Control System then takes the user back to the User Interface displaying the Find Result grid.

If the user chooses to Schedule the selected Record(s), the Control System brings forth a User Interface from where the user can enter/select Criteria like Scheduled time of display, Scheduled Date, Select to activate Background Music and Voice Assistant, choose between scheduling the Record(s) or scheduling Practice Session(s) or Self Evaluation Test(s) using the Record(s). The Scheduling activity is described in detail in FIGS. 46 and 47. The Control System Schedules the Record(s) accordingly to be displayed on the user's computer, including hand held devices, saves such a Scheduled Session, generates a new Scheduled Session Id, and thus updates the Database(s). After the user has scheduled the selected Record(s), the Control System then takes the user back to the User Interface displaying the Find Result grid.

If the user chooses to Export the selected Record(s), the Control System creates a Database file using the selected Record(s) and brings forth a User Interface from where the user must browse for and select the desired file/folder destination on a computer system to save this Database file. After the user does this selection and chooses to save the file, the Control System saves the file accordingly, notifies the user that the Record(s) have been exported, and displays the number of Record(s) exported. The utility(s)/functionality(s) available to the user at the time of exporting Record(s), as described in FIGS. 40 and 41, are also available in this case. After the user exports the selected Record(s), the Control System then takes the user back to the User Interface displaying the Find Result grid.

Double clicking on any Record in the Find Result grid will take the user to the concerned Record in the Module.

If the user wishes to Modify an existing Record in this Module, all the utility(s)/functionality(s) available at the time of building Questions and Answers would be available to the user and using the same, the user can make further modifications in the Question if required. After modification, if the user chooses to save the Record, the Control System saves the modifications done to the same and updates the Database(s).

If the user wishes to Delete an existing Record in this Module, the Control System prompts the user as to whether or not the user wishes to do so. If the user chooses to continue, the Control System deletes the Record from the Module, sends it to the Recycle. Bin of the System, and updates the Database(s). Sufficient security is provided by the System, so as not to allow the deletion of any Record(s) that may be in use in Practice Session(s), Self Evaluation Test(s), Insta Test(s)/Quiz(s), Test(s)/Quiz(s), and/or Scheduled Session(s).

If the user chooses to Add and/or Modify Record(s) by Voice Input, the user can do so with or without a conjunction of input made by keyboard support, and/or use any other utility(s)/functionality(s) of the System, as may be supported by the System for such use, by Voice Command. The user can use all the utility(s)/functionality(s) available at the time of building or modifying Questions and Answers, by Voice Input. If the user builds a Question and Answer by Voice Input and chooses to save, the Control System saves the same, generates a new Record Id, and updates the Database(s). The user can further choose to receive Voice Output of the Questions and Answers by activating the Voice Assistant. A character appears which speaks out the text of the Questions and Answers through an embedded text to speech engine. The Control System saves the Voice Output of a particular Question and Answer in an mp3 file format, as may be specified by the user in the Voice Output option described in FIG. 56.

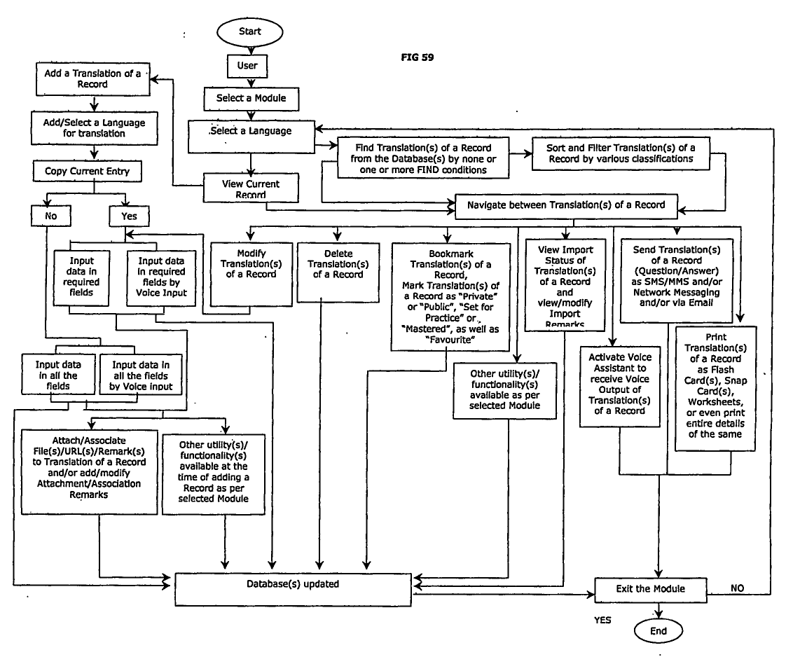

If the user chooses to Translate a Record in this Module, the user can do so by considering the Record as a parent Language Record and translate the same in any language of the user's choice. The translation is carried out in the manner described in the Translation Module in FIGS. 58 and 59. The Control System saves the Translation of the parent Language Record, generates a new Record Id, and thus updates the Database(s).

The user can further navigate back and forth between the Records of this Module and can also choose to directly go to a Record by entering its Record Id in a data input field provided for the purpose.

If the user chooses to Bookmark a Record in this Module, then the Control System brings forth a User Interface from where the user must enter some Bookmark Remarks in order to Bookmark the Record. The user can also view the earlier Bookmark Remarks, if any, and can modify the same. The Control System bookmarks the Record accordingly. From the User Interface, the user can also remove the flag of Bookmark from the Record. The Control System updates the Database(s) whenever a Record is Bookmarked or the Bookmark flag is removed from it.

If the user chooses to mark a Record in this Module as “Set for Practice” or “Mastered”, “Public” or “Private” and “Favourite”, the Control System flags the Record accordingly. Further when a Record is marked as “Private” by a user who has logged in to the System, the Record will not be visible to other users who log into the same System at any other point of time. The user can also choose to remove the flag of “Set for Practice” or “Mastered”, “Public” or “Private” and “Favourite”. The Control System updates the Database(s) whenever a Record is marked as “Set for Practice” or “Mastered”, “Public” or “Private” and “Favourite”, or whenever these flags are removed from the Record.

If the user chooses to print Record(s) in this Module, the user can do so by any of the following conditions. The user can print the current Record facing the user as Flash Card, Snap Card, Worksheet, or even print entire details of the Record. The user can further print choose to print Record(s) found by a FIND condition as specified by the user, in the same manner as that of the current Record. The Control System brings forth the print previews accordingly from which the user can further print. The Printing utility further allows the Print reports to be Exported to various destinations in various file formats.

The user can choose to send a Record (Question/Answer) of this Module as SMS/MMS and/or Network Messaging and/or via Email.

If the user chooses to export Questions to the Question Bank—Main Module, the user can either select to export the current Question facing the user, or select to export Question(s) by finding the same by none or one or more FIND conditions as specified by the user. The FIND conditions in this case are the same as described above. The Control System brings forth a User Interface displaying the Record(s) in a Find Result grid according to the FIND conditions. This User Interface provides the user with the same utility(s)/functionality(s) applicable to Record(s) in a Find Result grid as described above. After the user selects to export Questions in either manner, the Control System brings forth a User Interface wherein the user can view or modify the Classifications of the Question(s) before exporting them. If the user continues, the Control System exports the Question(s) to the Question Bank—Main Module along with their Classification(s), notifies the user about the same and displays the number of Questions exported, generates new Record Id(s) for the Question(s) in the Question Bank—Main Module, and thus updates the Database(s). The user can view or modify these exported Question(s) in the Question Bank—Main Module. The user is provided with a choice to retain or permanently delete the exported Question(s) from the Question Bank—Rapid Entry Module, once they have been exported. In case the Record(s) are thus deleted, they are permanently removed from the System.

If the user chooses to view Import Status of a Record in this Module, the Control System will bring forth a User Interface showing whether or not the Record has been imported from a Database File in the manner described in the Import Module in FIGS. 43 and 44. The user can further view and modify the Import Remarks associated with the Record in a data input field provided for the purpose.

The Module also accepts data built by another user (Exporting user) of the System, and which may be further manipulated by the user (Importing user) to suit the user's requirements. (EXAMPLE—the Exporting user may have classified a Question on the animal “YAK” under the subject ANIMAL WORLD, but the Importing user would like to classify the same under the subject WILD LIFE)

The Questions and Answers built in this Module can be used for, inter alia, taking Practice Sessions, Scheduling Sessions, taking Self Evaluation Tests, and for creating Tests/Quizzes.

Any data entered or imported into the Question Bank—Rapid Entry Module is further used as part of the functions of the other Modules of the System.

Note: The flags like Bookmark, “Set for Practice”, “Mastered”, “Public”, “Private”, and “Favourite” applied to a Record by a user who has logged into the System will not be visible to any other user who logs into the same System at any other point of time.

FIG. 6 describes the System State Transition of the Question Bank—Rapid Entry Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIG. 7 describes the System Function of the Question Bank—Main Module.

The architecture of this Module comprises the following major functions, which allow a user to build Questions and Answers by well-defined Classifications with the help of the User Interface.

The Module allows a user to:
Enter/Select a Language
Build Questions and Answers by well-defined Classifications
Copy Current Entry
Find the available hierarchy of Subject and Sub-Subject(s)
Find related Record(s) having the same Classifications as that of the current Record, as may be defined by the user
Build Questions and Answers in various Questioning Formats such as:
Multiple Choice
True/False
Fill in the Blanks
Match Maker
Attach/Associate File(s)/URL(s)/Remark(s) to Record(s)
Find existing Records from the Database(s) by none or one or more FIND conditions
Sort, Filter, and Select Record (s)
Modify Record(s)
Add/Modify Record(s) by Voice Input as well as receive Voice Output of Record(s)
Translate Record(s)
Delete Record(s)
Go To a Record and Navigate between Records
Print Record(s) by various Print conditions including printing of Flash Cards, Snap Cards, and Worksheets
Bookmark Record(s)
Mark Record(s) as “Set for Practice” or “Mastered”, “Public” or “Private” as well as “Favourite”
Send Record (Question/Answer) as SMS/MMS and/or Network Messaging and/or via Email
Import Question(s) and Answer(s) from the Question Bank—Rapid Entry Module and Comprehension Bank Module

FIG. 8 describes the System Operation of the Question Bank—Main Module, explaining that the Module is based on user actions. The Question Bank—Main Module accepts data in one or more languages (such data capable of being accepted from more than one user at the same time), with or without Voice, by well-defined Classifications like (1) Date (the same being generated by the Control System and which can be modified by the user if needed), (2) Language (the user selects from the available languages or adds a new one), (3) Source of Information (to record the Source from where the user obtained the details the user is entering—EXAMPLE—The user may have read something in a particular book or magazine—say “XYZ” and would like to store this as Source of Information), (4) Age Group (to record the relevant Age Group for which the Record, that the user is entering, is meant for—EXAMPLE—the Record may be meant for JUNIORS AGE GROUP or SENIORS AGE GROUP etc.), (5) Difficulty Level (to record the level of difficulty of the Record that the user is entering for an Age Group), (6) Subject (to record the Subject under which the Record, that the user is entering, is to be stored—EXAMPLE—A Question on the animal “YAK” may be stored under the subject ANIMAL WORLD), (7) Sub Subject(s) (to record the Sub Subject(s) under which the details that the user is entering is to be stored—EXAMPLE—A Question on the animal “YAK” may be based on the subject ANIMAL WORLD and the user may want to further classify the same up to 5 levels {Sub Subjects} e g. SUBJECT>ANIMAL WORLD>SUB SUBJECT1>TERRESTRIAL ANIMAL>SUB SUBJECT2>MAMMAL>SUB SUBJECT3>QUADRUPED>SUB SUBJECT4>HERBIVORE>SUB SUBJECT5>WILD ANIMAL).

When the user enters this Module, the Control System brings forth a User Interface from where the user can Enter/Select a Language, Build Questions and Answers in that Language by well-defined Classifications, Find the available hierarchy of Subject and Sub-Subject(s), Find related Question(s) classified under the same Subject hierarchy as that of the current Record, or other hierarchy as may be defined by the user, Build Questions and Answers in various Questioning Formats, Attach/Associate File(s)/URL(s)/Remark(s) to Question(s), Find existing Record(s) from the Database(s) by none or one or more FIND conditions, Sort, Filter, and Select Record(s), Modify Record(s), Delete Record(s), build/Modify Record(s) by Voice Input as well as receive Voice Output of Record(s), Translate Record(s), Go To a Record and Navigate between Records, Bookmark Record(s), Mark Record(s) as “Set for Practice” or “Mastered”, “Public” or “Private” as well as “Favourite”, Print Record(s) by various Print conditions including printing of Flash Cards, Snap Cards, and Worksheets, Send Record (Question/Answer) as SMS/MMS and/or Network Messaging and/or via Email, Import Question(s) and Answer(s) from the Question Bank—Rapid Entry Module and Comprehension Bank Module, and view Import Status. The user can also choose not to use any of these functionalities and close the User Interface to come out of the Module. All of these functionalities are described below in detail.

If the user chooses to build Questions and Answers, the user must first enter/select a Language. When the user chooses to build a Question, the Control System brings forth a User Interface which prompts the user to copy the current Question and Answer if any, facing the user, in terms of data input fields comprising of the Header (Classifications), Question, Answer and Remarks, Questioning Formats, and/or Attachment/Association(s), such “Copy Current Entry” utility being of immense use to the user to simplify the building of Questions and Answers having at least common Classifications. If a user selects to“copy the Header (Classifications), then the Classifications under which the current Question facing the user is classified, will be copied.—EXAMPLE—if a user has an existing Question classified as:

AGE GROUP: GENERAL

DIFFICULTY LEVEL: HIGH

SUBJECT: ANIMAL WORLD

SUB SUBJECT1>TERRESTRIAL ANIMAL>SUB SUBJECT2>MAMMAL>SUB SUBJECT3>QUADRUPED>SUB SUBJECT4>HERBIVORE>SUB SUBJECT5>WILD ANIMAL

And the new Question being built by the user also happens to be falling under the above Classifications, the “Copy Current Entry” utility would make the new entry easier for the user, in that, the user would not have to reclassify the new Question entry. If a user selects to copy the Question, Answer and Remarks, and Questioning Formats, the current Question, Answer and Remarks and Questioning Formats, facing the user will be copied. If a user selects to copy the Attachment/Associations to the current Question facing the user, then the Attachment/Associations will be copied accordingly. If a user chooses not to use this “Copy Current Entry” utility, then the Control System gets notified and blanks out all the relevant data input fields for new data input by the user.

The user can then check whether the user is duplicating an entry by choosing to find the available hierarchy of Subject and Sub-Subject(s) by which the Record(s) are stored in the Database(s), as well as Record(s) having the same Classifications as that of the current Record facing the user. The hierarchy of Subject and Sub-Subject(s) is found according to what the user has entered as Subject and/or Sub Subject(s)—EXAMPLE—If the user has not entered any Subject and Sub Subject(s), the Control System brings forth all the available hierarchies of Subject and Sub Subject(s) by which the Questions are classified and stored in the Database(s). If the user enters or selects the Subject as “ANIMAL WORLD”, the Control System brings forth the hierarchies of Subject and Sub Subject(s) pertaining to the Subject “ANIMAL WORLD”. Further if the user has entered or selected “ANIMAL WORLD” in either the Subject or Sub Subject(s), the Control System brings forth hierarchies of Subject and Sub Subject(s) where “ANIMAL WORLD” is there in either the Subject or Sub Subject(s). The user can select any hierarchy from the Find Results and can enter this hierarchy in the Subject and Sub Subject fields in the User Interface.

The Control System brings forth the Find Results accordingly in case the user can further choose to find the Question(s) having the same Classifications as that of the current Question facing the user.

The user can build Questions and Answers by entering the same in relevant data input fields provided for the purpose. It is mandatory for the user to do this, else the Question and Answer will not be saved in the Database(s). The user can further add Remarks about the Question and Answer in a data input field provided for the purpose.

The user can further build Questions and Answers in various Questioning Formats like the ones described below:
Multiple Choice—The user can enter/or modify a Question and further assign 4 options to it out of which one is the correct Answer. The option, which is the correct Answer, is automatically brought forth by the Control System. This can be further modified by the user if required. The other 3 options can also be randomly brought forth by the Control System, based on the Subject under which the Question has been classified. The user can further modify these options if required.
True/False—The user has to enter the Question in the form of a statement and signify it as either a True or a False statement. In case the entered statement is signified as False, the user also has to enter the correct statement. However, if the user has entered the Fill in the Blanks format, then the statement entered by the user is populated in this format as the True statement. This will mean that the user need not enter this format, as the Control System has automatically created this format for the user.
Fill in the Blanks—The user has to enter the Question in the form of a statement and choose to blank any part(s) of the statement. However, if the user has entered the True/False format, then the correct statement is populated in this format as a statement. In this case, the user will simply need to select the words to be blanked out.
Match Maker—The user has to enter the Question and the Answer as corresponding left and right matching columns in the form of clues.

The user can further choose to Attach/Associate File(s), URL(s), Remarks(s) to the Question being built by the user in the same manner as described in FIG. 5.

After the user builds and chooses to save the Question and Answer in the manner described above, the Control System saves the same, generates a new Record Id, and updates the Database(s). The Control System generates a new Record ID each time a new entry is made by a user or when a Record is imported by the user.

If the user chooses to find existing Record(s) in the Database(s), the Control System brings forth a User Interface from where the user enters/selects a FIND criterion, and based on the same, the Control System finds and retrieves the Record(s) from the Database(s). The user can find Record(s) by one or none or more FIND conditions. EXAMPLE—If the user wishes to find Record(s) pertaining to the subject ANIMAL WORLD, the user must enter the subject ANIMAL WORLD in the Subjects field in the User Interface. The user can further find Record(s) pertaining to any of the 5 Sub Subject(s).—EXAMPLE—If the user wishes to find Record(s) classified under the Sub Subject hierarchy SUB SUBJECT1>TERRESTRIAL ANIMAL>SUB SUBJECT2>MAMMAL>SUB SUBJECT3>QUADRUPED>SUB SUBJECT4>HERBIVORE>SUB SUBJECT5>WILD ANIMAL, the user can enter either of the Sub Subjects in the Sub Subjects field. The user can further find Record(s) by entering relevant keyword(s) in the Sub Subjects field. The user can use more than one keyword and can also choose to include or exclude any keyword with respect to its preceding keyword by using the ‘+’ and ‘−’ separators respectively. The Control System searches for the entered keyword(s) in all of the 5 Sub Subjects of the Question(s) created and stored in the Database(s) and brings forth the Find Results accordingly—EXAMPLE—If a user enters ASTRONOMY COMETS then the Control System will bring forth Find Results showing those Record(s) which have either ‘ASTRONOMY’ or ‘COMETS’ or both in the same or in different Sub Subjects irrespective of the Sub Subject hierarchy (it is not necessary that ‘ASTRONOMY’ should come before/after ‘COMETS’ in the Sub Subject hierarchy). Further, if a user enters “ASTRONOMY COMETS” (inside double quotes), then the Control System brings forth Find Results showing those Subject(s) wherein the exact match of ASTRONOMY COMETS is found in any of the Sub Subjects. If a user enters either ASTRONOMY+COMETS or COMETS+ASTRONOMY in the Sub Subjects field, then the Control System will bring forth the Find Results showing those Record(s) which have both ‘ASTRONOMY’ as well as ‘COMETS’ in the same or in different Sub Subjects irrespective of the Sub Subject hierarchy. Further, if a user enters ASTRONOMY−COMETS, then the Control System will bring forth Find Results showing those Record(s) which have ‘ASTRONOMY’ in any of their Sub Subject but not ‘COMETS’. The same applies vice versa in case the user enters COMETS−ASTRONOMY. The user can enter as many no of keywords as the user wants, in the combinations described above. Also, the user can enter part(s) of keyword(s)—EXAMPLE—If the user enters ASTRO instead of ASTRONOMY, then the Control System will bring forth Find Results showing those Record(s) which have ‘ASTRO’ in either of their Sub Subjects. All the combinations described above with respect to keyword(s) entered by the user are also applicable in case the user enters part(s) of keyword(s). Further, if keyword(s) or part(s) of keyword(s) entered by the user is not in any of the Sub Subjects of the Record(s) stored in the Database(s) or if keyword(s) or part(s) of keyword(s) has been wrongly entered by the user in the Sub Subjects field, then the Control System notifies the user that there are no Record(s) in the Database(s) pertaining to the entered keyword(s) or part(s) of keyword(s). Similarly, if the user wishes to find Record(s) pertaining to the Source of Information ‘XYZ’, the user must select the Source of Information ‘XYZ’ in the Source of Information field in the User Interface. The user can also enter relevant keywords in the keywords field, which would bring forth those Record(s), which contain the exact match or part thereof of the keywords entered by the user. The user can use more than one keyword and can also choose to include or exclude the whole or part of any keyword. If the user wishes to find Record(s) classified under the Age Group ‘HIGH SCHOOL’, the user must select the Age Group ‘HIGH SCHOOL’ in the Age Group field in the User Interface. If the user wishes to find Record(s) which have a Difficulty Level ‘HIGH’, the user must select the Difficulty Level ‘HIGH’ in the Difficulty Level field in the User Interface. The user can also find Record(s) by the Questioning Formats with an option to include or exclude particular Questioning Format(s).—EXAMPLE—If a user wants to find all Record(s) in True/False format but not in Match Maker format, the user can select to find accordingly. The user can further find Record(s) stored in the Database(s) by a Date range and Record Id.—EXAMPLE—If the user wants to find Record(s) created between particular dates, the user has to select the appropriate dates in the From Date and To Date fields in the User Interface. If the user wants to find Record(s) by their Record ID, then the user has to enter the Record Id of the desired Record(s) in the From Record Id field and To Record Id fields of the User Interface. The user has the further option to exclude these FIND conditions.—EXAMPLE—If the user enters the Subject as ANIMAL WORLD and chooses to exclude the same, the Control System will avoid showing those Record(s) having the Subject as ANIMAL WORLD in the Find Results. The same (i.e the option to exclude a FIND condition) applies accordingly in case of Sub Subject(s), Source of Information, Age Group, Difficulty Level, keywords, Questioning Formats, Date Range and Record Id The user can further find Record(s) by a Criteria of whether or not the Record(s) have been Bookmarked. In case, the user selects to find Record(s) which have been bookmarked, the user must enter the appropriate Bookmark Remarks associated with the Record(s). The user has the further option of excluding the entered Bookmark Remark.—EXAMPLE—If the user has entered the Bookmark Remarks as “XYZ” and chooses to exclude the same, then the Control System will avoid showing those Record(s) where “XYZ” is there in the Bookmark Remarks, in the Find Results. The user can further find Record(s) by a Criteria of whether or not the Record(s) has been marked as “Public”/“Private” or both, “Set for Practice”/“Mastered” or both. The user can further select between finding Record(s) marked as “Favourite” or Record(s) not marked thus. The user has a further option to exclude these flags—EXAMPLE—If the user chooses to exclude Record(s) marked as “Set for Practice”, the Control System will bring forth Find Results showing Record(s) marked as “Mastered” as well as Record(s) which are not marked either as “Set for Practice” or “Mastered”. The same applies in case of “Public” or “Private” and “Favourite”. The user can further find Record(s) by a Criteria of whether or not the Question(s) have Associations or File Attachments. If the user selects to find Question(s) that have File Attachments, the user must further select the type of the File Attachment as either an Image, Animation, or a Sound file. The user has a further option to exclude the type of the File Attachment.—EXAMPLE—If the user selects the type of the File Attachment as ‘IMAGE’ and chooses to exclude the same, the Control System will bring forth Find Results showing those Record(s) which do not have Image files as Attachments. Further the user can find by entering the relevant Attachment/Association Remarks if any, related to the Attachment/Association of the Record(s). The user has a further option to exclude the entered Attachment/Association Remark(s).—EXAMPLE—If the user has entered the Attachment/Association Remarks as “XYZ” and chooses to exclude the same, then the Control System will bring forth Find Results showing those Record(s) where “XYZ” is not there in the Attachment/Association Remarks. The user can further find by the Import Remarks, if any, given to the Questions that were imported, with a further option to exclude the same in the same manner as described in case of Attachment/Association Remarks. The user can also choose to find by more than one master for a particular Criteria by using the Custom option.—EXAMPLE—the user can choose to find Record(s) for Age Groups ‘JUNIORS’ as well as ‘SENIORS’ at a time. The user can further find Record(s) by Accuracy and Frequency of Occurrence—EXAMPLE—in case of Accuracy, the user finds according to the performance of the user on the Question in a Self Evaluation Test. In case of Frequency of Occurrence, the user finds by whether or not a Question has appeared in a Self Evaluation Test or a Practice Session and if so, the number of times it has appeared, and also the time period in which it has appeared. The user has a further option to find Record(s) by excluding the Accuracy and/or Frequency of Occurrence as may be specified by the user.

If the user chooses none of the FIND Criteria described above, then the Control System brings forth Find Results showing all the Record(s) stored in the Database(s), by all the FIND Criteria. If the user chooses one of the FIND Criteria described above, then the Control System brings forth Find Results showing Record(s) pertaining only to that Criteria. If the user chooses more than one FIND Criteria described above, then the Control System brings forth Find Results showing Record(s) pertaining to the Criteria chosen by the user.

After the user has chosen to find the Records by none or one or more of the FIND conditions described above, the Control System brings forth a User Interface displaying the Record(s) in a Find Result grid according to the FIND conditions. This User Interface provides the user with the same utility(s)/functionality(s) applicable to Record(s) in a Find Result grid as described in FIG. 5. The user can further choose to Sort, Filter, and Select the Records in the Find Result grid in the same manner as described in FIG. 5.

If the user wishes to Modify an existing Record in this Module, all the utility(s)/functionality(s) available at the time of building Questions and Answers would be available to the user and using the same, the user can make further modifications in the Question if required. After modification, if the user chooses to save the Question, the Control System saves the modifications done to the same and updates the Database(s).

If the user wishes to Delete an existing Record in this Module, the Control System prompts the user as to whether or not the user wishes to do so. If the user chooses to continue, the Control System deletes the Question from the Module, sends it to the Recycle Bin of the System, and updates the Database(s). Sufficient security is provided by the System, so as not to allow the deletion of any Record(s) that may be in use in Practice Session(s), Self Evaluation Test(s), Insta Test(s)/Quiz(s), Test(s)/Quiz(s), and/or Scheduled Session(s).

If the user chooses to Add and/or Modify Record(s) by Voice Input, the user can do so with or without a conjunction of input made by keyboard support, and/or use any other utility(s)/functionality(s) of the System, as may be supported by the System for such use, by Voice Command. The user can use all the utility(s)/functionality(s) available at the time of buiding or modifying Questions and Answers, by Voice Input. If the user builds a Question and Answer by Voice Input and chooses to save, the Control System saves the same, generates a new Record Id, and updates the Database(s). The user can further choose to receive Voice Output of the Questions and Answers by activating the Voice Assistant. A character appears which speaks out the text of the Questions and Answers through an embedded text to speech engine. The Control System saves the Voice Output of a particular Question and Answer in an mp3 file format, as may be specified by the user in the Voice Output option described in FIG. 56.

If the user chooses to Translate a Record in this Module, the user can do so by considering the Record as a parent Language Record and translate the same in any language of the user's choice. The translation is carried out in the manner described in the Translation Module in FIGS. 58 and 59. The Control System saves the translation of the parent Language Record and thus updates the Database(s).

The user can further navigate back and forth between the Records of this Module and can also choose to directly go to a Record by entering its Record Id in a data input field provided for the purpose.

If the user chooses to Bookmark a Record in this Module, then the Control System brings forth a User Interface from where the user must enter some Bookmark Remarks in order to Bookmark the Record. The user can also view the earlier Bookmark Remarks, if any, and can further modify the same. The Control System bookmarks the Record accordingly. From the User Interface, the user can also remove the flag of Bookmark from the Record. The Control System updates the Database(s) whenever a Record is Bookmarked or the Bookmark flag is removed from it.

If the user chooses to mark a Record in this Module as “Set for Practice” or “Mastered”, “Public” or Private” and “Favourite”, the Control System flags the Record accordingly. Further when a Record is marked as “Private” by a user who has logged in to the System, the Record will not be visible to other users who log into the System at any other point of time. The user can also choose to remove the flag of “Set for Practice” or “Mastered”, “Public” or “Private” and “Favourite”. The Control System updates the Database(s) whenever a Record is marked as “Set for Practice” or “Mastered”, “Public” or “Private” and “Favourite”, or whenever these flags are removed from the Record.

If the user chooses to print Record(s) in this Module, the user can do so by any of the following conditions. The user can print the current Record facing the user as a Flash Card, Snap Card, Worksheet, or even print entire details of the Record. The user can further print choose to print Record(s) found by a FIND condition as specified by the user, in the same manner as that of the current Record. The Control System brings forth the print previews accordingly from which the user can further print. The Printing utility further allows the Print reports to be Exported to various destinations in various file formats.

The user can choose to send a Record (Question/Answer) of this Module as SMS/MMS and/or Network Messaging and/or via Email.

If the user chooses to import Questions from the Question Bank Rapid Entry Module or Comprehension Bank Module, the user must first select the respective Module from which the user wishes to import Questions. The Control System brings forth a User Interface pertaining to the selected Module, from where the user must find the Questions to be imported by specifying none or one or more FIND conditions. The FIND conditions are the same as the ones described in FIG. 5 or 11, pertaining to whether the selected Module is Question Bank Rapid Entry Module or Comprehension Bank Module. The Control System brings forth a User Interface, showing a grid displaying the Find Results accordingly from where the user can further Sort, Filter, and Select the Record(s) to be imported. The Sort, Filter, and Select functionalities are same as the ones described in FIG. 5 or 11, pertaining to whether the selected Module is Question Bank Rapid Entry Module or Comprehension Bank Module. This User Interface provides the user with the same utility(s)/functionality(s) applicable to Record(s) in a Find Result grid as described in FIG. 5. After the user chooses to import the selected Record(s), the Control System prompts the user to enter some Import Remarks to the same. The Control System then imports the Record(s) into the Module, notifies the user about the same, displays the number of Record(s) imported, generates new Record Id(s) for the same, and updates the Database(s). In case the user imports Records from the Question Bank—Rapid Entry Module, the user is provided with a choice to retain or permanently delete the imported Record(s) from the Question Bank—Rapid Entry Module, once they have been imported. In case the Record(s) are thus deleted, they are permanently removed from the System. The Control System updates the Database(s) in this case.

If the user chooses to view Import Status of a Record in this Module, the Control System will bring forth a User Interface showing whether or not the Record has been imported from the Question Bank—Rapid Entry, or Comprehension Bank Module or a Database File in the manner described in the Import Module in FIGS. 43 and 44. The user can further view and modify the Import Remarks associated with the Record in a data input field provided for the purpose.

The Module also accepts data built by another user (Exporting user) of the System, and which may be further manipulated by the user (Importing user) to suit the user's requirements. (EXAMPLE—the Exporting user may have classified a Question on the animal “YAK” under the subject ANIMAL WORLD, but the Importing user would like to classify the same under the subject WILD LIFE)

The Questions and Answers built in this Module can be used for, inter alia, taking Practice Sessions, Scheduling Sessions, taking Self Evaluation Tests, printing Insta Test(s)/Quiz(s) and for creating Test(s)/Quiz(s).

Any data entered or imported into the Question Bank—Main Module is further used as part of the functions of the other Modules of the System.

Note: The flags like Bookmark, “Set for Practice”, “Mastered”, “Public”, “Private”, and “Favourite” applied to a Record by a user who has logged into the System will not be visible to any other user who logs into the same System at any other point of time.

FIG. 9 describes the System State Transition of the Question Bank—Main Module explaining that the Module is based on the different States. The Control System receives events from the user(s), and each event causes the transition from one State to another within the Module.

Each State contains its own separate Terminal State. A double lined transition arrow from State 4 indicates that multiple instances of the state are possible. So it is possible for multiple instances of state 4 to occur, each of which has its own terminal transition. A transition shown with a dotted line indicates that it is leaving from one State and entering another State.

FIG. 10 describes the System Function of the Comprehension Bank Module.

The architecture of this Module comprises the following major functions, which allow a user to build a passage of text as well as Questions and Answers based on it by well-defined Classifications with the help of the User Interface.

The Module allows a user to:
Enter/Select a Language
Build a passage of text as well as Questions and Answers based on it by well-defined Classifications
Copy Current Entry
Find the available hierarchy of Subject and Sub-Subject(s)
Find related Record(s) having the same Classifications as that of the current Record, as may be defined by the user
Build Questions and Answers (based on the passage) in various Questioning Formats such as:
Multiple Choice
True/False
Fill in the Blanks
Match Maker
Attach/Associate File(s)/URL(s)/Remark(s) to Record(s)
Find existing Records from the Database(s) by none or one or more FIND conditions
Sort, Filter, and Select Record(s)
Modify Record(s)
Add/Modify Record(s) by Voice Input as well as receive Voice Output of Record(s)
Translate Record(s)
Delete Record(s)
Go To a Record and Navigate between Records
Print Record(s) by various Print conditions including printing of Flash Cards, Snap Cards, and Worksheets
Bookmark Record(s)
Mark Records as “Set for Practice” or “Mastered”, “Public” or “Private” as well as “Favourite”
Send Record (Question/Answer) as SMS/MMS and/or Network Messaging and/or via Email
Export Question(s) and Answer(s) to Question Bank—Main Module

FIG. 11 describes the System Operation of the Comprehension Bank Module, explaining that the Module is based on user actions. The Comprehension Bank Module accepts data in one or more languages (such data capable of being accepted from more than one user at the same time), with or without Voice, by well-defined Classifications like (1) the Date (the same being generated by the Control System and which can be modified by the user if needed) (2) Language (the user selects the available language or adds a new one) (3) Source of Information (to record the Source from where the user obtained the details the user is entering—EXAMPLE—The user may have read something in a particular book or magazine—say “XYZ” and would like to store this as Source of Information) (4) Age Group (to record the relevant Age Group for which the Record, that the user is entering, is meant for—EXAMPLE—the Record may be meant for JUNIORS AGE GROUP or SENIORS AGE GROUP etc.) (5) Difficulty Level (to record the level of difficulty of the Record that the user is entering for an Age Group), (6) Subject “(to record the Subject under which the Record, that the user is entering, is to be stored—EXAMPLE—A passage on the animal “YAK” may be stored under the subject ANIMAL WORLD), (7) Sub-Subject(s) (to record the Sub Subject (s) under which the details that the user is entering is to be stored—EXAMPLE—A passage on the animal “YAK” may be based on the subject ANIMAL WORLD and the user may want to further classify the same up to 5 levels {Sub Subjects} e g. SUBJECT>ANIMAL WORLD>SUB SUBJECT1>TERRESTRIAL ANIMAL>SUB SUBJECT2>MAMMAL>SUB SUBJECT3>QUADRUPED>SUB SUBJECT4>HERBIVORE>SUB SUBJECTS>WILD ANIMAL). All of these Classifications apply to both the passage of text as well as the Questions and Answers based on it.

When the user enters this Module, the Control System brings forth a User Interface from where the user can Enter/Select a Language, build a passage of text as well as Questions and Answers based on it in that Language by well-defined Classifications, Find the available hierarchy of Subject and Sub-Subject(s), Find related Record(s) having the same Classifications as that of the current Record, as may be defined by the user, Build Questions and Answers based on the passage in various Questioning Formats, Attach/Associate File(s)/URL(s)/Remark(s) to Question(s), Find existing Record(s) from the Database(s) by none or one or more FIND conditions, Sort, Filter, and Select Record(s), Modify Record(s), Delete Record(s), build/Modify Record(s) by Voice Input as well as receive Voice Output of Record(s), Translate Record(s), Go To a Record and Navigate between Records, Bookmark Record(s), Mark Record(s) as “Set for Practice” or “Mastered”, “Public” or “Private” as well as “Favourite”, Print Record(s) by various Print conditions including printing of Flash Cards, Snap Cards, and Worksheets, Send Record (Question/Answer) as SMS/MMS and/or Network Messaging and/or via Email, Export Question(s) and Answer(s) to the Question Bank—Main Module, and view Import Status. The user can also choose not to use any of these functionalities, and close the User Interface to come out of the Module. All of these functionalities are described below in detail.

When the user chooses to build a passage of text as well as Questions and Answers based on it, the Control System brings forth a User Interface which prompts the user to copy the current Record if any, facing the user, in terms of data input fields comprising of the Header (Classifications), text of the passage, Question, Answer and Remarks, Questioning Formats, and/or Attachment/Association(s), such “Copy Current Entry” utility being of immense use to the user to simplify the building of Questions and Answers having at least common Classifications. If a user selects to copy the Header (Classifications), then the Classifications under which the current Question facing the user is classified, will be copied.—EXAMPLE—if a user has an existing Record classified as:

AGE GROUP: GENERAL

DIFFICULTY LEVEL: HIGH

SUBJECT: ANIMAL WORLD

SUB SUBJECT1>TERRESTRIAL ANIMAL>SUB SUBJECT2>MAMMAL>SUB SUBJECT3>QUADRUPED>SUB SUBJECT4>HERBIVORE>SUB SUBJECT5>WILD ANIMAL

And the new Record being added by the user also happens to be falling under the above Classifications, the “Copy Current Entry” utility would make the new entry easier for the user, in that, the user would not have to reclassify the new entry. If the user selects to copy the text of the passage facing the user, then only the text of the passage will be copied. If a user selects to copy the Question, Answer and Remarks, and Questioning Formats, the Question, Answer, Remarks, and Questioning Formats of the Questions and Answers based on the passage, will be copied. If a user selects to copy the Attachment/Associations to the current Record facing the user, then the Attachment/Associations will be copied accordingly. If a user chooses not to use this “Copy Current Entry” utility, then the Control System gets notified and blanks out all the relevant data input fields for new data input by the user.

The user can check whether the user is duplicating an entry by choosing to find the available hierarchy of Subject and Sub-Subject(s) by which the Questions are stored in the Database(s), as well as Record(s) having the same Classifications as that of the current Question facing the user. The hierarchy of Subject and Sub-Subject(s) is found according to what the user has entered as Subject and/or Sub Subject(s)—EXAMPLE—If the user has not entered any Subject and Sub Subject(s), the Control System brings forth all the available hierarchies of Subject and Sub Subject(s)y by which the Questions are classified and stored in the Database(s). If the user enters or selects the Subject as “ANIMAL WORLD”, the Control System brings forth the hierarchies of Subject and Sub Subject(s) pertaining to the Subject “ANIMAL WORLD”. Further if the user has entered or selected “ANIMAL WORLD” in either the Subject or Sub Subject(s), the Control System brings forth hierarchies of Subject and Sub Subject(s) where “ANIMAL WORLD” is there in either the Subject or Sub Subject(s). The user can select any hierarchy from the Find Results and can enter this hierarchy in the Subject and Sub Subject fields in the User Interface. The Control System brings forth the Find Results accordingly in case the user further chooses to find the Question(s) having the same Classifications as that of the current Question facing the user.

The user can build the passage of text as well as Questions and Answers based on it by entering the same in relevant data input fields provided for the purpose. It is mandatory for the user to first build a passage of text and choose to save it, else the user will not be able to build Questions and Answers based on the same. The user can further add Remarks about the passage of text in a data input field provided for the purpose. When the user chooses to build Questions and Answers based on the passage, the Control brings forth another User Interface wherein the user can build Questions and Answers in the same manner as described in FIG. 8.

The user can further build Questions and Answers based on the passage, in various Questioning Formats, in the same manner as described in FIG. 8. Also all the utilities/functionalities available in the Question Bank—Main Module are also available in this case. Further, when the user is building Questions and Answers based on the passage, the user can view the text of the passage as well as Classifications of the same.

The user can Attach/Associate File(s), URL(s), Remark(s) to the passage of text as well as the Questions and Answers based on it, in the same manner as described in FIG. 8.

After the user builds and chooses to save the the passage of text as well as Questions and Answers in the manner described above, the Control System saves the same, generates a new Record Id for the passage of text, and updates the Database(s). The Control System treats the Questions as subsets of the passage which is considered the main part of the Record in this Module.

If the user chooses to find existing Record(s) in the Database(s), the Control System brings forth a User Interface from where the user enters/selects a FIND criterion, and based on the same, the Control System finds and retrieves the Record(s) from the Database(s). The user can find Record(s) by one or none or more FIND conditions. The user can find by Age Group, Difficulty Level, Source of Information, Subject and Sub Subjects, Date Range, Record Id, find by whether or not the Record(s) are bookmarked and/or marked as “Set for Practice” or “Mastered” or both, “Public” or “Private” or both, and “Favourite”, find by Attachment/Associations, find Questions by Questioning Formats, and Accuracy and Frequency of Occurrence in the same manner as described in FIG. 8. The user can also enter relevant keywords in the keywords field, which would bring forth those Records, which contain the exact match or part thereof of the keywords entered by the user. The user can use more than one keyword and can also choose to include or exclude the whole or part of any keyword. In case where the user wants to find a passage which has a Title ‘ABC’, the user must select the Title ‘ABC’ in the Title field in the User Interface. The user has a further option to exclude these FIND conditions in the same manner as described in FIG. 8. The user can also choose to find by more than one master for a particular Criteria by using the Custom option.—EXAMPLE—the user can choose to find Record(s) by Age Group by selecting ‘JUNIORS’ as well as ‘SENIORS’ at a time.

If the user chooses none of the FIND Criteria described above, then the Control System brings forth Find Results showing all the Record(s) stored in the Database(s), by all the FIND Criteria. If the user chooses one of the FIND Criteria described above, then the Control System brings forth Find Results showing Record(s) pertaining only to that Criteria. If the user chooses more than one FIND Criteria described above, then the Control System brings forth Find Results showing Record(s) pertaining to the Criteria chosen by the user.

After the user has chosen to find the Records by none or one or more of the FIND conditions described above, the Control System brings forth a User Interface displaying the Record(s) in a Find Result grid according to the FIND conditions. The Record(s) in the Find Result grid are displayed in the form of passages and Questions based on them. Double clicking on any Record in the grid will take the user to the Record in the Module. The user can Sort and Filter the Records in the Find Result grid in the same manner as described in FIG. 5. The user can select only one Record i.e a passage at a time as mulitple selections are not allowed in this case. The user can further make global changes to the selected Record as described in FIGS. 13 and 14. Further, if the user wants to print Flash Cards, Snap Cards, Worksheets, or even entire details, the user has to first select a Record i.e a passage in the grid and then select the Question(s) based on the same to be printed as Flash Cards, Snap Cards, or Worksheets. The user can further print entire details of the selected Record i.e the passage, along with the Question(s) based on it. The user can take a Practice Session or a Self Evaluation Test, Create a Test/Quiz, Print an Insta Test/Quiz using the selected Record, Schedule, or Export the selected Record i.e the passage, along with the Question(s), in the same manner as described in FIG. 5.

If the user wishes to Modify an existing Record comprising of a passage of text as well as Questions and Answers based on it, in this Module, all the utility(s)/functionality(s) available at the time of building the passage of text as well as Questions and Answers based on it would be available to the user and using the same, the user can make further modifications if required. After modification, if the user chooses to save the Record, the Control System saves the modifications done to the same and updates the Database(s).

The user can Delete Record(s), build/Modify Record(s) by Voice Input as well as receive Voice Output of Record(s), Translate Record(s), Go to a Record and Navigate between Records, Bookmark Record(s), Mark Record(s) as “Set for Practice” or “Mastered”, “Public” or “Private” as well as “Favourite”, Print Record(s) by various Print conditions including printing of Flash Cards, Snap Cards, and Worksheets, Send Record (Question/Answer) as SMS/MMS and/or Network Messaging and/or via Email, in the same manner as described in FIG. 5.

If the user chooses to export Questions and Answers based on the passages to the Question Bank—Main Module, the user can either select to export the current Question facing the user, or select to export Question(s) based on a passage by finding the same by none or one or more FIND conditions as specified by the user. The FIND conditions in this case are the same as described above. The Control System brings forth a User Interface displaying the Record(s) in a Find Result grid according to the FIND conditions. This User Interface provides the user with the same utility(s)/functionality(s) applicable to Record(s) in a Find Result grid as described in FIG. 5. After the user selects to export Questions in either manner, the Control System brings forth a User Interface wherein the user can view or modify the Classifications of the Question(s) before exporting them. If the user continues, the Control System exports the Question(s) to the Question Bank—Main Module along with their Classification(s), Questioning Formats, Attachment(s), and Association(s), notifies the user about the same and displays the number of Questions exported, generates new Record Id(s) for the Question(s) in the Question Bank—Main Module, and thus updates the Database(s). The user can view or modify these exported Question(s) in the Question Bank—Main Module.

If the user chooses to view Import Status of a Record in this Module, the Control System will bring forth a User Interface showing whether or not the Record has been imported from a Database File in the manner described in the Import Module in FIGS. 43 and 44. The user can further view and modify the Import Remarks associated with the Record in a data input field provided for the purpose.

The Module also accepts data built by another user (Exporting user) of the System, and which may be further manipulated by the Importing user to suit the Importing user's requirements. (EXAMPLE—the Exporting user may have classified a passage on the animal “YAK” under the subject ANIMAL WORLD, but the Importing user may like to classify the same under the subject WILD LIFE)

The passages as well as Questions and Answers based on passages, built in this Module can be used for, inter alia, taking Practice Session(s), Scheduling Session(s), taking Self. Evaluation Test(s), printing Insta Test(s)/Quiz(s), and for creating Test(s)/Quiz(s).

Any data entered or imported into the Comprehension Bank Module is further used as part of the functions of the other Modules of the System.

Note: The flags like Bookmark, “Set for Practice”, “Mastered”, “Public”, “Private”, and “Favourite” applied to a Record by a user who has logged into the System will not be visible to any other user who logs into the same System at any other point of time.

FIG. 12 describes the System State Transition of the Comprehension Bank Module explaining that the Module is based on the different States. The Control System receives events from the user(s), and each event causes the transition from one State to another within the Module.

Each State contains its own separate Terminal State. A double lined transition arrow from State 4 indicates that multiple instances of the state are possible. So it is possible for multiple instances of state 4 to occur, each of which has its own terminal transition. A transition shown with a dotted line indicates that it is leaving from one State and entering another State.

FIG. 13 is the diagram of the System Function of Global Changes Module of the present invention. The architecture of this Module comprises the following major functions, which allow a user to make global changes to the Records stored in the Database(s) like globally Modifying part(s) of Records, globally Deleting Records, globally Bookmarking Records, globally marking Records as “Set for Practice” or “Mastered”, globally marking Records as “Public” or “Private”, globally marking Records as “Favourite”, globally Associating additional information in the form of File(s)/URL(s)/Remark(s) to Records, globally Attaching a File such as an Image, Animation, or a. Sound file to Records, or globally Translating Records with the help of the User Interface.

The Module allows a user to:
Select a Module (e g. Question Bank—Rapid Entry, Question Bank—Main, Comprehension Bank, Create a Test/Quiz) where the user wants to make global changes to the Records
Select a Language
Find existing Records from the Database(s) by none or one or more FIND conditions
Sort, Filter, and Select Record(s)
Globally Modify part(s) of Records, globally Delete Records, globally Bookmark Records, globally mark Records as “Set for Practice” or “Mastered”, globally mark Records as “Public” or “Private”, globally mark Records as “Favourite”, globally Associate additional information in the form of File(s)/URL(s)/Remark(s) to Records, globally Attach a File such as an Image, Animation, or a Sound file to Records, or globally Translate the selected Record(s).

FIG. 14 describes the System Operation of the Global Changes Module, explaining that the Module is based on user actions.

The user first selects the Module where the user wishes to make global changes to the Records like globally Modifying part(s) of Records, globally Deleting Records, globally Bookmarking Records, globally marking Records as “Set for Practice” or “Mastered”, globally marking Records as “Public” or “Private”, globally marking Records as “Favourite”, globally Associating additional information in the form of File(s)/URL(s)/Remark(s) to Records, globally Attaching a File such as an Image, Animation, or a Sound file to Records, or globally Translating Records. The user then selects the Language in which the Records are to be brought forth for making such global changes. The Control System brings forth a User Interface from where the user can find Record(s) for making global changes, from the Database(s) by none or one or more FIND conditions. The FIND conditions in this case are the same as the ones described in FIG. 5, 8, 11, or 38, pertaining to whether the selected Module is either the Question Bank—Rapid Entry Module, Question Bank—Main Module, Comprehension Bank Module, or Create a Test/Quiz Module respectively. The Control System brings forth a User Interface, displaying the Find Results in a grid, and from where the user can Sort, Filter, and Select the Record(s) to be exported. The Sort, Filter, and Select, including ‘Selected So Far’, functionalities in this case are same as the ones described in FIG. 5, 8, 11, or 38 pertaining to whether the selected Module is either the Question Bank—Rapid Entry Module, Question Bank—Main Module, Comprehension Bank Module, or the Create a Test/Quiz Module respectively. The User Interface provides the user with the same utility(s)/functionality(s) applicable to Record(s) in a Find Result grid as described in FIG. 5. Double clicking on any Record in the grid will take the user to the Record in the Module. The user can also view the Classification details of the selected Record(s) or those of the entire set of found Record(s). The user can also print the selected Record(s) as Flash Card(s), Snap Card(s), Worksheet(s), or can even print the entire details of the Record(s). The user can choose to either globally Modify, globally Delete, globally Bookmark, globally mark as “Set for Practice” or “Mastered”, globally mark as “Public” or “Private”, globally mark as “Favourite”, globally Associate additional information in the form of File(s)/URL(s)/Remark(s), globally Attach a File such as an Image, Animation, or a Sound file, or globally Translate the selected Record(s).

If the user chooses to globally Modify selected Record(s), the Control System brings forth a User Interface from where the user can select the desired part or field of the Record(s) that the user wishes to Modify, enter/select to find that which is to be replaced in that selected field, and further enter/select to Replace that which is thus found, in specific data input fields provided for the purpose.—EXAMPLE—If the user selects a master based field like Age Group, for the selected Record(s), the user can select to find the Age Group say ‘JUNIORS’ and can enter or select to Replace it with the Age Group ‘SENIORS’. The Control System searches the Age Group field of the selected Record(s) for ‘JUNIORS’ and replaces it with ‘SENIORS’. Further, if the user selects a text based field like Remarks, then the user must enter some text which the user wishes to find to be replaced in the Remarks field and then enter the text that will replace this found text. —EXAMPLE—If the user enters ‘ABC’ to be found to be replaced and then enters ‘XYZ’ as the text to Replace ‘ABC’, the Control System will search the Remarks field of the selected Record(s) for all occurrences of ‘ABC’ and Replace it with ‘XYZ’. After entering or selecting to find and Replace, the Control System prompts the user as to whether or not the user wants to do the same. If the user continues, the Control System modifies the selected Record(s) accordingly, notifies the user that the selected Record(s) have been modified, and displays the number of Record(s) modified. The Control System updates the Database(s) whenever the Record(s) are modified.

If the user chooses to globally Delete the selected Record(s), the Control System prompts the user as to whether or not the user wishes to Delete the selected Record(s). If the user continues, the Control System deletes the selected Record(s) from the grid, notifies the user that the Record(s) have been deleted, and also displays the number of Record(s) deleted. The Control System sends the deleted Record(s) to the Recycle Bin of the System and updates the Database(s).

If the user chooses to globally Bookmark the selected Record(s), the Control System brings forth a User Interface where the user must enter some Bookmark Remarks in order to Bookmark the selected Record(s). After the user enters the Bookmark Remarks and saves the same, the Control System prompts the user as to whether the user wishes to overwrite or append the existing Bookmark Remarks, if any, of the selected Record(s) in case such Record(s) have been bookmarked earlier. After the user selects either to overwrite or append the existing Bookmark Remarks, the Control System bookmarks the Record(s) accordingly, notifies the user that the Record(s) have been bookmarked, and displays the number of Record(s) bookmarked. The user can view the existing Bookmark Remarks of all Record(s) in the Find Result grid, in case such Record(s) have been bookmarked earlier. The user can further remove the Bookmark flag of the selected Record(s) in case such Record(s) have been bookmarked earlier. The Control System updates the Database(s) whenever the Record(s) are bookmarked or whenever the Bookmark flag is removed from the Record(s) which have been bookmarked earlier.

If the user chooses to mark the selected Record(s) as “Set for Practice” or “Mastered”, the Control System brings forth a User Interface where the user must select either to mark the Record(s) as “Set for Practice” or “Mastered”. After the user selects either one of these two options, the Control System prompts the user as to whether or not the user wishes to thus mark the selected Record(s). If the user continues, then the Control System marks the selected Record(s) as “Set for Practice” or “Mastered” as may be specified by the user, notifies the user that the Record(s) have been thus marked, and displays the number of Record(s) thus marked. The user can also remove the “Set for Practice” and “Mastered” flags of the selected Record(s) in case such Record(s) have been marked earlier as “Set for Practice” or “Mastered”. The Control System updates the Database(s) whenever the Record(s) are marked as “Set for Practice” or “Mastered” or whenever the flags of “Set for Practice” or “Mastered” are removed from Record(s) which have been marked earlier as “Set for Practice” or “Mastered”.

If the user chooses to mark the selected Record(s) as “Public” or “Private”, the Control System brings forth a User Interface where the user must select either to mark the Record(s) as “Public” or “Private”. After the user selects either one of these two options, the Control System prompts the user as to whether or not the user wishes to thus mark the selected Record(s). If the user continues, then the Control System marks the selected Record(s) as “Public” or “Private” as may be specified by the user, notifies the user that the Record(s) have been thus marked, and displays the number of Record(s) thus marked. The user can also remove the “Public” and “Private” flags of the selected Record(s) in case such Record(s) have been marked earlier as “Public” or “Private”. The Control System updates the Database(s) whenever the Record(s) are marked as “Public” or “Private” or whenever the flags of “Public” or “Private” are removed from Record(s) which have been marked earlier as “Public” or “Private”.

If the user chooses to mark the selected Record(s) as “Favourite”, the Control System prompts the user as to whether or not the user wishes to thus mark the selected Record(s). If the user continues, then the Control System marks the selected Record(s) as “Favourite”, notifies the user that the Record(s) have been thus marked, and displays the number of Record(s) thus marked. The user can also remove the “Favourite” flag of the selected Record(s) in case such Record(s) have been marked earlier as “Favourite”. The Control System updates the Database(s) whenever the Record(s) are marked as “Favourite” or whenever the flag of “Favourite” is removed from Record(s) which have been marked earlier as “Favourite”.

If the user chooses to globally Associate File(s)/URL(s)/Remark(s) to the selected Record(s), the Control System prompts the user as to whether or not the user wants to do the same. If the user continues, the Control System brings forth a User Interface from where the user can Associate File(s)/URL(s)/Remark(s), and add Remarks about such associations. In case the user wants to Associate File(s) with the Record(s), the user can browse for and select the File(s), from a computer system. In case the user wants to Associate URL(s) or Remark(s), the user must enter the same into a data input field provided for the purpose. The user can further enter Remarks about each Association in a data input field provided for the purpose. From the User Interface, the user can also open and view the Associated File or URL and further can delete the Association(s) that the user might have given to the selected Record(s) at this time. If the user chooses to save the Association(s), then the Control System Associates the File(s)/URL(s)/Remark(s) to the selected Record(s), notifies the user about the same, and displays the number of Record(s) to which either File(s)/URL(s)/Remark(s) have been associated. The user can also delete all Association(s) of the selected Record(s) in case such Record(s) have been associated with File(s)/URL(s)/Remark(s) earlier. The Control System updates the Database(s) whenever File(s)/URL(s)/Remark(s) are associated and/or Association Remarks are added to the selected Record(s) or whenever any previous Associations are deleted from the selected Record(s).

If the user chooses to globally Attach a File to the selected Record(s), the Control System prompts the user as to whether or not the user wants to do the same, also notifying the user that the Attachment made by the user at this time will replace the earlier Attachment, if any, of the selected Record(s). If the user continues, the Control System brings forth a User Interface from where the user can Attach a File, and add Remarks about this Attachment. In order to Attach a File with the Record(s), the user must browse for and select the File, from a computer system. The user can further enter Remarks about the Attachment in a data input field provided for the purpose. From the User Interface, the user can also open and view the Attached File. If the user chooses to save the Attachment, then the Control System Attaches the File to the selected Record(s), notifies the user about the same, and displays the number of Record(s) to which the File has been attached. The user can also delete the Attachment(s) of the selected Record(s) in case such Record(s) have been attached with a File earlier. The Control System updates the Database(s) whenever a File is attached and/or Attachment Remarks are added, to the selected Record(s) or whenever any previous Attachment is deleted from the selected Record(s).

If the user chooses to globally Translate the selected Record(s), the Control System brings forth a User Interface from where the user must select the part(s) of the selected Record(s) to be translated and then enter/select the Language to do the same. The user must further enter the translation(s) of the selected part(s) in the Language entered or selected, in data input fields provided for the purpose. After entering the translation, the Control System prompts the user as to whether or not the user wants to do the same. If the user continues, the Control System translates the selected Record(s) accordingly, notifies the user that the selected Record(s) have been translated, and displays the number of Record(s) translated. The Control System updates the Database(s) whenever the Record(s) are globally translated.

When the user closes the User Interface from where the user can make global changes and choose the other options as described above, the Control System gets notified and the user comes out from the Module.

Note: In case of the Comprehension Bank Module, the user can make global changes to multiple passages and/or multiple Questions based on one or more passages. The Global Changes Module further allows the user to make global changes to Questions based on a passage, selectively.

FIG. 15 describes the System State Transition of the Global Changes Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 16 to 18 explain the System Function, System Operation and System State Transition respectively of the Practice Session Module, which allows the user to invoke and store a Practice Session (such Practice Sessions capable of being taken by more than one user at the same time), using the data stored in the Database(s).

FIG. 16 is the diagram of the System Function of Practice Session Module of the present invention. The architecture of this Module comprises of the following major functions, which allow a user to invoke a Practice Session using the data stored in the Database(s), with the help of the User Interface.

The Module allows a user to:
Select a Module (e g. Question Bank—Rapid Entry, Question Bank—Main, Comprehension Bank) from which the user wants to take a Practice Session
Select a Language
Enter/Select Criteria like Practice Session Title, No. of Records to appear in the Practice Session, and time of display per Record
Activate Background Music
Take a Practice Session by using the Record(s) found from the Database(s) by none or one or more FIND conditions
Navigate manually (Manual Scroll) or automatically (AutoScroll) between Records during a Practice Session
Activate Voice Assistant during a Practice Session
Send Record (Question/Answer) as SMS/MMS and/or via Email and/or Network Messaging during a Practice Session
Bookmark Record(s) related to a Practice Session
Mark Record(s) related to a Practice Session as “Set for Practice”/“Mastered” as well as “Favourite”
Print Record(s) related to a Practice Session including printing of Flash Cards, Snap Cards, and Worksheets
Repeat a Practice Session
Take a Practice Session with Repeated Criteria
Take a Practice Session on Record(s) which have appeared in a Self Evaluation Test
Take a Practice Session on Question(s) incorrectly answered in a Self Evaluation Test

FIG. 17 describes the System Operation of the Practice Session Module, explaining that the Module is based on user actions.

To invoke a Practice Session, the user first selects the Module for the Records on which the user wishes to take a Practice Session and then the Language in which Records for the Practice Session are to be brought forth. The Control System brings forth a User Interface from where the user can enter/select Criteria like Practice Session Title, No. of Records that the user wishes to appear in the Practice Session, and time of display per Record, specify none or one or more FIND conditions to find the Record(s) from the Database(s) to be used in the Practice Session, select to listen to a Background Music Sound File during the Practice Session, and start a Practice Session. The FIND conditions in this case are same as the ones described in FIG. 5, 8, or 11 pertaining to whether the selected Module is either the Question Bank—Rapid Entry or Question Bank—Main, or the Comprehension Bank respectively.

After the user makes the necessary entries/selections and starts the Practice Session, the Control System brings forth a User Interface which displays the Practice Session, showing Record(s) found from the Database(s) according to the FIND conditions specified by the user, one after the other along with the time of display per Record as may be specified by the user. The Subject under which the Record(s) may have been classified in the respective Module to which the Record(s) belong, is additionally displayed. In case the user enters the No. of record(s) that the user wishes to appear in the Practice Session, that many Record(s) are randomly selected from the Database(s) according to the FIND conditions. Else, the Control System will bring forth all the available Record(s), which satisfy the FIND conditions, to be displayed in the Practice Session. In case of the Question Bank—Rapid Entry and Question Bank—Main Modules, the Record(s) are displayed in the form of Question and Answer, while in the case of the Comprehension Bank Module, the Record(s) are displayed in the form of a passage of text along with the Question and Answer. From the User Interface, the user can view the classification details of the Record(s) displayed one by one. The user can further select whether or not to listen to the Background Music during the Practice Session at any point of time. The user can activate the Voice Assistant in order to receive Voice Output of the Record(s) displayed one by one. A character appears which speaks out the text of the Record(s) through an embedded text to speech engine. The Control System saves the Voice Output of a particular Record in an mp3 file format, as may be specified by the user in the Voice Output option described in FIG. 56. The user can select between either automatically or manually navigating between the Record(s). In case of automatic navigation, a Record is automatically displayed to the user for the time of display per Record as may be specified by the user. The Record(s) are thus displayed one by one to the user until all the Record(s) that are to appear in the Practice Session, as specified by the user, have been displayed. In case of manual navigation, the user can navigate back and forth between the Record(s). There is no time of display per Record in this case. The user can switch between automatic and manual navigation at any point of time during the Practice Session.

The user can further select to view or play an Attached File, if any, of the Record(s) during the Practice Session. In case the Attached File is an Animation or Sound file, the Control System will invoke the relevant application, if installed on the user's computer system, to play the same. While in case if the Attached File is an Image file, the Control System automatically displays the same. The user can also send any Record (Question/Answer) as SMS/MMS and/or via Email and/or Network Messaging during the Practice Session. The user can, at any point of time, either choose to close the User Interface displaying the Practice Session, or choose to end the Practice Session. In all these cases, the Control System saves the Practice Session upto the Record last seen by the user when the user closed the User Interface or ended the Practice Session. EXAMPLE—If a Practice Session is to display 10 Records and the user sees only 1 Record, and chooses to close the User Interface displaying the Practice Session or end the same at that time, then the Control System will consider only that 1 Record as having appeared in the Practice Session and will ignore the remaining 9 Records, and thus save the Practice Session accordingly. When the user chooses to repeat this Practice Session, take a Self Evaluation Test on it, or chose to print it, the user will only get to see 1 Record.

If the user chooses to close the User Interface displaying the Practice Session, the Control System closes the User Interface, saves the Practice Session along with its Criteria, generates a new Practice Session Id, and thus updates the Database(s). The user then comes out of the Module.

If the user chooses to end the Practice Session, the Control System closes the User Interface displaying the Practice Session, saves the Practice Session along with its Criteria, generates a new Practice Session Id, and thus updates the Database(s). The Control System then brings forth a User Interface showing a grid which displays the Record(s) viewed by the user during the Practice Session, and from where the user can choose options like repeating the immediately preceding Practice Session, continuing the immediately preceding Practice Session, taking a Practice Session with same Criteria as that of the immediately preceding Practice Session, taking a Practice Session with new Criteria, or taking a Self Evaluation Test on the immediately preceding Practice Session. The user can further choose to print Record(s) of the immediately preceding Practice Session as Flash Card(s), Snap Card(s), Worksheets, print a Practice Session Report, or entire details of Record(s), as well as Bookmark or mark as “Set for Practice”, or “Mastered” and “Favourite”, the Record(s) of the immediately preceding Practice Session. The user can chose not to select any of these options and further close the User Interface to come out of the Module.

If the user chooses to repeat the immediately preceding Practice Session, the Control System starts the Practice Session by bringing forth a User Interface displaying the same, showing the same Record(s) as in the immediately preceding Practice Session. At the end of this Session, the Control System saves the same along with its Criteria, generates a new Practice Session Id, and updates the Database(s). The Control System will now treat this saved Practice Session as a separate Practice Session.

If the user chooses to continue the immediately preceding Practice Session, the user can do so only in either of the following circumstances. In case if a user has entered beforehand a specific number of Record(s) to appear in the Practice Session, the Control System will randomly select this specific number of Record(s) from the Database(s), that satisfy the FIND conditions specified by the user, and display them in the Practice Session. However, if there are more Record(s) in the Database(s) which satisfy the same FIND conditions but have not appeared in the Practice Session, then the user can continue the Practice Session with such Record(s). In case if a user has chosen to take a Practice Session with a number of Record(s) as specified by the user, and if the user chooses to end the Practice Session before the specified number of Record(s) have been displayed, then the user can continue the Practice Session with the remaining Record(s) as well as the Record(s) in the Database(s) which have not been randomly selected but satisfy the FIND conditions specified by the user. In case if a user does not specify the number of Record(s) that the user wishes to appear in a Practice Session, the Control System will bring forth all Record(s) from the Database(s) satisfying the FIND conditions specified by the user, to be displayed in the Practice Session. After seeing some Record(s), if the user chooses to end the Practice Session, the user can continue the Practice Session with the remaining Record(s). In either of these cases, the Record(s) with which the user continues the Practice Session will be considered as having appeared in that Practice Session. The Control System starts the Practice Session by bringing forth a User Interface displaying the same, showing new Record(s). There is no new Practice Session Id generated in this case. The Control System appends the new Record(s) to the original Practice Session and updates the Database(s).

If the user chooses to take a Practice Session with same Criteria as that of the immediately preceding Practice Session, the Control System brings forth a User Interface from where the user can choose between selecting to take a Practice Session by excluding Record(s) that have already appeared in the the immediately preceding Practice Session taken by the same Criteria, or selecting to take a Practice Session with all the Record(s) by the same Criteria as that of the immediately preceding Practice Session. The Control System starts a Practice Session by bringing forth a User Interface displaying the Practice Session, showing the Record(s) according to the user's selections. The Control System saves this Practice Session along with its Criteria, generates a new Practice Session Id, and thus updates the Database(s).

If the user chooses to take a Practice Session with new Criteria, the Control System brings forth a User Interface from where the user can enter/select Practice Session Criteria and start the Practice Session as described earlier. The Control System starts a Practice Session by bringing forth a User Interface displaying the Practice Session, showing the Record(s) according to the user's selections. The Control System saves this Practice Session along with its Criteria, generates a new Practice Session Id, and thus updates the Database(s).

If the user chooses to take a Self Evaluation Test on the immediately preceding Practice Session, the Control System will bring forth a User Interface from where the user can enter/select relevant Criteria like Self Evaluation Test Title, Test Format, Time to answer per Question, and even select to listen to Background Music during the Self Evaluation Test. After the user makes the necessary entries/selections, the Control System starts a Self Evaluation Test by bringing forth a User Interface displaying the same. The Self Evaluation Test is as described in FIGS. 19 and 20. The Control System saves this Self Evaluation Test along with its Criteria and Results, generates a knew Self. Evaluation Test Id, and updates the Database(s).

If the user wishes to print the Record(s) of the immediately preceding Practice Session as Flash Card(s), Snap Card(s), Worksheet(s), or even entire Details, the user can select all or specific Record(s) to be thus printed. The Control System brings forth the print previews accordingly from where the user can print further.

If the user chooses to Bookmark and/or mark as “Set for Practice” or “Mastered” and “Favourite” the Records(s) of the immediately preceding Practice Session, the user can select all or specific Record(s) to be thus flagged. The Control System flags the Record(s) accordingly and thus updates the Database(s).

In case the user wishes to repeat a Practice Session that has been taken earlier, the user must first select the Module from which the user wishes to repeat a Practice Session and then select the Language. The Control System brings forth a User Interface showing a grid which displays all the Practice Session(s) taken earlier for the selected Module in the selected Language. The user can Sort the Practice Session(s) in the grid, in ascending or descending order, by Criteria like Practice Session Title, number of Record(s) appeared in the Practice Session, and Date on which the Practice Session was taken. The user can also view the Criteria by which the Practice Session(s) were taken. Further, if the user selects any Practice Session in the grid, the Control System displays the details of the Record(s) appeared in that selected Practice Session, in another grid. After the user selects the desired Practice Session, the Control System starts the Practice Session by bringing forth a User Interface displaying the same. After the end of this Practice Session, the Control System saves the same, generates a new Practice Session Id, and updates the Database(s). The utility(s)/functionality(s) provided by the Module after the end of a Practice Session, as described above, are also applicable in this case.

In case if the user wishes to take a Practice Session with the same Criteria as that of a Practice Session taken earlier, then the user must first select the Module for which the user wishes to do the same and then select the Language. The Control System brings forth a User Interface showing a grid which displays all the Practice Session(s) taken earlier for the selected Module in the selected Language. The general functionality(s) related to this User Interface like sorting the Practice Session(s), viewing the details of the same, are the same as those in the User Interface brought forth in case of repeating a Practice Session. After the user selects the desired Practice Session, the Control System brings forth a User Interface from where the user must choose between selecting to take a Practice Session by excluding Record(s) that have already appeared in the selected Practice Session taken by the same Criteria, or selecting to take a Practice Session with all the Record(s) by the same Criteria as that of the selected Practice Session. The Control System starts a Practice Session by bringing forth a User Interface displaying the same, showing the Record(s) according to the user's selections. The Control System saves this Practice Session along with its Criteria, generates a new Practice Session Id, and thus updates the Database(s). The utility(s)/functionality(s) provided by the Module after the end of a Practice Session, as described above, are also applicable in this case.

In case if the user wishes to take a Practice Session on the Record(s) that have appeared in a Self Evaluation Test taken earlier, then the user must first select the Module for which the user wishes to do the same and then select the Language. The Control System brings forth a User Interface showing a grid which displays all the Self Evaluation Test(s) taken earlier for the selected Module in the selected Language. The user can Sort the Self Evaluation Test(s) in the grid, in ascending or descending order, by Criteria like Self Evaluation Test Title, number of Record(s) appeared in the Self Evaluation Test, Test Format, Marks obtained, and Date on which the Self Evaluation Test was taken. The user can also view the Criteria by which the Self Evaluation Test(s) were taken. Further, if the user selects any Self Evaluation Test in the grid, the Control System displays the details of the Record(s) appeared in that selected Self Evaluation Test, in another grid. After the user selects any Self Evaluation Test from the grid, the Control System brings forth a User Interface from where the user must enter/select Criteria like Practice Session Title, and time of display per Record. After this, the Control System starts a Practice Session by bringing forth a User Interface displaying the same, showing the Record(s) that have appeared in the Self Evaluation Test. The Control System saves this Practice Session along with its Criteria, generates a new Practice Session Id, and thus updates the Database(s). The utility(s)/functionality(s) provided by the Module after the end of a Practice Session, as described above, are also applicable in this case.

In case if the user wishes to take a Practice Session on the Question(s) that have been incorrectly answered in a Self Evaluation Test taken earlier, then the user must first select the Module for which the user wishes to do the same and then select the Language. The Control System brings forth a User Interface showing a grid which displays all the Self Evaluation Test(s) taken earlier for the selected Module in the selected Language, in which Question(s) were incorrectly answered. The user can Sort the Self Evaluation Test(s) in the grid, in ascending or descending order, by Criteria like Self Evaluation Test Title, number of Record(s) appeared in the Self Evaluation Test, Test Format, Marks obtained, and Date on which the Self Evaluation Test was taken. The user can also view the Criteria by which the Self Evaluation Test(s) were taken. Further, if the user selects any Self Evaluation Test in the grid, the Control System displays the details of only those Question(s) which were incorrectly answered in that selected Self Evaluation Test, in another grid. After the user selects any Self Evaluation Test from the grid, the Control System brings forth a User Interface from where the user must enter/select Criteria like Practice Session Title, and time of display per Record. After this, the Control System starts a Practice Session by bringing forth a User Interface displaying the same, showing the Record(s) accordingly. The Control System saves this Practice Session along with its Criteria, generates a new Practice Session Id, and thus updates the Database(s). The utility(s)/functionality(s) provided by the Module after the end of a Practice Session, as described above, are also applicable in this case.

Note: The Practice Session(s) taken by a particular user who has logged into the System are not visible to any other user who logs into the same System at a different point of time.

In case the user wishes to invoke a Practice Session on the Records of the Comprehension Bank Module, the user first selects a passage from the Database(s) by finding the same based on none or one or more FIND conditions. The passage is displayed to the user throughout the Session in addition to the Questions and Answers, based on the said passage.

FIG. 18 describes the System State Transition of the Practice Session Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 19 to 30 explain the System Function, System Operation and System State Transition respectively of the Self Evaluation Test Module, the System Function, System Operation and System State Transition of the Print a Test Module, the System Function, System Operation and System State Transition of the Individual Test Report Module, the System Function, System Operation and System State Transition of the Overall Evaluation Report Module, respectively of the present invention. The Self Evaluation Test Module allows the user to take a Self Evaluation Test in one or more Test Formats (such Tests capable of being taken by more than one user at the same time), using the data stored in the Database(s).

The Print a Test Module allows the user to print a Test. The Individual Test Report Module allows the user to Print an evaluation Report for a Self Evaluation Test, and the Overall Evaluation Report Module allows the user to obtain an Overall Evaluation Report of all the Self Evaluation Test(s) taken by the user, by various Classifications.

FIG. 19 is the diagram of the System Function of Self Evaluation Test Module of the present invention. The architecture of this Module comprises the following major functions, which allow a user to take a Self Evaluation Test in one or more Test Formats, using the data stored in the Database(s).

The Module allows a user to:
Select a Module (e g. Question Bank—Rapid Entry, Question Bank—Main, Comprehension Bank) from which the user wants to Take a Self Evaluation Test
Select a Language
Enter/Select Criteria like Self Evaluation Test Title, No. of Questions to be used for the Self Evaluation Test, Time to answer per Question, and Test Format
Activate Background Music
Take a Self Evaluation Test using the Question(s) found from the Database(s) by none or one or more FIND conditions
Activate Voice Assistant during a Self Evaluation Test
Send Record (Question/Answer) as SMS/MMS and/or via Email and/or Network Messaging during a Self Evaluation Test
View a Replay of a Self Evaluation Test as well as user's actions performed during a Self Evaluation Test and obtain a Report of the same
Bookmark Record(s) related to a Self Evaluation Test
Mark Record(s) related to a Self Evaluation Test as “Set for Practice”/“Mastered” as well as “Favourite”
Print a Self Evaluation Test with and/or without the Answers
Print Flash Cards, Snap Cards, and Worksheets from the Questions related to a Self Evaluation Test
Print an Individual Test Report
Repeat a Self Evaluation Test
Take a Self Evaluation Test with Incorrect Answers
Take a Self Evaluation Test with Repeated Criteria
Take a Self Evaluation Test on Question(s) appeared in a Practice Session(s)

FIG. 20 describes the System Operation of the Self Evaluation Test Module, explaining that the Module is based on user actions.

To take a Self Evaluation Test the user first selects the Module from which the user wishes to do the same and then selects the Language in which the Questions for the Self Evaluation Test are to be brought forth. The Control System brings forth a User Interface from where the user can enter/select Criteria like the Self Evaluation Test Title, No. of Questions that the user wishes to face for the Self Evaluation Test, Time to answer per Question. The user can further select any one of the following Test formats like:
Multiple Choice—This format displays a Question and provides 4 options (that were assigned in the Question Bank—Main Module/Comprehension Bank Module), as the possible Answers. The user must select one of the 4 options as the correct Answer.
True or False—This format displays the Question in the form of a statement (as entered in the Question Bank—Main Module/Comprehension Bank Module) and the user is required to select whether the statement is True or False.
Fill in the Blanks—This format displays the Question in the form of a statement (as entered in the Question Bank—Main Module/Comprehension Bank Module) with blanked characters. The user reads this statement and provides the Answer by entering the blanked characters in the correct sequence.
Scrambler—This format displays a statement with blanked characters and the Answer in a scrambled form. The user provides the correct Answer by entering the blanked characters or by selecting the letters of the scrambled word in the correct sequence.
Match Maker—This format comprises of left (Question) and right (Answer) columns, (as entered in the Question Bank—Main Module/Comprehension Bank Module) which allow the user to match the appropriate columns, by clicking on any Question in the left column and looking for the corresponding Answer in the right column or vice versa. Additional matches are provided in the right (Answer) column, to further challenge the user.

The user can further select to listen to a Background Music Sound File during the Self Evaluation Test. The user can specify none or one or more FIND conditions to find the Question(s) from the Database(s), that are to appear in the Self Evaluation Test. The FIND conditions in this case are same as the ones described in FIG. 5, 8, or 11 pertaining to the whether the selected Module is either the Question Bank—Rapid Entry or Question Bank—Main or the Comprehension Bank respectively. The user can further avoid those Question(s) that the user may have faced in an earlier Practice Session or a Self Evaluation Test for a certain number of times or in a certain number of days, as well as those Question(s) on which the user's performance in Self Evaluation Tests is over a certain percentage as may be determined by the user, by specifying the FIND conditions accordingly.

After the user makes the necessary entries/selections, the Control System starts the Self Evaluation Test by bringing forth a User Interface showing Question(s) found from the Database(s) according to the FIND conditions specified by the user, one after the other along with the time to answer per Question as may be specified by the user. The Subject under which the Question(s) may have been classified in the respective Module to which the Question(s) belong, is additionally displayed. The user can also view the total marks obtained by the user during the Self Evaluation Test. The Control System allots marks to each Question beforehand. In case the user enters the No. of Question(s) that the user wishes to take in the Self Evaluation Test, that many Question(s) are randomly selected from the Database(s) according to the FIND conditions Else, the Control System will bring forth all the available Question(s), which satisfy the FIND conditions, to be displayed in the Self Evaluation Test. The user can further select whether or not to listen to the Background Music during the Self Evaluation Test at any point of time. The user can activate the Voice Assistant in order to receive Voice Output of the Question(s) displayed one by one. A character appears which speaks out the text of the Question(s) through an embedded text to speech engine. The Control System saves the Voice Output of a particular Question in an mp3 file format, as may be specified by the user in the Voice Output option described in FIG. 56. The user can also send any Record (Question/Answer) as SMS/MMS and/or via Email and/or Network Messaging during the Self Evaluation Test. The user can also use the Hint option, wherein the user is allowed to take a hint on a particular Question. If the user uses this Hint option for a Question, then the Control System automatically deducts marks alloted to that Question by a certain percentage as may be determined by the user.

The user must answer the Question within the time to answer per Question as may be specified by the user. In case, the user fails to do so, the Control System notifies the user that the time to answer the Question is over and hence displays the correct Answer to the Question. The Control System then prompts the user to attempt the next Question in the Self Evaluation Test. If the user gives a correct Answer to a Question, the Control System notifies the user that the Answer is correct and awards the marks for that Question, which are then added to the total Marks. The Control System then automatically takes the user to the next Question. Further, if the user gives an incorrect Answer to a Question, the Control System notifies the user that the user has given an incorrect Answer and displays the correct Answer to the Question. In this case, the Control System prompts the user to attempt the next Question in the Self Evaluation Test. In case, the user does not attempt a Question and goes on to attempt the next Question, then the Control System displays the correct Answer to the Question which is not attempted and then prompts the user to attempt the next Question in the Self Evaluation Test. The user can, at any point of time, either choose to close the User Interface displaying the Self Evaluation Test, or choose to end the Self Evaluation Test and view the correct Answer of the Question last seen by the user, or choose to end the Self Evaluation Test. In all these cases, the Control System saves the Self Evaluation Test upto the Question last faced by the user when the user closed the User Interface or ended the Self Evaluation Test. EXAMPLE—If a Self Evaluation Test is to display 10 Questions and the user sees only 1 Question and chooses to close the User Interface displaying the Self Evaluation Test or end the same at that time, then the Control System will consider only that 1 Question as having appeared in the Self Evaluation Test and will ignore the remaining 9 Questions, and thus save the Self Evaluation Test accordingly. When the user chooses to repeat this Self Evaluation Test, take a Practice Session on it, or chose to print it, the user will only get to see 1 Question.

If the user chooses to close the User Interface displaying the Self Evaluation Test, the Control System closes the User Interface, saves the Self Evaluation Test along with its Criteria and Result of the user's performance in the same, generates a new Self Evaluation Test Id, and thus updates the Database(s). The user then comes out of the Module.

If the user chooses to end the Self Evaluation Test and view the correct Answer of the Question last seen by the user, the Control System ends the Self Evaluation Test and displays the correct Answer accordingly. The Control System saves the Self Evaluation Test along with its Criteria and Result of the user's performance in the same, generates a new Self Evaluation Test Id, and thus updates the Database(s). In this case the User Interface displaying the Self Evaluation remains as it is, and if the user closes it, the user comes out of the Module.

If the user chooses to end the Self Evaluation Test, the Control System closes the User Interface displaying the Self Evaluation Test, saves the Self Evaluation Test along with its Criteria and Result of the user's performance in the same, generates a new Self Evaluation Test Id, and thus updates the Database(s). The Control System then brings forth a User Interface showing a grid which displays the Question(s) faced by the user during the Self Evaluation Test along with their correct Answers as well as the Answers given by the user in the Self Evaluation Test. The grid further shows whether the user has taken the Hint option for the Question(s), the Marks scored by the user per Question as well as the Status of the Questions as either “Correct”, “Incorrect”, or “Not Attempted”—EXAMPLE—If a Question has been correctly answered, its Status will be “Correct”, if a Question has been incorrectly answered, its Status will be “Incorrect”, or if a Question has not been attempted, its Status will be “Not Attempted”. From this User Interface, the user can choose options like Replaying the Question(s) appeared in the immediately preceding Self Evaluation Test, Replaying the immediately preceding Self Evaluation Test, repeating the immediately preceding Self Evaluation Test, continuing the immediately preceding Self Evaluation Test, taking a Self Evaluation Test with same Criteria as that of the immediately preceding Self Evaluation Test, taking a Self Evaluation Test with new Criteria, taking the immediately preceding Self Evaluation Test with incorrect Answers, or taking a Practice Session on the immediately preceding Self Evaluation Test. The user can further choose to print Record(s) of the immediately preceding Self Evaluation Test as Flash Card(s), Snap Card(s), Worksheets, print the Self Evaluation Test with Answers and/or without Answers, print an Individual Test Report, Print a Performance Report, or entire details of Record(s), as well as Bookmark or mark as “Set for Practice”, or “Mastered” and “Favourite”, the Record(s) of the immediately preceding Self Evaluation Test. The user can chose not to select any of these options and further close the User Interface to come out of the Module.

If the user chooses to replay the Question(s) appeared in the immediately preceding Self Evaluation Test, or replay the immediately preceding Self Evaluation Test itself, the Control System brings forth the User Interface displaying the immediately preceding Self Evaluation Test. The User Interface shows a replay of the Self Evaluation Test showing the Question(s) that the user faced in the Self Evaluation Test along with the Answers that the user gave to each Question as well as the correct Answer, without any user intervention. If the user closes this User Interface, the user comes out of the Module.

If the user chooses to repeat the immediately preceding Self Evaluation Test, the Control System starts the Self Evaluation Test by bringing forth a User Interface displaying the same, showing the same Question(s) as in the immediately preceding Self Evaluation Test. At the end of this Self Evaluation Test, the Control System saves the same along with its Criteria and Result of the user's performance in the same, generates a new Self Evaluation Test Id, and updates the Database(s). The Control System will now treat the saved Self Evaluation Test as a separate Self Evaluation Test.

If the user chooses to continue the immediately preceding Self Evaluation Test, the user can do so in the same manner as described in case of a Practice Session in FIGS. 16 and 17. The Control System starts the Self Evaluation Test by bringing forth a User Interface displaying the same, showing new Question(s). There is no new Self Evaluation Test Id generated in this case. The Control System appends the new Question(s) to the original Self Evaluation Test, saves the result of the user's performance in the new Question(s) in the original Self Evaluation Test, and updates the Database(s).

If the user chooses to take a Self Evaluation Test with the same Criteria as that of the immediately preceding Self Evaluation Test, the Control System brings forth a User Interface from where the user can choose between selecting to take a Self Evaluation Test by excluding Question(s) that the user faced in the immediately preceding Self Evaluation Test taken by the same Criteria, or selecting to take a Self Evaluation Test with all the Question(s) found by the same Criteria as that of the immediately preceding Self Evaluation Test. The Control System starts a Self Evaluation Test by bringing forth a User Interface displaying the same, showing the Question(s) according to the user's selections. The Control System saves this Self Evaluation Test along with its Criteria and Result of the user's performance in the same, generates a new Self Evaluation Test Id, and thus updates the Database(s).

If the user chooses to take a Self Evaluation Test with new Criteria, the Control System brings forth a User Interface from where the user can enter/select Self Evaluation Test Criteria and start the Self Evaluation Test as described earlier. The Control System starts a Self Evaluation Test by bringing forth a User Interface displaying the same, showing the Question(s) according to the user's selections. The Control System saves this Self Evaluation Test along with its Criteria and Result of the user's performance in the same, generates a new Self Evaluation Test Id, and thus updates the Database(s).

If the user chooses to take the immediately preceding Self Evaluation Test with incorrect Answers, the user can do so in case the user has incorrectly answered any Question(s) in the immediately preceding Self Evaluation Test. The Control System will bring forth a User Interface displaying the immediately preceding Self Evaluation Test, showing only those Question(s) which the user had incorrectly answered. At the end of the Self Evaluation Test, the Control System saves the Result of the user's performance over these Question(s) in the immediately preceding Self Evaluation Test and updates the Database(s). There is no new Self Evaluation Test Id generated in this case.

If the user chooses to take a Practice Session on the immediately preceding Self Evaluation Test, the Control System brings forth a User Interface from where the user can enter/select Practice Session Criteria and choose to start the Practice Session. The Control System starts a Practice Session by bringing forth a User Interface displaying the same. The Practice Session is as described in FIGS. 16 and 17. The Control System saves the Practice Session along with its Criteria, generates a new Practice Session Id, and updates the Database(s).

If the user wishes to print the Record(s) of the immediately preceding Self Evaluation Test as Flash Card(s), Snap Card(s), Worksheet(s), or even entire Details, the user can select all or specific Record(s) to be thus printed. The user can further choose to print the Self Evaluation Test with Answers and/or without Answers, print an Individual Test Report, Print a Performance Report. The Control System brings forth the print previews accordingly from where the user can print further.

If the user chooses to Bookmark and/or mark as “Set for Practice” or “Mastered” and “Favourite” the Records(s) of the immediately preceding Self Evaluation Test, the user can select all or specific Record(s) to be thus flagged. The Control System flags the Record(s) accordingly and thus updates the Database(s).

In case the user wishes to repeat a Self Evaluation Test that was taken earlier, the user must first select the Module from which the user wishes to do the same, and then select the Language. The Control System brings forth a User Interface showing a grid which displays all the Self Evaluation Test(s) taken earlier for the selected Module in the selected Language. The user can Sort the Self Evaluation Test(s) in the grid, in ascending or descending order, by Criteria like Self Evaluation Test Title, number of Question(s) faced by the user in the Self Evaluation Test, and Date on which the Self Evaluation Test was taken. The user can also view the Criteria by which the Self Evaluation Test(s) were taken. Further, if the user selects any Self Evaluation Test in the grid, the Control System displays the details of the Question(s) appeared in that selected Self Evaluation Test, in another grid. After the user selects the desired Self Evaluation Test, the Control System starts the Self Evaluation Test by bringing forth a User Interface displaying the same. After the end of this Self Evaluation Test, the Control System saves the same, generates a new Self Evaluation Test Id, and updates the Database(s). The utility(s)/functionality(s) provided by the Module after the end of a Self Evaluation Test, as described above, are also applicable in this case.

In case if the user wishes to take a Self Evaluation Test with the same Criteria as that of a Self Evaluation Test taken earlier, then the user must first select the Module for which the user wishes to do the same and then select the Language. The Control System brings forth a User Interface showing a grid which displays all the Self Evaluation Tests(s) taken earlier for the selected Module in the selected Language. The general functionality(s) related to this User Interface like sorting the Self Evaluation Test(s), viewing the details of the same, are the same as those in the User Interface brought forth in case of repeating a Self Evaluation Test. After the user selects the desired Self Evaluation Test, the Control System brings forth a User Interface from where the user must choose between selecting to take a Self Evaluation Test by excluding Question(s) that have already appeared in the selected Self Evaluation Test taken by the same Criteria, or selecting to take a Self Evaluation Test with all the Question(s) by the same Criteria as that of the selected Self Evaluation Test. The Control System starts a Self Evaluation Test by bringing forth a User Interface displaying the same, showing the Question(s) according to the user's selections. The Control System saves this Self Evaluation Test along with its Criteria and Result of the user's performance in the same, generates a new Self Evaluation Test Id, and thus updates the Database(s). The utility(s)/functionality(s) provided by the Module after the end of a Self Evaluation Test, as described above, are also applicable in this case.

In case the user wishes to take a Self Evaluation Test taken earlier with incorrect Answers, then the user must first select the Module for which the user wishes to do the same and then select the Language. The Control System brings forth a User Interface showing a grid which displays those Self Evaluation Tests(s) taken earlier for the selected Module in the selected Language, in which the user has incorrectly answered any Question(s). The general functionality(s) related to this User Interface like sorting the Self Evaluation Test(s), viewing the details of the same, are the same as those in the User Interface brought forth in case of repeating a Self Evaluation Test. After the user selects the desired Self Evaluation Test, the Control System brings forth a User Interface displaying the same, showing only those Question(s) of the selected Self Evaluation Test which the user had incorrectly answered. At the end of the Self Evaluation Test, the Control System saves the Result of the user's performance over these Question(s) in the selected Self Evaluation Test and updates the Database(s). There is no new Self Evaluation Test Id generated in this case. The utility(s)/functionality(s) provided by the Module after the end of a Self Evaluation Test, as described above, are also applicable in this case.

In case the user wishes to take a Self Evaluation Test on Question(s) that have appeared in a Practice Session taken earlier, the user must first select the Module for which the user wishes to do the same and then select the Language. The Control System brings forth a User Interface showing a grid which displays all Practice Session(s) taken earlier for the selected Module in the selected Language. The general functionality(s) related to this User Interface like sorting the Practice Session(s), viewing the details of the same, are similar to those in the User Interface brought forth in case of repeating a Self Evaluation Test. After the user selects the desired Practice Session, the Control System brings forth a User Interface from where the user must enter/select Self EvaluationTest Title, Test Format, and time to answer per Question, and start a Self Evaluation Test on the selected Practice Session. The Control System starts a Self Evaluation Test by bringing forth a User Interface displaying the same, showing the Question(s) appeared in the selected Practice Session. The Control System saves this Self Evaluation Test along with its Criteria and Result of the user's performance in the same, generates a new Self Evaluation Test Id, and thus updates the Database(s). The utility(s)/functionality(s) provided by the Module after the end of a Self Evaluation Test, as described above, are also applicable in this case.

Note: The Self Evaluation Test(s) taken by a particular user who has logged into the System are not visible to any other user who logs into the same System at a different point of time.

In case the user wishes to invoke a Self Evaluation Test on the Questions of the Comprehension Bank Module, the user first selects a passage from the Database(s) by finding the same based on none or one or more FIND conditions. The passage is displayed to the user throughout the Self Evaluation Test in addition to the Questions, based on the said passage.

FIG. 21 describes the System State Transition of the Self Evaluation Test Module explaining that the Module is based on the different States. The Control System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIG. 22 is the diagram of the System Function of Print a Test Module of the present invention. The architecture of this Module comprises the following major functions, which allow a user to print a Test with the help of the User Interface.

The Module allows a user to:
Select the Module
Select the Language
Select a Self Evaluation Test from previously taken Self Evaluation Test(s) pertaining to the selected Module, in the selected Language
Print the selected Self Evaluation Test with and/or without Answers

FIG. 23 describes the System Operation of the Print a Test Module, explaining that the Module is based on user actions.

The user first selects the Module from which the user wishes to print a Test and then selects the Language. The Control System brings forth a User Interface showing a grid which displays all the Self Evaluation Test(s) taken earlier by a user, pertaining to the selected Module in the selected Language. The User Interface also enables the user to Sort the Self Evaluation Test(s) displayed in the grid, in ascending or descending order, by Criteria like Test Format, Test Title, Date, Total Marks, and No. of Questions. The user then selects the desired Self Evaluation Test and chooses to print it. The Control System brings forth a print preview of the Self Evaluation Test in the Test Format as may be specified by the user at the time of taking the Self Evaluation Test. The user can then print the Self Evaluation Test. If the user closes the print preview, the Control System further prompts the user as to whether the user wishes to print the Self Evaluation Test with Answers or not. If the user chooses to print the Self Evaluation Test with Answers, then the Control System brings forth as described above, a print preview of the Self Evaluation Test with the correct Answers. The user can then print the Self Evaluation Test with Answers. If the user closes the print preview, the Control System gets notified and the User Interface showing the grid is brought forth from where the user can make further selections.

FIG. 24 describes the System State Transition of the Print a Test Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIG. 25 is the diagram of the System Function of Individual Test Report Module of the present invention. The architecture of this Module comprises the following major functions, which allow a user to print an Individual Test Report of a Self Evaluation Test with the help of the User Interface.

The Module allows a user to:
Select the Module
Select the Language
Select a Self Evaluation Test from previously taken Self Evaluation Test(s) pertaining to the selected Module, in the selected Language
Print either an Individual Test Report and/or Graph based on the selected Self Evaluation Test

FIG. 26 describes the System Operation of the Individual Test Report Module, explaining that the Module is based on user actions.

The user first selects the Module from which the user wishes to print an Individual Test Report and then selects the Language. The Control System brings forth a User Interface showing a grid which displays all the Self Evaluation Test(s) taken earlier by a user, pertaining to the selected Module in the selected Language. The User Interface also enables the user to Sort the Self Evaluation Test(s) displayed in the grid, in ascending or descending order, by Criteria like Test Format, Test Title, Date, Total Marks, and No. of Questions. The user then selects the desired Self Evaluation Test and chooses to print an Individual Test Report based on it. The Control System brings forth a print preview of the Individual Test Report which displays the Criteria selected by the user as well as information regarding the Self Evaluation Test selected by the user, grouped according to headers such as No. of Questions Attempted, No. of Questions correctly Answered, and Percentage Score of the user for a Subject. The Report also displays the Total of No. of Questions Attempted, No. of Questions correctly Answered, and the Percentage Score. The user can then print the Individual Test Report from this print preview. On closing this print preview, the Control System gets notified and the User Interface showing the grid is brought forth from where the user can make further selections.

FIG. 27 describes the System State Transition of the Individual Test Report Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIG. 28 is the diagram of the System Function of Overall Evaluation Report Module of the present invention. The architecture of this Module comprises the following major functions, which allow a user to obtain an Overall Evaluation Report on all Self Evaluation Test(s) taken by the user by various Classifications with the help of the User Interface.

The Module allows a user to:
Select the Module
Select the Language
Select Criteria
Print an Overall Evaluation Report/Graph

FIG. 29 describes the System Operation of Overall Evaluation Report Module, explaining that the Module is based on user actions. Overall Evaluation Reports are generated by the System based on Criteria like User Name, Date, Age Group, Subject, Difficulty Level, Test Title, and Source of Information.

The user first selects the Module from which the user wishes to obtain an Overall Evaluation Report and then selects the Language. The Control System brings forth a User Interface from where the user can select various Criteria such as Date Range. If the user wishes to obtain an Overall Evaluation Report of all the Self Evaluation Test(s) taken by a user on a particular Date or in a Date Range, then the user can select the appropriate dates in the From Date and To Date fields of the User Interface. The Module further allows the user to obtain an Overall Evaluation Report of all the Self Evaluation Test(s) taken by a user, grouped in ascending or descending order by Criteria like Subject, Age Group, Difficulty Level, Source of Information, and Test Title.—EXAMPLE—If the user wishes to obtain an Overall Evaluation Report of all the Self Evaluation Test(s) taken by a user grouped according to Subject, then the user must select “Subject” in the Group By field of the User Interface. The same applies to other Criteria like Age Group, Difficulty Level, Source of Information, and Test Title. The user can select the Criteria as described above and choose to print the Overall Evaluation Report. The Control System then brings forth a print preview of the Overall Evaluation Report which displays the Criteria selected by the user as well as information regarding each Self Evaluation Test taken by a user, grouped according to headers such as No. of Questions Attempted, No. of Questions correctly Answered, and Percentage Score, depending on the Group By Criteria selected by the user. The Report also displays the Total of No. of Questions Attempted, No. of Questions correctly Answered, and the Percentage Score. The Overall Evaluation Report is based on the user's performance in all the Self Evaluation Test(s) that the user might have taken so far. The user can print the Overall Evaluation Report from this print preview. On closing this print preview, the Control System gets notified and the user comes out from the Module.

FIG. 30 describes the System State Transition of the Overall Evaluation Report Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 31 to 33 explain the System Function, System Operation and System State Transition respectively of the Reports Module which allows a user to obtain Reports and/or Graphs.

FIG. 31 is the diagram of the System Function of Reports Module of the present invention. The architecture of this Module comprises the following major functions, which allow a user to obtain Reports and/or Graphs with the help of the User Interface.

The Module allows a user to:
Select a Module
Select Language
Select a Report type
Select Criteria
Print Report/Graph with or without the details of the selected Criteria by using Record(s) found from the Database(s) by none or one or more FIND conditions, pertaining to the selected Report, in the selected Language

FIG. 32 describes the System Operation of Reports Module, explaining that the Module is based on user actions.

The user selects the Module from which the user wishes to print a Report and then selects the Language. The Control System brings forth a User Interface which displays a list of all the available Reports along with a brief description about each Report. The Reports Module allows the user to obtain the following Reports like:
List of Questions
List of Questions Count by Classification
Evaluation Report (Individual and Overall) by Classifications like Language, Source of Information, Age Group, Subjects, Difficulty Level etc.
Record usage report (details of how often, for a given period, a Record has been brought forth to a user in a Practice Session/Self Evaluation Test/Test/Quiz along with details of the user's performance for that Record)
Flash Cards, Snap Cards, Worksheets, and Question details
User Details

The user then selects a Report type to be printed. The Control System, depending on the type of Report selected, either brings forth a print preview of the Report from where the user can directly print the Report or brings forth a User Interface wherein the user must enter/select some Criteria beforehand and then the Control System brings forth the print preview of the Report by using Record(s) found from the Database(s) by the Criteria specified by the user. The user comes out of the Module by closing either the print preview or the User Interface mentioned.

FIG. 33 describes the System State Transition of the Reports Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 34 to 36 explain the System Function, System Operation and System State Transition respectively of the Insta Test/Quiz Module which allows the user to create and print an Insta Test/Quiz using the Questions stored in the Database(s).

FIG. 34 is the diagram of the System Function of the Insta Test/Quiz Module of the present invention. The architecture of this Module comprises the following major functions, which allow a user to create and print an Insta Test/Quiz using the Questions stored in the Database(s) with the help of the User Interface.

The Module allows a user to:
Select the Module from which the user wants to create and print an Insta Test/Quiz
Select the Language
Enter/Select Criteria like Group Name, Insta Test/Quiz Title, Insta Test/Quiz Date, Insta Test/Quiz format, and the No. of Questions to be used in the Insta Test/Quiz
Select between Random or Selective printing of Insta Test/Quiz (in case of Selective print, the user can Sort, Filter, and Select the Questions)
Print an Insta Test/Quiz with Answers and/or without Answers using Questions found from the Database(s) by none or one or more FIND conditions
Print details of the selected Criteria as well as Description (header and footer details)
Print an Insta Test/Quiz that was created and printed earlier
Print an Insta Test/Quiz with Repeated Criteria

FIG. 35 describes the System Operation of the Insta Test/Quiz Module, explaining that the Module is based on user actions.

The user first selects the Module from which the user wants to create and print an Insta Test/Quiz. The Control System brings forth a User Interface from where the user can select the Language in which the Questions for the Insta Test/Quiz are to be brought forth, enter/select Criteria like Group Name, Insta Test/Quiz Title, Insta Test/Quiz Date, Insta Test/Quiz format, and the No. of Questions to be used in the Insta Test/Quiz.—EXAMPLE—If a user wishes to print an Insta Test/Quiz for the Group “ABC”, then the user must enter “ABC” in the Group Name field of the User Interface. If a user wishes to give a Title “XYZ” to the Insta Test/Quiz, then the user must enter “XYZ” in the Title field of the Use Interface. The user can further specify the FIND conditions to find the Question(s) from the Database(s), as well as select one or more Print Criteria such as Printing the Insta Test/Quiz along with selected Criteria, Printing the Insta Test/Quiz along with Description, Print as Test, Print as Quiz, Printing the Insta Test/Quiz with Answers and/or without Answers. The user can also change the Description (header and footer details) of the Insta Test/Quiz. The FIND conditions in this case are same as the ones described in FIG. 5, 8, or 11 pertaining to whether the selected Module is either the Question Bank—Rapid Entry or Question Bank—Main or the Comprehension Bank respectively. The Module further enables the user to avoid any of the Questions in the Insta Test/Quiz that have been duplicated during any user specified earlier period for the Group which will face the Insta Test/Quiz or any Questions on which the user's performance, by specifying the appropriate FIND conditions. The user can further select between printing the Insta Test/Quiz using Questions randomly selected from the Database(s) depending upon the FIND condition(s), or Questions selected from the Find results wherein the user can Sort, Filter, and Select the Questions. In case where the user selects to directly print the Insta Test/Quiz using Questions randomly selected from the Database(s) depending upon the FIND condition(s), then the Control System directly brings forth a print preview of the Insta Test/Quiz displaying the randomly selected Questions, with Answers and/or without Answers as may be specified by the user, in the Insta test/quiz format as may be specified by the user. The user can then print the Insta Test/Quiz from this print preview. On closing the print preview, the Control System takes the user back to the User Interface. In case where the user selects to print the Insta Test/Quiz using Questions selected from the Find results wherein the user can Sort, Filter and Select the Questions, the Control System brings forth a User Interface displaying the Questions found from the Database(s) in a Find Result grid according to the FIND conditions specified by the user. This User Interface provides the user with the same utility(s)/functionality(s) applicable to Record(s) in a Find Result grid as described in FIG. 5. The user can further Sort, Filter, and Select the Question(s) to be used for the Insta Test/Quiz. The Sort, Filter, and Select, including ‘Selected So Far’, functionalities in this case are same as the one described in FIG. 5, 8, or 11 pertaining to whether the selected Module is either the Question Bank—Rapid Entry Module, Question Bank—Main Module, or the Comprehension Bank Module respectively. The user can then choose to print the Insta Test/Quiz using the selected Questions. The Control System brings forth a print preview of the Insta Test/Quiz displaying the Questions selected by the user from the Find Results, with Answers and/or without Answers as may be specified by the user, in the Insta test/quiz format, as may be specified by the user. The user can then print the Insta Test/Quiz from this print preview. On closing the print preview, the Control System takes the user back to the User Interface from where the user can make further selections. In this case, the Control System saves the Insta Test/Quiz, generates a new Insta Test/Quiz Id, and thus updates the Database(s). This functionality provided by the Module allows the user to print any Insta Test/Quiz that was created and printed earlier.

For printing an Insta Test/Quiz that was printed earlier, the user first selects a Module like Question Bank—Rapid Entry Module, Question Bank—Main Module, or the Comprehension Bank Module, and then selects a Language for printing the desired Insta Test/Quiz created and printed earlier for that particular Module in the selected Language. The Control System brings forth a User Interface showing a grid which displays all the Insta Tests/Quizzes of the selected Module in the selected Language that were printed earlier along with the Question(s) used in each Insta Test/Quiz. The user can further Sort and Filter the Insta Tests/Quizzes displayed in the grid, in ascending or descending order, by Criteria like Group Name, Insta Test/Quiz Title, Insta Test/Quiz Date, Insta test/quiz format, and No. of Questions. The user can select to print the desired Insta Test/Quiz from the grid. The Control System brings forth a print preview of the Insta Test/Quiz The user can then print the Insta Test/Quiz from this print preview. On closing the print preview, the Control System takes the user back to the User Interface showing the grid displaying the Insta Test(s)/Quiz(s) from where the user can further Sort and Filter, and select to print.

If the user wishes to print an Insta Test/Quiz with the same Criteria as that of an Insta Test/Quiz that was created and printed earlier, the user must first select a Module and then select the Language. The Control System brings forth a User Interface showing a grid which displays all the Insta Test(s)/Quiz(s) of the selected Module in the selected Language, that were printed earlier along with the Question(s) used in each Insta Test/Quiz. The user can further Sort and Filter the Insta Test(s)/Quiz(s) displayed in the grid, in ascending or descending order, by Criteria like Group Name, Insta Test/Quiz Title, Insta Test/Quiz Date, Insta test/quiz format, and No. of Questions. The user can also view the Criteria by which the Insta Test(s)/Quiz(s) displayed in the grid were created and printed. The user can then select the desired Insta Test/Quiz from the grid. Further the user can view the Criteria by which the selected Insta Test/Quiz was printed. After the selection, if the user chooses to continue, then the Control System brings forth a User Interface from where the user must choose between selecting to print an Insta Test/Quiz by excluding Question(s) that have already appeared in the selected Insta Test/Quiz printed by the same Criteria, or selecting to print an Insta Test/Quiz with all the Question(s) in the Database(s) satisfying the same Criteria as that of the selected Insta Test/Quiz. After this selection, the Control System brings forth a print preview of the Insta Test/Quiz, displaying the Question(s) according to the user's selection. The user can then print the Insta Test/Quiz from this print preview. In this case, the Control System saves the Insta Test/Quiz, generates a new Insta Test/Quiz Id, and thus updates the Database(s). On closing the print preview, the Control System takes the user back to the User Interface showing the grid displaying the Insta Test(s)/Quiz(s) which the user can further Sort and Filter, and select to print.

On closing any of the User Interfaces described above, the Control System gets notified and the user comes out from the Module.

FIG. 36 describes the System State Transition of the Insta Test/Quiz Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 37 to 39 explain the System Function, System Operation and System State Transition respectively of the Create a Test/Quiz Module which allows the user to create Test(s) or Quiz(s), using the data stored in the Database(s).

FIG. 37 is the diagram of the System Function of the Create a Test/Quiz Module of the present invention. The architecture of this Module comprises the following major functions, which allow a user to create a Tests or Quizzes with the help of the User Interface.

The Module allows a user to:
Select the Module from which the user wants to create a Test/Quiz
Select the Language
Select whether to create the Test/Quiz manually or automatically
Create Test(s)/Quiz(s)
Copy Current Entry
Enter/Select Test/Quiz Criteria like Group Name, Test/Quiz Title, Test/Quiz Date, Test/Quiz Venue, and Category and Sub Categories of the Test/Quiz (such Category and sub Categories are useful to, inter alia, define the details of the Test/Quiz including, but not limited to the details of the audience facing the Test/Quiz)
Find the available hierarchy(s) of Category and Sub-Category(s) by which the Test(s)/Quiz(s) are stored in the Database(s)
Find Questions to be used in a Test/Quiz from the Database(s), with or without backtracking, by none or one or more FIND conditions
Sort, Filter, and Select Question(s)
Assign marks per Question
Attach/Associate File(s)/URL(s)/Remark(s) to Test(s)/Quiz(s)
Find Test(s)/Quiz(s) created earlier, from the Database(s) by none or one or more FIND conditions
Sort and Select Test(s)/Quiz(s)
Modify Test(s)/Quiz(s)
Delete Test(s)/Quiz(s)
Go to a Record and Navigate between Records
Print Record(s) by various Print conditions including printing of Flash Cards, Snap Cards, and Worksheets
Bookmark Record(s)
Mark Record(s) as “Set for Practice” or “Mastered”, “Public” or “Private” as well as “Favourite”
Export the Questions used in a Test/Quiz as well as a Test/Quiz itself as a Database file

FIG. 38 describes the System Operation of the Create a“Test/Quiz Module, explaining that the Module is based on user actions.

The Create a Test/Quiz Module accepts data in one or more languages (such data capable of being accepted from more than one user at the same time) by well-defined Test/Quiz Criteria like (1) Test/Quiz Date (the same being generated by the Control System and which can be modified by the user if needed), (2) Language (the user selects the available language or adds a new one), (3) Name (to record either the name of the target audience which will face the Test/Quiz or the title of the Test/Quiz), (4) Test/Quiz Venue (to record the venue of the Test/Quiz), (5) Category (to record the Category under which the Test/Quiz that the user is creating, is to be stored—EXAMPLE—A Test/Quiz containing questions on the subject of geography may be stored under the Category GEOGRAPHY), (6) Sub Category(s) (to record the Sub Category(s) under which the Test/Quiz that the user is creating is to be stored—EXAMPLE—A Geography Test/Quiz specifically on the Mountain Ranges of the world meant for a Grade 8, Division “A”, First Semester, Unit Test, may be stored under the Category GEOGRAPHY and the user may want to further classify the same up to 5 levels {Sub Categories}—EXAMPLE—CATEGORY>GEOGRAPHY>SUB CATEGORY1>MOUNTAIN RANGES OF THE WORLD>SUB CATEGORY2>GRADE 8>SUB CATEGORY3>DIVISION “A”>SUB CATEGORY4>FIRST SEMESTER>SUB CATEGORY5>UNIT TEST).

The user first selects the Module from which the user wants to create a Test/Quiz and then selects the Language in which to do the same, and further selects whether to create the Test/Quiz manually or automatically. If the user selects to create the Test/Quiz manually, the Control System brings forth a User Interface from where the user can Create a Test/Quiz, Find Test(s)/Quiz(s) created earlier from the Database(s) by none or one or more FIND conditions, Modify Test(s)/Quiz(s), Delete Test(s)/Quiz(s), Navigate between Records, Print Record(s) by various Print conditions including printing of Flash Cards, Snap Cards, and Worksheets, Bookmark Test(s)/Quiz(s), Mark Test(s)/Quiz(s) as “Set for Practice” or “Mastered”, “Public” or “Private”, as well as “Favourite”, Export the Questions used in a Test/Quiz as well as a Test/Quiz itself as a Database file. The user can also choose not to use any of these functionalities and close the User Interface to come out of the Module. All of these functionalities are described below in detail.

The Create a Test/Quiz functionality allows the user to create a Test/Quiz by well-defined Criteria. If the user chooses to create a new Test/Quiz, the Control System brings forth a User Interface which prompts the user to copy the current Test/Quiz, facing the user, in terms of data input fields comprising of the Header (Test/Quiz Criteria), Question Details, and/or Attachment/Association(s), such “Copy Current Entry” utility being of immense use to the user to simplify the creation of Test(s)/Quiz(s) having at least common Criteria. If a user selects to copy the Header (Test/Quiz Criteria), then the Criteria by which the current Test/Quiz facing the user was created, will be copied.—EXAMPLE—if a user has created a Test/Quiz by the following Criteria:

TEST/QUIZ NAME: UNIT TEST

TEST/QUIZ VENUE: HALL OF FAME

CATEGORY: GEOGRAPHY

SUB CATEGORY1>MOUNTAIN RANGES OF THE WORLD>SUB CATEGORY2>GRADE8>SUB CATEGORY3>DIVISION “A”>SUB CATEGORY4>FIRST SEMESTER>SUB CATEGORY5>UNIT TEST

And the new Test/Quiz being created by the user also happens to be falling under the above Criteria, the “Copy Current Entry” utility would make the creation of the new Test/Quiz easier for the user, in that, the user would not have to reassign the same Criteria to the new Test/Quiz. If a user selects to copy the Question Details, the Questions used in the current Test/Quiz facing the user will be copied. If a user selects to copy the Attachment/Associations to a Test/Quiz, then the Attachment/Associations of the current Test/Quiz facing the user will be copied. If a user chooses not to use this “Copy Current Entry” utility, then the Control System gets notified and blanks out all the relevant data input fields for new data input by the user. When the user is creating a Test/Quiz, the user has to enter/select the Test/Quiz Criteria which are described above. The user can also find the available hierarchy(s) of Category and Sub-Category(s) by which the Test(s)/Quiz(s) created earlier are stored in the Database(s). The user can do so in the same manner as described in case of Subject and Sub Subject(s) in FIG. 8. The user can select any hierarchy from the Find Results and can enter this hierarchy in the Category and Sub Category fields in the User Interface.

The user can also Attach/Associate File(s), URL(s), Remark(s) to the Test/Quiz being created by the user in the same manner as described in FIG. 5. The user can open and view the Attached/Associated File(s) when the user is creating a Test/Quiz and even while Navigating between Test(s)/Quiz(s) stored in the Database(s).

Further, it is mandatory for a user to add Question(s) to a Test/Quiz. The Control System takes the user to a User Interface from where the user can add Question(s) to a Test/Quiz, assign marks per Question, remove Question(s) from a Test/Quiz, as well as choose to save the Test/Quiz. For the purpose of adding Question(s) to the Test/Quiz, the user has to first find the same from the Database(s). The user can find Questions with or without a backtracking utility provided by the Module. The backtracking utility allows the user to avoid Questions which have been used in Test(s)/Quiz(s) created earlier with the same Test/Quiz Criteria as of the current Test/Quiz being created by the user, in order to avoid duplication. If the user selects to find Question(s) with the backtracking utility, the Control System brings forth a User Interface from where the user can select the appropriate Test/Quiz Criteria for backtracking.—EXAMPLE—If the user wishes to avoid Questions that have been used in Test(s)/Quiz(s) created over a certain period of time, the user can do so by selecting the appropriate dates in the ‘From Date’ and ‘To Date’ fields in the User Interface. After this selection, if the user finds the Question(s) to be added to the Test/Quiz, then the Control System will check for Question(s) that have been used in Test(s)/Quiz(s) created between the dates specified in the ‘From Date’ and ‘To Date’ fields by the user, and will avoid displaying such Question(s) in the Find Results. If the user is creating a Test/Quiz for a target audience ‘XYZ’ and wishes to avoid Questions that have been used in Test(s)/Quiz(s) created earlier for the same target audience, then the user must select to include the Test/Quiz Criteria of Name for backtracking. After this selection, if the user finds the Question(s) to be added to the Test/Quiz, then the Control System will check for Question(s) that have been used in Test(s)/Quiz(s) created earlier for the target audience ‘XYZ’, and avoid displaying such Question(s) in the Find Results. The same applies in case where the user selects to include other Test/Quiz Criteria like Test/Quiz Venue, Category and 5 Sub Categories. The user can select to include all or specific Test/Quiz Criteria and/or select the appropriate dates in the ‘From Date’ and ‘To Date’ fields for backtracking. The user is also allowed to undo such selections. After the user has selected whether to find the Questions with or without the backtracking utility, the Control System brings forth a User Interface from where the user can find Questions to be added to the Test/Quiz, from the Database(s) by none or one or more FIND conditions. The FIND conditions in this case are same as the ones described in FIG. 5, 8, or 11 pertaining to the whether the selected Module is either the Question Bank—Rapid Entry Module or Question Bank—Main Module or the Comprehension Bank Module respectively. After the user has chosen to find the Records according to the FIND conditions the Control System brings forth a User Interface displaying the Record(s) in a Find Result grid according to the FIND conditions. This User Interface provides the user with the same utility(s)/functionality(s) applicable to Record(s) in a Find Result grid as described in FIG. 5. The user can further Sort, Filter, and select from the Find results, the Question(s) to be added to the Test/Quiz. The Sort, Filter, and Select functionalities in this case is same as the ones described in FIG. 5, 8, or 11 pertaining to whether the Module selected by the user is either the Question Bank—Rapid Entry Module or Question Bank—Main Module or the Comprehension Bank Module respectively.

The Control System displays the selected Question(s) in a grid, and further allows the user to Sort the selected Questions, in ascending or descending order, by Classifications like Date, Source of Information, Age Group, Difficulty Level, Subject, and Questioning Format. The user can assign marks to all or specific Question(s) selected by the user in the grid. The user is further allowed to remove all or specific Question(s) selected by the user in the grid. The Control System further displays the count of the Question(s) displayed in the grid. After the user creates a Test/Quiz and chooses to save it, the Control System saves the same and updates the Database(s). The Control System generates a new Record ID each time a new Test/Quiz is thus created and saved by a user or when a Test/Quiz is imported by the user.

If the user chooses to find existing Test(s)/Quiz(s) stored in the Database(s), then the Control System brings forth a User Interface from where the user can enter/select FIND Criteria. The user can find Record(s) by none or one or more FIND conditions.—EXAMPLE—If the user wants to find Test(s)/Quiz(s) created under the name ‘ABC’, then the user must select the name ‘ABC’ in the Name field in the User Interface. If the user wants to find Test(s)/Quiz(s) having the venue ‘XYZ’, then the user must select the venue ‘XYZ’ in the Test/Quiz Venue field in the User Interface. If the user wants to find Test(s)/Quiz(s) created under the category SCIENCE, the user must enter the category as SCIENCE in the Category field in the User Interface. The user can further find Test(s)/Quiz(s) created under any of the 5 Sub Category(s) in the same manner as described in FIG. 8. The user has a further option of excluding these FIND conditions—EXAMPLE—If the user enters the category as ‘SCIENCE’ and chooses to exclude the same, the Control System will avoid showing Test(s)/Quiz(s) which were created under the category SCIENCE in the Find Results. The same (i.e the option to exclude a FIND condition) applies in case of Sub Category(s), Name, and Test/Quiz Venue. The FIND conditions like Date Range, Record Id, finding by whether or not the Test(s)/Quiz(s) is bookmarked and/or marked as “Set for Practice” or “Mastered” or both, “Public” or “Private” or both, and “Favourite”, finding by Attachment/Associations, are the same as the ones described in FIG. 8. The user can also choose to find by more than one master for a particular Criteria by using the Custom option.—EXAMPLE—the user can choose to find Test(s)/Quiz(s) created under the Categories ‘SCIENCE’ as well as ‘GEOGRAPHY’ at a time.

If the user chooses none of the FIND Criteria described above, then the Control System brings forth Find Results showing all the Test(s)/Quiz(s) stored in the Database(s), by all the FIND Criteria. If the user chooses one of the FIND Criteria described above, then the Control System brings forth Find Results showing Test(s)/Quiz(s) pertaining only to that Criteria. If the user chooses more than one FIND Criteria described above, then the Control System brings forth Find Results showing Test(s)/Quiz(s) pertaining to the Criteria chosen by the user.

After the user has chosen to find the Records by none or one or more of the FIND conditions described above, the Control System brings forth a User Interface displaying the Test(s)/Quiz(s) in a Find Result grid according to the FIND conditions. This User Interface provides the user with the same utility(s)/functionality(s) applicable to Record(s) in a Find Result grid as described in FIG. 5. The user can choose to Sort, Filter and Select the Record(s) in the same manner as described in FIG. 5.

If the user wishes to Modify an existing Test/Quiz in this Module, all the utility(s)/functionality(s) available at the time of creating a Test/Quiz would be available to the user and using the same, the user can make further modifications in the Test/Quiz if required. After modification, if the user chooses to save the Test/Quiz, the Control System saves the modifications done to the same and updates the Database(s).

The user can further Delete Test(s)/Quiz(s), Go to a Test/Quiz and Navigate between Test(s)/Quiz(s), Bookmark Test(s)/Quiz(s), Mark Test(s)/Quiz(s) as “Set for Practice” or “Mastered”, “Public” or “Private” as well as “Favourite”, Print Test(s)/Quiz(s) by various Print conditions including printing of Flash Cards, Snap Cards, and Worksheets, Send Record (Question/Answer) as SMS/MMS and/or Network Messaging and/or via Email, in the same manner as described in FIG. 5.

If the user chooses to export the Questions used in a Test/Quiz, the Control System at first prompts the user as to whether the user wants to Bookmark the Questions to be exported. If the user chooses to Bookmark the Questions, the Control System brings forth a User Interface from where the user must enter relevant Bookmark Remarks. The Control System further offers the, user with a choice as to whether the user wishes to overwrite or append to the existing, Bookmark Remarks of the Questions in case some Questions have been bookmarked earlier (either in the Question Bank—Rapid Entry Module, Question Bank—Main Module, or the Comprehension Bank Module). After the user enters and saves Bookmark Remarks, the Control System bookmarks the Questions accordingly. The same Bookmark Remark applies to all the Questions used in a Test/Quiz, which are to be exported. However, the original Bookmark Remarks applied to the Questions in the respective Module will remain as it is.—EXAMPLE—If a Question has been bookmarked earlier in any of the respective Modules and has some Bookmark Remarks associated with it, then at the time of exporting the user can further modify the same and further add more Bookmark Remarks. But this modification will not be reflected in the Bookmark Remarks applied to the Question in its respective Module. Only the importing user will be able to see the modified Bookmark Remarks. The Control System then brings forth a User Interface from where the user must browse for and select the appropriate file/folder destination on a computer system where the user wants to export. After this selection, the user can export the Questions in a Database file created at the selected file/folder destination by the Control System. If the user chooses not to Bookmark the Questions before exporting them, then the Control System directly allows the user to export the Questions in the manner described above. If the user selects to export a Test/Quiz, the Control System then brings forth a User Interface from where the user must browse for and select the appropriate file/folder destination on a computer system where the user wants to export. After the user's selection, the Control System creates a Database File at the file/folder destination. The entire Test/Quiz is exported as the Database File along with the Questions and Test/Quiz Criteria.

If the user chooses to view Import Status of a Record in this Module, the Control System will bring forth a User Interface showing whether or not the Record has been imported from a Database File in the manner described in the Import Module in FIGS. 43 and 44. The user can further view and modify the Import Remarks associated with the Record in a data input field provided for the purpose.

In case where the user selects to create a Test/Quiz automatically, the Control System brings forth a User Interface where the user is asked to provide minimum information like the Language, Test/Quiz Date, Name, Venue, Category, Sub-Category(s), Number of Questions per specified FIND condition, marks per Question, and whether or not the user wishes to apply the backtracking check while finding Question(s) for the Test/Quiz. After this, the Control System randomly selects the Questions for the Test/Quiz from the Database(s) according to the FIND conditions specified by the user. All other utility(s)/functionality(s) available to a user in case of a Test/Quiz created manually are also available in case of a Test/Quiz created automatically.

FIG. 39 describes the System State Transition of the Create a Test/Quiz Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 40 to 42 explain the System Function, System Operation and System State Transition respectively of the Export Module which provides the user with the utility of Exporting Records (by means of a Database file created by the System) stored in the Database(s), by finding the same from the Database(s) based on none or one or more FIND conditions,

FIG. 40 is the diagram of the System Function of Export Module of the present invention. The architecture of this Module comprises of the following major functions, which allow a user to Export Record(s) stored in the Database(s), with the help of the User Interface.

The Module allows a user to:
Select the Module for the Records of which the user wants to Export
Select the Language
Find existing Record(s) from the Database(s) by none or one or more FIND conditions
Sort, Filter, and Select Record(s)
Validate Data
Export selected Record(s) as Database File and/or as SMS/MMS (in case of Question/Answer) and/or via Email and/or Network Messaging.

FIG. 41 describes the System Operation of Export Module, explaining that the Module is based on user actions.

The user first selects the Module for the Records of which the user wants to Export and then the Language in which the Record(s) to be exported are to be brought forth. The Control System then brings forth a User Interface from where the user is allowed to choose whether or not to send flags like Bookmark, ‘Set for Practice’, ‘Mastered’, ‘Public’, ‘Private’, and/or ‘Favourite’, if any, along with the Record(s) to be exported.—EXAMPLE—If the exporting user is exporting Record(s) which have been Bookmarked, the user has an option of selecting whether or not to send the Bookmarks and associated Bookmark Remarks along with such Record(s) to be exported. If the exporting user selects to send the Bookmarks and associated Bookmark Remarks, then the importing user is allowed to see that the Records(s) have been bookmarked and can further view and modify the Bookmark Remarks associated with the bookmarked Record(s). Else, the importing user cannot see that the Records(s) have been bookmarked. The same applies in case the user wishes to send other flags like ‘Set for Practice’, ‘Mastered’, ‘Public’, ‘Private’, and/or ‘Favourite’. The exporting user can choose to send either particular flag(s), all flags, or none of the flags with the Record(s) to be exported. The user can also undo selections of the same. The flags that are chosen to be sent along with the Record(s) to be exported are those set by the user who has logged in to the System. After the user has chosen whether or not to send the desired flags, the Control System brings forth a User Interface from where the user can find Record(s) to be exported, from the Database(s) by none or one or more FIND conditions. The FIND conditions in this case are same as the ones described in FIG. 5, 8, 11 or 38 pertaining to whether the selected Module is either the Question Bank—Rapid Entry, Question Bank—Main, Comprehension Bank, or Create a Test/Quiz respectively. The Control System brings forth a User Interface, displaying the Find Results in a grid, and from where the user can Sort, Filter, and Select the Record(s) to be exported. The Sort, Filter, and Select, including ‘Selected So Far’, functionalities in this case are same as the ones described in FIG. 5, 8, 11, or 38 pertaining to whether the selected Module is either the Question Bank—Rapid Entry Module, Question Bank—Main Module, Comprehension Bank Module, or the Create a Test/Quiz Module respectively. The User Interface provides the user with the same utility(s)/functionality(s) applicable to Record(s) in a Find Result grid as described in FIG. 5. The user can also view the Classification details of the selected Record(s) or those of the entire set of found Record(s). If the user chooses to Export the selected Record(s), the Control System performs a Data Validation. If Record(s) meet the Criteria of the Data Validation, the Control System allows these Record(s) to be exported. Else, the Control System notifies the user that the Record(s) cannot be exported. After Data Validation, the Control System brings forth a User Interface from where the user must browse for and select the appropriate file/folder destination on a computer system where the user wants to Export. After this selection, the user can Export the selected Record(s) as a Database File and/or as SMS/MMS (in case of Question/Answer) and/or via Email and/or Network Messaging. The Control System creates a Database file using the selected Record(s) at the file/folder destination on a computer system as specified by the user and notifies the user that the selected Record(s) were successfully exported and also displays the number of Record(s) exported. The Control System adds the User Details of the exporting user to the Record(s) in the Database file. These User Details can be viewed and further modified by the importing user through the User Interface showing the import Remarks, which is described in FIG. 44. After this, the Control System takes the user back to the User Interface from where the user can further Sort, Filter, Select and Export Record(s). If the user closes this User Interface, the Control System gets notified and the user comes out from the Module.

Note: In case of the Comprehension Bank Module, the user has the option to Export the passages and/or Questions based on the same.

FIG. 42 describes the System State Transition of the Export Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 43 to 45 explain the System Function, System Operation and System State Transition, respectively, of the Import Module which provides the user with the utility of Importing Records from a Database file that may have been created by other user(s) of this System, with the utility of appending to the data already stored by the user in the Database(s).

FIG. 43 is the diagram of the System Function of Import Module of the present invention. The architecture of this Module comprises the following major functions, which allow a user to Import Record(s) from a Database file that may have been built by other user(s) of this System, with the help of the User Interface.

The Module allows a user to:
Browse for and Select a File
Validate the File
Get Record(s)
Sort, Filter, and Select Record(s)
Import Record(s)

FIG. 44 describes the System Operation of Import Module, explaining that the Module is based on user actions.

When the user enters this Module, the Control System brings forth a User Interface from where the user must browse for and select the appropriate file on a computer system from which the user wants to Import Record(s). After this selection, the Control System verifies whether the file selected by the user is a valid Database file or not. If the file selected by the user is not a valid Database file, then the Control System notifies the user that the file is invalid and hence can't be imported. Else, the Control System brings forth a User Interface displaying all the Record(s) in the Database file in a grid, and from where the user can further Sort, Filter, and Select the Record(s) to be imported. The Sort and Filter functionalities are same as the ones described in FIG. 5, 8, 11, or 38 pertaining to whether the Record(s) to be imported from the selected Database file are from the Question Bank—Rapid Entry, Question Bank—Main , Comprehension Bank, or Create a Test/Quiz Module respectively. The user can select to import, the Record(s) which the user has highlighted, the entire set of Record(s) displayed in the grid facing the user, or the entire set of Record(s) in the Database file. The user can also undo these selections. The user can further view the selected Record(s) through a ‘Selected So Far’ utility, wherein the Control System brings forth a User Interface from where the user can view the selected Record(s) as well as Sort, Filter, and make further selections or undo selections of the same. If the user chooses to import the selected Record(s), the Control System prompts the, user as to whether the user wishes to add import Remarks to the Record(s) selected to be imported.—EXAMPLE—If the user is importing the Records from another user of the System, say Mr. ‘ABC’, the importing user may like to add the name of the exporting user (Mr. ABC), in the Import Remarks field for future reference of the Records received from the exporting user (Mr. ABC). The Control System brings forth a User Interface which displays the User Details of the exporting user which the importing user can further modify and can further enter more Import Remarks of the user's choice. These Import Remarks can be seen and further modified through the respective Module like Question Bank—Rapid Entry Module, Question Bank—Main Module, Comprehension Bank Module, or Create a Test/Quiz Module, into which the Record(s) are imported. The user can also choose to import the selected Record(s) without adding any Import Remarks. After the user has chosen to import the selected Record(s), the Control System appends the Record(s) to the Database(s) according to the Module to which the Record(s) belong—EXAMPLE—If the user imports Record(s) from a Database file created using Record(s) from the Question Bank—Rapid Entry Module, then the imported Record(s) append to the Database(s) of the System of the importing user in such a manner that they can be viewed and further modified only through the Question Bank—Rapid Entry Module. After importing, the Control System updates the Database(s) and notifies the user that the selected Record(s) were successfully imported and also displays the number of Record(s) imported. After this, the Control System takes the user back to the User Interface from where the user can further Sort, Filter, Select, and Import Record(s). If the user closes this User Interface, the Control System gets notified and the user comes out from the Module.

FIG. 45 describes the System State Transition of the Import Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 46 to 48 explain the System Function, System Operation and System State Transition respectively, of the Scheduler Module which allows the user to Schedule data to be displayed on the user's computer system at preset time intervals.

FIG. 46 is the diagram of the System Function of the. Scheduler Module of the present invention. The architecture of this Module comprises the following functions, which allow a user to find the Records from the Database(s) by none or one or more FIND conditions and Schedule them as desired with the help of a User Interface.

The Scheduler Module, through a User Interface, causes the Control System to find and retrieve the relevant data from the Database(s). The Module allows a user to:
Select the Module (Question Bank—Rapid Entry, Question Bank—Main, Comprehension Bank, Practice Session, Self Evaluation Test) for the Records of which the user wants to Schedule at preset time intervals
Select the Language
Find existing Records from the Database(s) by none or one or more FIND conditions
Sort, Filter, and Select the Record(s)
Schedule time of Scheduled Session as well as time of display per Record
Schedule Record(s) as well as Schedule a Practice Session or a Self Evaluation Test
Select to activate Background Music
Select to activate Voice Assistant
Send Record(s) (Question/Answer) as SMS/MMS and/or via Email and/or Network Messaging during the Scheduled Session

FIG. 47 describes the System Operation of the Scheduler Module explaining that the Module is based on user actions.

The user first selects the Module (Question Bank—Rapid Entry, Question Bank—Main, Comprehension Bank, Practice Session, Self Evaluation Test) for the Records of which the user wants to Schedule at preset time intervals and then selects the Language in which the Record(s) are to be brought forth. The Control System brings forth a User Interface from where the user must find the Record(s) from the Database(s) by specifying none or one or more FIND conditions. The FIND conditions in this case are same as the ones described in FIG. 5, 8, or 11 pertaining to whether the selected Module is the Question Bank—Rapid Entry Module, Question Bank—Main Module, or the Comprehension Bank Module. The Control System brings forth a User Interface showing a grid which displays the Find Results from where the user can further Sort, Filter, or Select the Record(s). The Sort, Filter, and Select functionalities are same as the ones described in FIG. 5, 8, or 11 pertaining to whether the selected Module is the Question Bank—Rapid Entry Module, Question Bank—Main Module, or the Comprehension Bank Module. The User Interface provides the user with the same utility(s)/functionality(s) applicable to Record(s) in a Find Result grid as described in FIG. 5. After the user chooses to Schedule the Record(s), the Control System brings forth a User Interface from where the user must enter/select Criteria like Time of Scheduled Session, time of display per Record, and choose between scheduling the Record(s) as it is or scheduling the Record(s) as a Practice Session or a Self Evaluation Test. The user can also select to listen to a Background Music Sound File and/or can select to activate the Voice Assistant during the Scheduled Session. The Control System schedules the Record(s) accordingly. In case the user wants to Schedule the Record(s) to appear in a Self Evaluation Test, the user must further specify the Test format. The user then closes the User Interface and comes out of the Module. The scheduled Record(s) are displayed at the specified time, according to the user's selection. The user can also send the Record(s) (Question/Answer) as SMS/MMS and/or via Email and/or Network Messaging during the Scheduled Session. The Control System saves the Scheduled Session, generates a new Scheduled Session Id, and updates the Database(s).

Note: The user can decide whether the Scheduler should remain active in the System tray of the user's computer system irrespective of whether the System is running or not.

In case where the user wishes to Schedule the Questions based on a Comprehension passage, the user first selects the passage from the Database(s) by finding the same based on none or one or more FIND conditions. The passage is displayed to the user throughout the Session in addition to the Questions and Answers, based on the said passage.

FIG. 48 describes the System State Transition of the Scheduler Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 49 to 51 System Function, System Operation and System State Transition respectively, of the Screen Saver Module which allows the user to use the Question(s) and Answer(s) stored in the Database(s) as Screen Savers.

FIG. 49 is the diagram of the System Function of Screen Saver Module of the present invention.

The architecture of this Module comprises of the following major functions, which allow a user to use the Question(s) and Answer(s) stored in the Database(s) as screen savers.

The Module allows a user to:
Select the Module for the Record(s) of which the user wants to use as Screen Savers
Select the Language in which the Record(s) are to be brought forth
Enter time after which the Screen Saver is to be activated
Enter the time interval for which Record(s) appear as Screen Savers
Select to listen to Background Music along with the Screen Saver

FIG. 50 describes the System Operation of the Screen Saver Module of the System explaining that the Module is based on user actions.

The user first selects the Module for the Record(s) of which the user wants to use as Screen Savers, and then the Language in which the Record(s) are to be brought forth. The Control System brings forth a User Interface from where the user can set Screen Saver settings like entering the time after which the Screen Saver is to be activated, entering the time interval for which Record(s) appear as Screen Savers, and selecting to listen to Background Music along with the Screen Saver. In case, the user selects to listen to Background Music along with the Screen Saver, the user must further browse for and select the desired Sound file from a computer system, for the same. The user can also clear all entries/selections on the User Interface for new data input. After the user makes the necessary entries/selections and chooses to save the same, the Control System saves the Screen Saver settings and updates the Database(s) accordingly. The Screen Saver is activated if the user's computer system is left unused for a time as may be specified by the user in the Screen Saver settings. The Record(s) which appear as Screen Savers are randomly selected from the Database(s) by the Control System. The user can also select Records to appear as Screen Savers. The user can further modify the Screen Saver settings as and when required.

FIG. 51 describes the System State Transition of the Screen Saver Module of the present invention explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 52 to 54 explain the System Function, System Operation and System State Transition respectively, of the Recycle Bin Module which allows the user to Restore or Permanently Delete a Record, which may have been deleted by the user.

FIG. 52 is the diagram of the System Function of Recycle Bin Module of the present invention. The architecture of this Module comprises of the following major functions, which allow a user to Restore/Permanently Delete Record(s) with the help of the User Interface.

The Module allows a user to:
Select the Module for the Record(s) of which the user wants to Restore or Permanently Delete
Select the Language
Find existing Record(s) in the Recycle Bin of the System, by none or one or more FIND conditions
Sort, Filter, and Select Record(s)
Restore/permanently Delete selected Record(s)

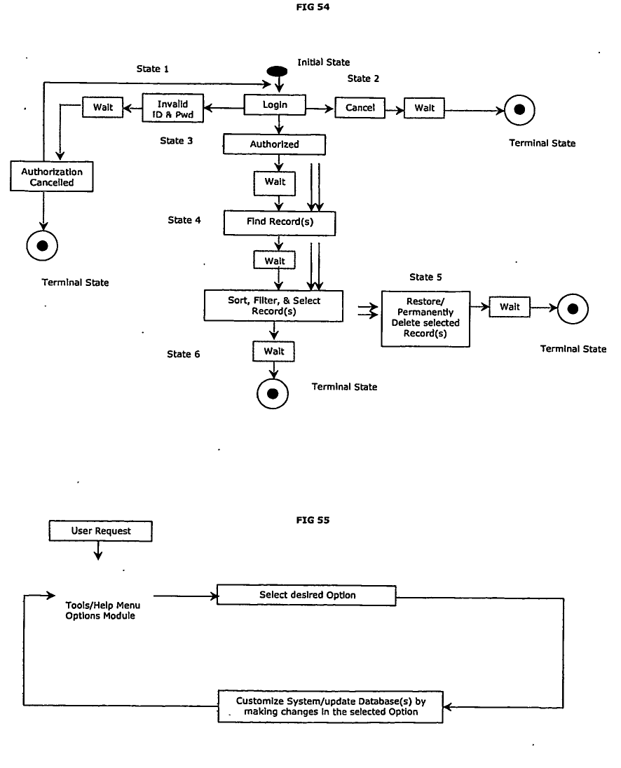

FIG. 53 describes the System Operation of the Recycle Bin Module of the present invention explaining that the Module is based on user actions.

The user first selects the Module for the Record(s) of which the user wants to Restore or Permanently Delete and then the Language in which the Record(s) to be Restored or Permanently Deleted are to be brought forth. The Control System brings forth a User Interface from where the user can find the Record(s) that have been deleted earlier and are lying in the Recycle Bin of the selected, Module, by none or one or more FIND conditions. The FIND conditions in this case are the same as the ones described in FIG. 5, 8, 11, or 38 pertaining to whether the selected Module is either the Question Bank—Rapid Entry Module, Question Bank—Main Module, Comprehension Bank Module, or the Create a Test/Quiz Module respectively. The Control System brings forth a User Interface displaying the Find Results showing the Record(s) of the selected Module which have been deleted by the user, in a grid, and from where the user can further Sort, Filter, and Select the Record(s) to be Restored or permanently Deleted. The Sort, Filter, and Select, including ‘Selected So Far’, functionalities in this case are same as the ones described in FIG. 5, 8, 11, or 38 pertaining to whether the Module selected by the user is either the Question Bank—Rapid Entry Module, Question Bank—Main Module, Comprehension Bank Module, or the Create a Test/Quiz Module respectively. The user can also view the Classification details of the selected Record(s) or those of the entire set of found Record(s). The user can also print the selected Record(s) as Flash Card(s), Snap Card(s), Worksheet(s), or can even print the entire details of the selected Record(s). After the user selects the Record(s), the user can choose to either Restore or permanently Delete the Record(s). In both cases, the Control System prompts the user as to whether or not the user wants to Restore or permanently Delete the selected Record(s). If the user chooses to Restore the selected Record(s), the Control System takes the selected Record(s) out of the Recycle Bin and restores them back to their respective Module (the Module selected by the user) with their original Record Id(s). If the user chooses to permanently Delete the selected Record(s), the Control System deletes the selected Record(s) from the Recycle Bin and thus permanently removes the Record(s) from the System. Sufficient care is exercised by the Control System to ensure that Record(s) that are in use, in existing Practice Session(s), Self Evaluation Test(s), Insta Test(s)/Quiz(s), Test(s)/Quiz(s), Scheduled Session(s) are not permanently deleted.—EXAMPLE—If certain Record(s) in the Recycle Bin are in use in existing Practice Session(s), Self Evaluation Test(s), Insta Test(s)/Quiz(s), Test(s)/Quiz(s), and/or Scheduled Session(s) and if the user chooses to Delete them, then the Control System notifies the user that the Record(s) are in use in an existing Practice Session(s), Self Evaluation Test(s), Insta Test(s)/Quiz(s), Test(s)/Quiz(s), and/or Scheduled Session(s) and hence cannot be permanently deleted. The Control System further brings forth a User Interface which displays the existing Practice Session(s), Self Evaluation Test(s), Insta Test(s)/Quiz(s), Test(s)/Quiz(s), and/or Scheduled Session(s) where the Record(s) selected to be deleted are in use, and prompts the user to Delete the same in order to permanently Delete the Record(s) from the System. Further, the user can repeat those existing Practice Session(s) or Self Evaluation Test(s), and/or even reprint those Insta Test(s)/Quiz(s) printed earlier, which use Record(s) lying in the Recycle Bin, but the user cannot take a new Practice Session(s) or Self Evaluation Test(s), print a new Insta Test/Quiz, create a new Test/Quiz, and/or Schedule a new Session by using Record(s) lying in the Recycle Bin.

Whenever Record(s) are Restored or Deleted, the Control System updates the Database(s) and notifies the user that the selected Record(s) were successfully Restored or Deleted and also displays the number of Record(s) Restored or Deleted. After this, the Control System takes the user back to the User Interface from where the user can further Sort, Filter, and Select to Restore or Delete Record(s). If the user closes this User Interface, the Control System gets notified and the user comes out from the Module.

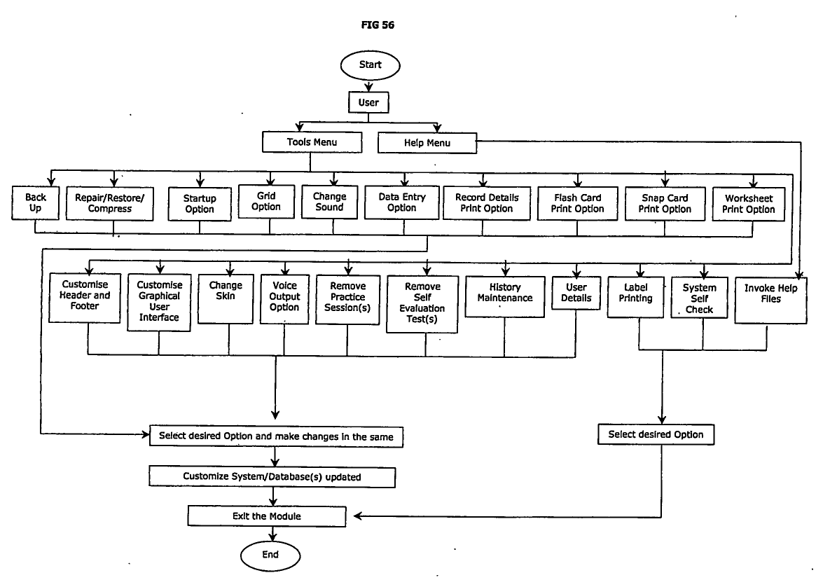

FIG. 54 describes the System State Transition of the Recycle Bin Module of the System explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

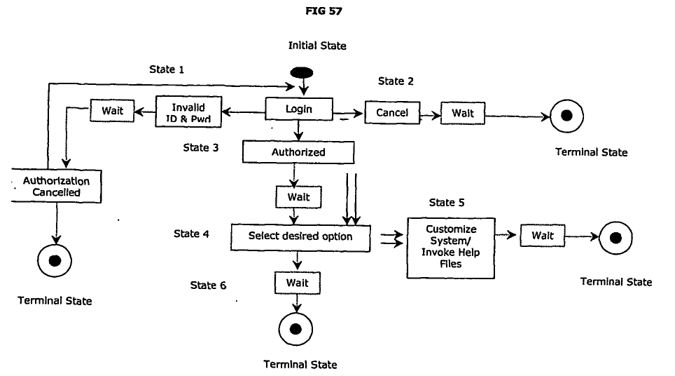

FIGS. 55 to 57 explain the System Function, System Operation and System State Transition respectively, of the Tools/Help Menu Options Module comprising of maintenance Tools such as Back Up, Repair, Restore, Compression of the entire Database(s) and System Self Check. There are other tools such as Start Up Option, Grid Option, Change Sound, Data Entry Option, Label Printing, Record Details Print Option, Flash Card Print Option, Snap Card Print Option, Worksheet Print Option, Customize Header and Footer, Customize Graphical User Interface, Change Skin, Voice Output Option, Remove Practice Session(s), Remove Self Evaluation Test(s), History Maintenance, User Details, and Help.

FIG. 55 is the diagram of the System Function of Tools/Help Menu Options Module of the present invention. The architecture of this Module comprises of the following major functions, which allow a user to select any option for Customization including maintenance of the System and updating of Database(s).

The Module allows a user to:
Select any option
Customize the System/Update Database(s) by making changes in the selected option.

FIG. 56 describes the System Operation of the Tools/Help Menu Options Module, explaining that the Module is based on user actions. Through this Module, the user can select any of the options mentioned below for customization and maintenance of the System.

The Tools/Help Menu Options Module, through the User Interface, retrieves and brings forth the following utilities which the user can select:
Back Up—This utility allows the user to back up the Database(s). If the user selects this utility, the Control System brings forth a User Interface from where the user must browse for and select the appropriate file/folder destination on the user's computer system, where the user wants to take the backup. The Control System backs up the entire Database(s) and creates a backup at the selected file/folder destination.
Restore—This utility allows the user to restore the Database(s) from a backup taken by the user by using the Back Up utility. If the user selects this utility, the Control System brings forth a User Interface from where the user must browse for and select the appropriate file/folder destination on the user's computer system, where the user has taken the backup. The Control System restores the Database(s) with the backup accordingly.
Repair and Compress—This utility allows the user to repair and compress the Database(s).
System Self Check—This utility allows the user to initiate a System Self Check. If the user selects this utility, the Control System gets notified and initiates a System Self Check. The Control System notifies the user whether the System Self Check has completed successfully or not, and further generates a Report displaying the tasks performed during the System Self Check.
Start Up Option—This utility allows the user to set conditions like the Login User Interface and Quick Start User Interface to appear each time the System is initiated. If the user selects this utility, the Control System allows the user to select either or both the Login and the Quick Start User Interfaces to appear each time the System is initiated. The Control System updates the Database(s) in this case.
Grid Option—This utility allows the user to enter the number of Record(s) to be displayed in a Find Result grid at a time, facing the user.—EXAMPLE—If the user enters 24, then 24 Record(s) will be displayed in any Find Result grid at a time, facing the user. The Control System updates the Database(s) in this case.
Change Sound—This utility allows the user to change sounds like the background, applause and regret sounds which are used in a Practice Session(s), Self Evaluation Test(s), and Scheduled Session(s). If the user selects this utility, the Control System brings forth a User Interface which displays the sound files for background, applause, and regret sounds selected by the user, and further allowing the user to browse for and select the appropriate sound files for background, applause, and regret sounds. The user can further play the sound files thus selected by the user for the background, applause, and regret sounds. The user can also select the sound files specified as default for background, applause, and regret sounds. The Control System updates the Database(s) in this case.
Data Entry Options—This utility allows the user to enable/disable the “Copy Current Entry” functionality during data input, as well as allowing further customization of the same. The “Copy Current Entry”functionality is described in FIGS. 5, 8, 11 and 38. If the user selects this utility, the Control System brings forth a User Interface, from where the user must first select the Module in order to choose whether to have “Copy Current Entry” functionality during data input or not, in that particular Module, as well as select the data input fields to be copied using this functionality. The Control System updates the Database(s) in this case.
Label Printing—This utility allows the user to print user information labels.
Record Details Print Option—This utility allows the user to customize the Criteria for printing Details of a Record. If the user selects this utility, the user must first select the Module for which the user wishes to use this utility and then select the Language. The Control System brings forth a User Interface, pertaining to the selected Module, from where the user can select the part(s) of a Record that are to be printed. The user can also undo all of these selections. The Control System updates the Database(s) in this case.
Flash Card Print Option—This utility allows the user to customize the Criteria for printing Flash Cards. If the user selects this utility, the user must first select the Module for which the user wishes to use this utility and then select the Language. The Control System brings forth a User Interface, pertaining to the selected Module, from where the user can select the part(s) of a Record that are to appear on a Flash Card. The user can further select the no of Flash Cards to be printed per page. The user can also undo all of these selections. The Control System updates the Database(s) in this case.
Snap Card Print Option—This utility allows the user to customize the Criteria for printing Snap Cards. If the user selects this utility, the user must first select the Module for which the user wishes to use this utility and then select the Language. The Control System brings forth a User Interface, pertaining to the selected Module, from where the user can select the part(s) of a Record that are to appear on a Snap Card. The user can further select the no of Snap Cards to be printed per page. The user can further select to print a Reference Sheet which displays additional information about the Record(s) that are printed as Snap Card(s). The user can further select the color background in which the Snap Card will be printed. The user can also undo all of these selections. The Control System updates the Database(s) in this case.
Worksheet Print Option—This utility allows the user to customize the Criteria for printing Worksheets. If the user selects this utility, the user must first select the Module for which the user wishes to use this utility and then select the Language. The Control System brings forth a User Interface, pertaining to the selected Module, from where the user can select the part(s) of a Record that are to appear on a Worksheet. The user can also undo these selections. The Control System updates the Database(s) in this case.
Customize Header and Footer—This utility allows the user to customize the Header and Footer for the Printed outputs. If the user selects this utility, the Control System brings forth a User Interface from where the user can enter the appropriate Header and Footer details which will appear in all the Reports. The Control System updates the Database(s) in this case.
Customize Graphical User Interface—This utility allows the user to change the Labels that appear on the User Interface. The Control System updates the Database(s) in this case.
Change Skin—This utility allows the user to select the “skins” for the User Interface. If the user selects this utility, the Control System brings forth a User Interface from where the user can browse for and select the desired “skin” file. The user can also set a “skin” file as the default “skin”. The user can also undo these selections. The Control System updates the Database(s) in this case.
Voice Output Option—This utility allows the user to select the part(s) of a Record of which the user wishes to receive Voice Output as well as save the Voice Output of a particular Record in an mp3 file format. If the user selects this utility, the user must first select the Module for which the user wishes to customise this utility and then select the Language. The Control System brings forth a User Interface from where the user can select all or specific part(s) of a Record of which the user wishes to receive the Voice Output. The user can further select to save the Voice Output of the Record, either received from the Module selected in this case, or from a Practice Session, Self Evaluation Test, or Scheduled Session pertaining to the selected Module, in an mp3 file format, and further browse for and select the appropriate file/folder destination on a computer system where the user wishes to save the mp3 file. The Control System updates the Database(s) in this case.
Remove Practice Session(s)—This utility allows the user to permanently remove previously taken Practice Sessions, such deletions capable of being made selectively. If the user selects this utility, the user must first select the Module for which the user wishes to remove Practice Session(s) pertaining to the selected Module and then select the Language. The Control System brings forth a User Interface showing a grid which displays all Practice Session(s) taken earlier for the selected Module in the selected Language. The user can Sort the Practice Session(s), in ascending or descending order, by various Classifications. The user can further select all or specific Practice Session(s) from the grid, to be removed from the System. If the user chooses to remove the selected Practice Session(s), then the Control System prompts the user as to whether or not the user wants to remove the selected Practice Session(s). If the user chooses to continue, the Control System removes the selected Practice Session(s) from the System and notifies the user about the same. The Control System updates the Database(s) accordingly.
Remove Self Evaluation Test(s)—This utility allows the user to permanently remove previously taken Self Evaluation Test(s), such deletions capable of being made selectively. If the user selects this utility, the user must first select the Module for which the user wishes to remove Self Evaluation Test(s) pertaining to the selected Module and then select the Language. The Control System brings forth a User Interface showing a grid which displays all Self Evaluation Test(s) taken earlier, pertaining to the selected Module in the selected Language. The user can Sort the Self Evaluation Test(s), in ascending or descending order, by various Classifications. The user can further select all or specific Self Evaluation Test(s) from the grid, to be removed from the System. If the user chooses to remove the selected Self Evaluation Test(s), then the Control System prompts the user as to whether or not the user wants to remove the selected Self Evaluation Test(s). If the user chooses to continue, the Control System removes the selected Self Evaluation Test(s) from the System and notifies the user about the same. The Control System updates the Database(s) accordingly.
History Maintenance—This utility allows the user to delete the History for a certain Record in the Database(s). The Control System maintains a History of each Record in the Database(s) in terms of Criteria such as its Record Id, the user who has created it, the Language in which the Record was created, whether or not the Record has appeared in a Practice Session and/or Self Evaluation Test, the frequency by which the Record appeared in the same, Date and time of the same, whether it was correctly or incorrectly answered in a Self Evaluation Test. The Control System updates the Database(s) in case the user deletes the History of Record(s).
User Details This utility allows the user to enter or modify the user details like User Name and Password. The user can create Sub users through this option. The Control System updates the Database(s) accordingly.
Help—This utility allows the user to invoke the Help files, which provide Help on how best to use the System.

After selecting any of the options mentioned above and customising or using the same, the user comes out of the Module.

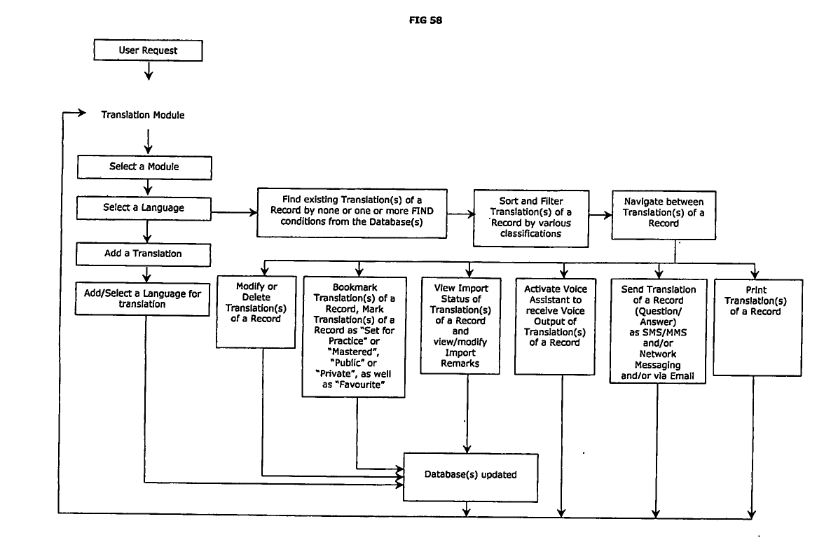

FIG. 57 describes the System State Transition of the Tools/Help Menu Options Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 58 to 60 explain the System Function, System Operation and System State Transition, of the Translation Module of the present invention. The Translation Module allows the user to consider any Record as a parent language Record and Translate the same into one or more languages of the user's choice, and further all of the features and/or utility(s)/functionality(s) available in case of the parent language Record would be available in case of its Translation.

FIG. 58 is the diagram of the System Function of the Translation Module of the present invention. The architecture of this Module comprises of the following major functions, which allow a user to consider any Record as a parent language Record and Translate the same into one or more languages of the user's choice.

For the purpose of the Translation activity, the user:
Selects the Module for the Records of which the user wants to Translate
Finds Record(s) from the Database(s) by none or one or more FIND conditions
Sorts, Filters, and Selects Record(s)
Selects/Adds a language
Adds Translation(s)
Modifies Translation(s)
Deletes Translation(s)
Prints Record(s) by various Print conditions including printing of Flash Cards, Snap Cards, Worksheets, and Question details

FIG. 59 describes the System Operation of Translation Module explaining that the Module is based on user actions. The Translation Module is invoked in the Question Bank—Rapid Entry Module, Question Bank—Main Module and the Comprehension Bank Module

The user first selects the Module for the Records of which the user wants to Translate. The Control System brings forth the User Interface of the selected Module from where the user can choose to Translate a Record. If the user continues, then the Control System brings forth another User Interface wherein the user must enter/select a Language and enter the translation in that Language, in data input fields which correspond to those of the Record facing the user considered as the parent Language Record. All the utility(s)/functionality(s) available in case of the parent Language Record of the selected Module are also available in case of its Translation. If the user chooses to save the Translation, the Control System saves the same as a Record in the Database(s), generates a new Record Id, and updates the Database(s). The user can find existing Translation(s) of a Record by none or one or more FIND conditions. The user can further Modify or Delete an existing Translation of a Record, in the same manner as in case of a normal Record of a Module. The user comes out of the Module by closing the User Interfaces.

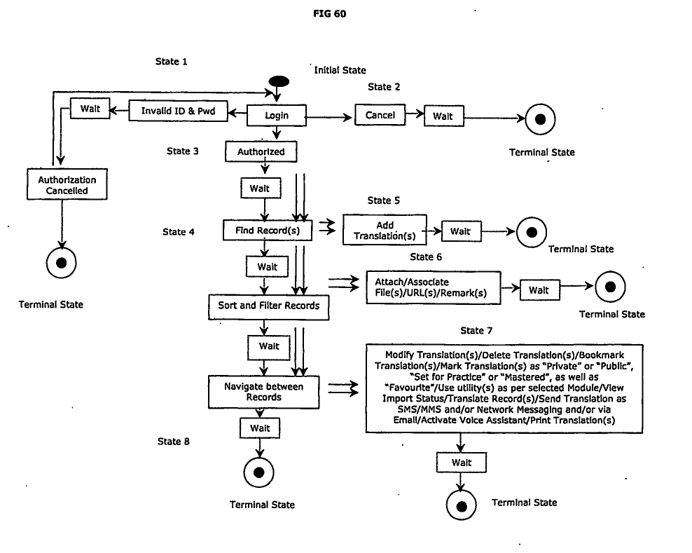

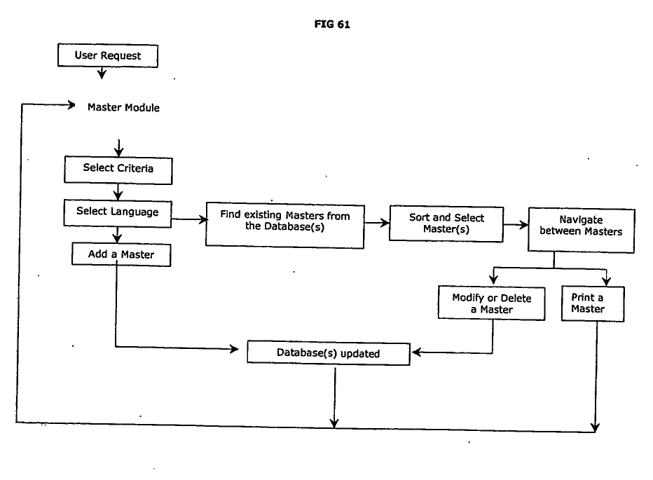

FIG. 60 describes the System State Transition of the Translation Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

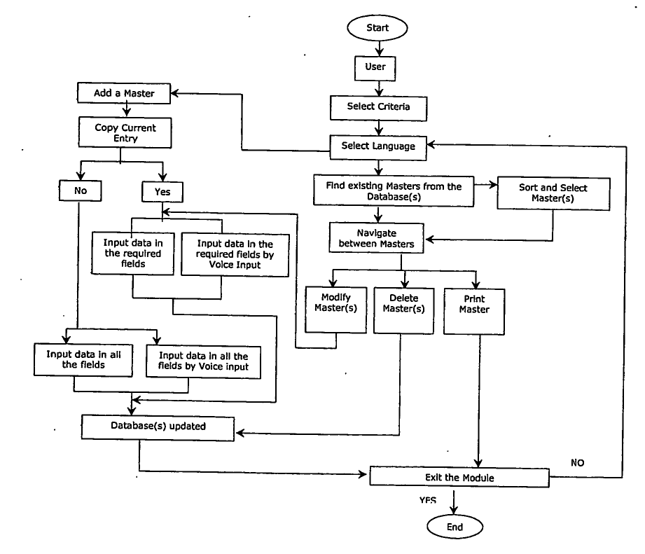

FIGS. 61 to 63 explain the System Function, System Operation and System State Transition respectively, of the Master Module which provides the utility of creating, finding, modifying, deleting, printing, navigating between Masters for Criteria like Language, User, Source of Information, Age Group, Difficulty Level, Subject, Sub Subjects, Test/Quiz Name, Test/Quiz Venue, Category, and Sub-Categories.

FIG. 61 is the diagram of the System Function of the Master Module of the present invention. The architecture of this Module comprises of the following major functions, which allow a user to create and store Masters for Criteria with the help of the User Interface.

The Module allows a user to:
Select Criteria
Select Language
Add Master(s) for the selected Criteria
Copy Current Entry
Find existing Master(s) from the Database(s)
Sort and Select Master(s)
Modify Master(s)
Delete Master(s)
Go To a Master and Navigate between Masters
Print Master(s)

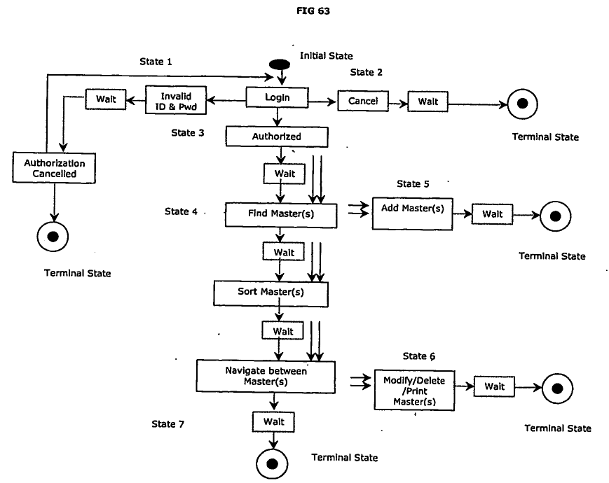

FIG. 62 describes the System Operation of the Master Module explaining that the Module is based on user actions. The Master Module accepts data in one or more languages (such data capable of being accepted from more than one user at the same time).

The user first selects the desired Criteria like Language, User, Source of Information, Age Group, Difficulty Level, Subject, Sub subjects, Test/Quiz Name, Test/Quiz Venue, Category, Sub-Categories for which the user wishes to create, find, modify, delete, print Masters, and then the Language in which the user wishes to do the same. The Control System brings forth a User Interface from where the user can Create Master(s), Find Master(s), Modify Master(s), Delete Master(s), Navigate between Master(s), Print Master(s), for the Criteria selected by the user. All of these functionalities are described below in detail.

The Create Master functionality allows the user to create a Master for the selected Criteria by allowing data input in the fields provided for the purpose in the User Interface described above. When the user chooses to create a Master, the Control System prompts the user as to whether the user wishes to copy the current Master, if any, facing the user. If a user chooses not to use this “Copy Current Entry” utility, then the Control System gets notified and blanks out the relevant data input field(s) for new data input by the user. The user can then enter data in the relevant data input field(s) as desired. After the user creates a new Master and chooses to save it, the Control System checks whether the new Master created by the user is a duplication of any Master created earlier. If the created Master is a duplication, then the Control System notifies the user that the user cannot create duplicate Masters and does not allow the user to save the Master. Else, the Control System saves the Master and updates the Database(s). The user can now use this Master for the selected Criteria at the time of adding or modifying Record(s) in any of the data input Modules like Question Bank—Rapid Entry, Question Bank—Main , Comprehension Bank, and/or the Create a Test/Quiz Module. The user can also create Masters by entering the same in the relevant data input fields when the user is adding or modifying Record(s) in any of the data input Modules. The Masters thus created are also visible to the user through the Master Module.—EXAMPLE—If the user creates Masters through the Master Module for the Criteria of Subject and Sub Subject(s) as SUBJECT>ANIMAL WORLD>SUB SUBJECT1>TERRESTRIAL ANIMAL>SUB SUBJECT2>MAMMAL>SUB SUBJECT3>QUADRUPED>SUB SUBJECT4>OMNIVORE>SUB SUBJECT5>DOG, then these Masters like ANIMAL WORLD, TERRESTRIAL ANIMAL, and MAMMAL for Subject and Sub Subject(s) are available to the user, when the user is adding or modifying a Record in any of the data input Modules. Conversely, if the user when adding or modifying a Record in any of the data input Modules, creates Masters like the ones described above for Subjects and Sub Subjects by entering the same in the relevant data input fields, then these Masters would be visible to the user in the Master Module. The Control System also updates the Database(s) in this case. If the user imports a Record into any of the data input Modules, the Masters contained in the relevant Record will also be visible to the user through the Master Module. The Control System also updates the Database(s) in this case. The Control System generates a new Record Id each time a new Master is created and saved by the user in either of the ways described above or when a Record is imported by the user which contains relevant Masters for Criteria like User, Language, Source of Information, Age Group, Difficulty Level, Subject, Sub Subjects, Language, Test/Quiz Name, Test/Quiz Venue, Category, Sub-Categories.

The Voice functionality allows the user to create and/or Modify Master(s) by Voice Input as well as receive Voice Output of the Master(s). In case the user chooses to receive Voice Output of the Master(s), the Control System brings forth a text to speech agent that speaks out the Master(s). The user can choose between listening to the text to speech agent speak out the Master(s) continuously or one Master at a time.

The Find functionality allows the user to find existing Master(s) stored in the Database(s). If the user chooses to use this functionality, then the Control System brings forth a User Interface from where the user can find Master(s) by entering keywords.—EXAMPLE—If there is a Master ‘JUNIOR’ for the Criteria of Age Group stored in the Database(s) and the user types in just ‘JU’, then the ‘JUNIOR’ Master will appear in the Find Results. The same applies in case the user enters any part of the word ‘JUNIOR’ as a keyword. If the user does not enter any keyword and chooses to Find Master(s), then the Control System brings forth Find Results showing all the Master(s) stored in the Database(s) for the selected Criteria. If a keyword entered by the user is not there in any of the Master(s), then the Control System notifies the user that no Master(s) have been found for the keyword entered by the user. The Control System brings forth a User Interface displaying the Find Results in a grid, from where the user can further Sort and group, the Masters currently displayed in the Find Result grid facing the user or the entire set of found Masters.

The Modify functionality allows the user to Modify a Master stored in the Database(s). If the user chooses to use this functionality then the user can use all the utility(s)/functionality(s) available at the time of creating a Master. After modification, if the user chooses to save the modification done to the Master, the Control System saves the same accordingly and updates the Database(s). Else, the modifications made by the user to the Master will not be saved. The modifications made by the user to the Master will be reflected in all the Record(s) which use that Master, in any of the data input Modules as well as in any existing Practice Session(s), Self Evaluation Test(s), Scheduled Session(s), Insta Test(s)/Quiz(s) and/or Test(s)/Quiz(s).

The Delete functionality allows the user to Delete an existing Master stored in the Database(s). If the user chooses to use this functionality, the Control System prompts the user as to whether or not the user wishes to Delete that particular Master. If the user chooses to delete the Master, the Control System deletes the Master permanently from the System. The Control System updates the Database(s) in this case. However, if the Master to be deleted is being used by any Record in any of the data input Modules as well as in any existing Practice Session(s), Self Evaluation Test(s), Scheduled Session(s), Insta Test(s)/Quiz(s) and/or Test/Quiz, the Control System notifies the user that the Master is in use and hence cannot be deleted.

The Navigation functionality allows the user to navigate between the Masters stored in the Database(s).

The Printing functionality allows the user to print Master(s) stored in the Database(s).

If the user closes the User Interface described above, the Control System gets notified and the user comes out from the Module.

FIG. 63 describes the System State Transition of the Master Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same functions in substantially the same way to achieve the same results are within the scope of this invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

1-24. (canceled)

25. An interactive system for building, organizing, and sharing one's own databank of questions and answers in a variety of questioning formats, on any subject, in one or more languages, using a computer system, comprising of:
(a) a User Interface;
(b) one or more well-classified databases to store data user wise including a User Database;
(c) at least one well classified data input, organizing and management module;
(d) modules for sharing, invoking, storing, evaluating, and improving one's knowledge on any subject, using the data from the databank, said data having been selected by a user by finding the same by none or one or more “FIND” conditions; and
(e) a control system acting as a bridge between the User Interface and the databases.

26. The system according to claim 25 wherein said data input organizing and management module allows the user to classify the data by Classifications like Date, Language, Source of Information, Age Group, Difficulty Level, Subject and Sub subjects.

27. The system according to claim 25 wherein the modules include a Question Bank—Rapid Entry Module for allowing the user to build questions and answers rapidly by minimum classifications.

28. The system according to claim 27 wherein said Question Bank—Rapid Entry Module allows the user to classify the data by classifications like Date, Language, Source of Information, Age Group, Difficulty Level, Subject and Sub subjects.

29. The system according to claim 25 wherein the modules include a Comprehension Bank Module for allowing the user to build and share a databank of passages by well-defined classifications, and further questions and answers based on said passages in various questioning formats, such that the user acquires an improved comprehension of said passages.

30. The system according to claim 29 wherein said Comprehension Bank Module allows the user to classify the data by well-defined classifications like Date, Language, Source of Information, Age Group, Difficulty Level, Subject and Sub subjects.

31. The system according to claim 29 wherein said Comprehension Bank Module allows the user to export the questions and answers based on the passages to the data input organizing and management module by finding the same from the databank by none or one or more FIND conditions.

32. The system according to claim 25 wherein the modules include a Practice Session Module for allowing the user to invoke and store a practice session for continuous improvement of one's knowledge on any subject, using the data from the databank by finding the same by none or one or more “FIND” conditions.

33. The system according to claim 25 wherein the modules include a Self Evaluation Test Module, Print a Test Module, Individual Test Report Module, and an Overall Evaluation Report Module for allowing the user to invoke and store self evaluation tests, being taken in a variety of test formats using the data from the databank, by finding the same by none or one or more “FIND” conditions, and to print such Tests, and obtaining evaluation reports of said tests.

34. The system according to claim 33 where the Self Evaluation Test Module includes a utility for viewing a replay of a self evaluation test along with the user's actions performed during the self evaluation test and to obtain reports of such replays.

35. The system according to claim 25 wherein the modules include a Create a Test/Quiz Module and an Insta Test/Quiz Module for allowing the user to create and/or print tests and/or quizzes manually or automatically, by various classifications like the Date of test/quiz, Venue, Name of test/quiz, Categories and Sub-categories, and further allowing the user to assign marks to each question, using the data from the databank, by finding the same, by none or one or more “FIND” conditions.

36. The system according to claim 35 wherein the Create a Test/Quiz Module enables verifying, using a backtracking utility, whether any of the questions being selected for the test/quiz, have been used during any user specified earlier period for the person(s) who will face the test/quiz, thus avoiding duplication of questions.

37. The system according to claim 25 wherein the modules include a Scheduler Module for allowing the user to schedule data by finding the same, from the databank, by none or one or more “FIND” conditions, and said data is brought up on the user's computer system at preset time intervals.

38. The system according to claim 25 wherein the modules include an Export Module for allowing the user to export data from the databank, said data having been selected by the user by finding the same by none or one or more “FIND” conditions.

39. The system according to claim 25 wherein the modules include an Import Module for allowing the user to import data built by one or more other users.

40. The system according to claim 39 wherein the Import Module further includes a utility for selectively importing the data.

41. The system according to claim 25 wherein the modules include a Global Changes Module for allowing the user to modify records, delete records, bookmark records, mark records as “Set for Practice” or “Mastered”, “Public” or “Private”, and “Favourite”, attach image, animation and/or sound files, and/or associate more information to a record in the form of URLs, files, remarks, translate records, individually as well as globally.

42. The system according to claim 25 wherein said data input organizing and management module further includes a utility for copying of existing classification and previously entered data, for new data input by the user, for ease of data entry, with a choice of defining the extent of the details to be copied.

43. The system according to claim 25 wherein the modules include a Recycle Bin Module for allowing the user to restore or permanently remove a record individually or plurally from the system.

44. The system according to claim 25 wherein the modules include a Reports Module for allowing a user to print reports and/or graphs about the data in the databank, by finding the same by none or one or more FIND conditions.

45. The system according to claim 25 wherein the “FIND” conditions are defined by classifications like the Date, Record ID, Language, Source of Information, Age Group, Difficulty Level, Subject, Sub Subjects, Test/Quiz Title, Test/Quiz Venue, Category and Sub Categories as well as by keywords, separators, wildcard characters, file attachments, attachment remarks, associations, association remarks, import remarks, or bookmark remarks including whether or not a record is marked as “Set for Practice” or “Mastered” or either, “Private” or “Public” or either, as well as “Favourite”, Practice Session Title, Test/Quiz Title, Test/Quiz Venue, Category and Sub categories.

46. The system according to claim 45, wherein the “FIND” conditions allow the user to avoid questions that may have been faced by the user in a self evaluation test before a specified number of days and/or for a specified number of times and/or based on a score that the user achieved on the questions in a self evaluation test during a specified period of time.

47. The system according to claim 25 wherein the modules include a Translation Module for allowing translation of a record from one language into another of user's choice, individually or globally.

48. The system according to claim 25 wherein the modules include a Tools/Help Menu Options Module for allowing the user to select an option for customization including system maintenance and updating of database.

49. The system according to claim 25 wherein the modules include a Master Module for allowing the user to create and store masters for well-defined classifications.

50. The system according to claim 25 wherein the modules include a Screen Saver Module for allowing the user to display the data in the databank as screen savers.

51. The system according to claim 25 further includes a utility which allows the user to print flash cards, snap cards, and worksheets from the data in the databank.

52. The system according to claim 25 wherein the modules and utilities are adapted to be operated within a browser and/or other viewing and/or processing programs and to operate on one or more computers, including hand held devices.
